(19) United States
(12) Patent Application Publication
(10) Pub. No.: US 2008/0281843 A1
(43) Pub. Date: Nov. 13, 2008

(54) Distributed Memory Type Information Processing System

(75) Inventor: Shinji Furusho, Kanagawa (JP)

Correspondence Address: GRIFFIN & SZIPL, PC, SUITE PH-1, 2300 NINTH STREET, SOUTH, ARLINGTON, VA, 22204, US

(73) Assignee: TURBO DATA LABORATORIES, INC., Yokohama-shi, Kanagawa (JP)

(21) Appl. No.: 10/596,822

(22) PCT Filed: Dec. 22, 2004
(86) PCT No.: PCT/JP2004/019181

§ 371 Date: Jul. 23, 2008

(30) Foreign Application Priority Data
Dec. 25, 2003 (JP) 2003-431248

(51) Int. Cl. G06F 17/30

(52) U.S. Cl. 707/101; 707/E17.011; 707/E17.009

(57) ABSTRACT

It is possible to realize high-speed data processing between processing modules with a small communication amount when performing information processing of a large amount of data employing the parallel computer architecture. Each of the processing modules transmits a first list as a list of values stored in the memory of the local processing module to another processing module in the information processing system and receives at least one second list as a list of values transmitted from the another processing module to the local processing module so as to compare the values in the second list with the values in the first list. When the values in the second list coincide with the values in the first list, counters corresponding to the values in the first list which have coincided are incremented by one.

This is a National Phase Application in the United States of International Patent Application No. PCT/JP2004/019181 filed Dec. 22, 2004, which claims priority on Japanese Patent Application No. 2003-431248, filed Dec. 25, 2003 The entire disclosures of the above patent applications are hereby incorporated by reference.

### FIELD OF THE INVENTION

The present invention relates to an information processing method and information processing apparatus for processing large amounts of data, and more particularly, to an information processing method and an information processing system using a parallel computer architecture.

### BACKGROUND OF THE INVENTION

Conventionally, large amounts of information are accumulated and data processing such as searching or tabulating is performed on the accumulated information. The data processing may be performed using, for example, a known computer system including a CPU, a memory, a peripheral device interface, an auxiliary storage device such as a hard disk, a display device such as a display or a printer, an input device such as a keyboard or a mouse, and a power supply unit connected via a bus, and may be particularly provided as software that can run on a readily commercially available computer system. In order to perform the aforementioned data processing such as searching or tabulating, various types of databases which particularly store large amounts of data are known. Among the large amounts of data, there is a particularly strong demand for processing data which can be expressed in a table format.

Whether or not large amounts of data can be searched for or tabulated efficiently depends on the format in which the large amounts of data are stored. Conventionally, typical known storage techniques include the so-called “record-wise” and “field-wise” storage techniques. In the record-wise storage techniques, a set of field values of sex, age and occupation for each record number is stored on a disk in order of the record numbers so as to increase logical addresses. On the other hand, in the case of the field-wise storage technique, for each field, the field values are stored on a disk in order of the record numbers so as to increase logical addresses.

In the case of the aforementioned prior art, field values corresponding to all fields for all record numbers are stored without change in a two-dimensional data structure (with the record number as one dimension and the other field values as one dimension). Hereinafter, such a data structure in particular shall be referred to as a “data table”. In the case of the prior art, searching for and tabulating the accumulated data is performed by accessing such a data table.

In addition to the method of storing the values of the fields as the field values without change, there is also a known method of converting the values to codes and storing the codes as the field values. Even in this case, the converted codes are stored in a data table as the field values.

In the case of searching for and tabulating large amounts of data stored using a data structure of the data table type in the aforementioned prior art, there is a problem in that the processing time for searching and tabulating becomes longer due to the access time required to access such data tables.

In addition, data tables have at least the following intrinsic drawbacks.

(1) The data tables easily become enormous in size and are hard to be (physically) separated into individual fields. It is difficult to actually expand a data table into a high-speed storage device such as a memory for the purpose of tabulating or searching.

(2) Data tables cannot be held in a form in which field values are sorted for each field in parallel.

(3) In a data table, identical values may appear over and over.

Accordingly, in order to significantly improve the speed of searching for and tabulating large amounts of data, the present inventor has proposed a method of searching for, tabulating and sorting table-format data by providing a data management mechanism that has the functions of the conventional data table and solves the aforementioned problems of the data structure based on the data table and an apparatus for implementing the method (For example, see Patent Document 1).

In accordance with a first embodiment of the present invention, there is provided an information processing method of transmitting/receiving and processing data among a plurality of processing modules in an information processing system in which the plurality of processing modules each having a memory for storing a list composed of values is logically connected to one another in a loop, wherein the method includes the steps of: (a) allowing each of the processing modules to transmit a first list composed of values stored in the memory of each of the processing module to the other processing modules in the information processing system; (b) allowing each of the processing modules to receive at lease one second list composed of values transmitted to each of the processing module, from the other processing module; (c) allowing each of the processing modules to compare the values of the second list with the values of the first list; and (d) allowing each of the processing modules to increase a counter corresponding to the value of the first list by one, when the value of the second list is identical to the value of the first list.

In accordance with a second embodiment of the present invention, there is provided an information processing method of transmitting/receiving and processing data among a plurality of processing modules in an information processing system in which the plurality of processing modules each having a memory for storing a list composed of values is logically connected to one another in a loop, wherein the method includes the steps of: (a) allowing each of the processing modules to transmit a first list which is composed of pairs of a value and the number of value stored in the memory of each of the processing module, to the other processing modules in the information processing system; (b) allowing each of the processing modules to receive at least one second list which is composed of the pairs of value and the number of value transmitted to each of the processing module, from the other processing module; (c) allowing each of the processing modules to compare the values of the second list with the values of the first list; and (d) allowing each of the processing modules to increase a counter corresponding to the value of the first list by the number of the values corresponding to the value of the second list, when the value of the second list is identical to the value of the first list.

In accordance with a third embodiment of the present invention, there is provided an information processing method of transmitting/receiving and processing data among a plurality of processing modules in an information processing system in which the plurality of processing modules each having a memory for storing a list composed of values is logically connected to one another in a loop, wherein the method includes the steps of: (a) allowing each of the processing modules to transmit a first list composed of values stored in the memory of each of the processing module to the other processing modules in the information processing system; (b) allowing each of the processing modules to receive at least one second list composed of values transmitted to each of the processing module, from the other processing module; (c) allowing each of the processing modules to compare the values of the second list with the values of the first list; and (d) allowing each of the processing modules to increase the count of the value of the first list, which ranks immediately next to the value of the second list, by one, when the value of the first list ranks lower than the value of the second list.

In accordance with a fourth embodiment of the present invention, there is provided an information processing method of transmitting/receiving and processing data among a plurality of processing modules in an information processing system in which the plurality of processing modules each having a memory for storing a list composed of values is logically connected to one another in a loop, wherein the method includes the steps of: (a) allowing each of the processing modules to transmit a first list, which is composed of pairs of a value and the number of value stored in the memory of each of the processing module, to the other processing modules in the information processing system; (b) allowing each of the processing modules to receive at least one second list which is composed of the pairs of a value and the number of value transmitted to each of the processing module, from the other processing module; (c) allowing each of the processing modules to compare the values of the second list with the values of the first list; and (d) allowing each of the processing modules to increase a counter corresponding to the value of the first list ranked immediately next to the value in the second list by the number of the values corresponding to the value of the second list, when the value of the first list ranks lower than the value of the second list.

In accordance with a fifth embodiment of the present invention, there is provided an information processing method of transmitting/receiving and processing data among a plurality of processing modules in an information processing system in which the plurality of processing modules each having a memory for storing a list composed of values is logically connected to one another in a loop, wherein the method includes the steps of: (a) allowing each of the processing modules to transmit a first list composed of values stored in the memory of each of the processing module to the other processing modules in the information processing system; (b) allowing each of the processing modules to receive at least one second list composed of values transmitted to each of the processing module, from the other processing module; (c) allowing each of the processing modules to cancel a value of the second list when the value of the second list exists in the first list, and, when the identical values exist in two or more second lists, allowing each of the processing modules to cancel the value of one or more second lists, which appear later among the two or more second lists; and (d) allowing each of the processing modules to increase a counter corresponding to the value of the first list, which ranks immediately next to the value of the second list, by one, when the value of the first list ranks lower than the value of the second list.

In accordance with a sixth embodiment of the present invention, there is provided the information processing method according to any of the previous embodiment is further modified so that each of the processing modules stores table-format data represented by an array of records including field values contained in an information field in the memory in a form of a value list in which the field values are stored in order of field value numbers corresponding to the field values and an array of pointers in which information for specifying the field value numbers is stored in order of records, and wherein the list composed of the values is the value list, which constructs the table-format data.

In accordance with a seventh embodiment of the present invention, there is provided an information processing system that includes a plurality of processing modules each having a memory for storing a list composed of values and a transmitting path for logically connecting the plurality of processing modules to one another in a loop and transmits/receives and processes data among the plurality of processing modules, wherein each of the processing modules includes: (a) a means that transmits a first list composed of values stored in the memory of each of the processing modules to the other processing modules in the information processing system; (b) a means that receives at least one second list composed of values transmitted to each of the processing module, from the other processing module; (c) a means that compares the values of the second list with the values of the first list; and (d) a means which, when a value of the second list is identical to a value of the first list, increases a counter corresponding to the identical value of the first list by one.

In accordance with an eighth embodiment of the present invention, there is provided an information processing system that includes a plurality of processing modules each having a memory for storing a list composed of values and a transmitting path for logically connecting the plurality of processing modules to one another in a loop and transmits/receives and processes data among the plurality of processing modules, wherein each of the processing modules includes: (a) a means which transmits a first list which is composed of pairs of a value and the number of value stored in the memory of each of the processing module to the other processing modules in the information processing system; (b) a means which receives at least one second list which is composed of the pairs of values and the number of value transmitted to each of the processing module, from the other processing module; (c) a means which compares the values of the second list with the values of the first list; and (d) a means which, when a value of the second list is identical to a value of the first list, increases a counter corresponding to the identical value of the first list by the number of the values corresponding to the identical value of the second list.

In accordance with a ninth embodiment of the present invention, there is provided an information processing system that includes a plurality of processing modules each having a memory for storing a list composed of values and a transmitting path for logically connecting the plurality of processing modules to one another in a loop and transmits/receives and processes data among the plurality of processing modules, wherein each of the processing modules includes: (a) a means which transmits a first list composed of values stored in the memory of each of the processing module to the other processing modules in the information processing system; (b) a means which receives at least one second list composed of values transmitted to each of the processing module, from the other processing module; (c) a means which compares the values of the second list with the values of the first list; and (d) a means which, when a value which ranks lower than a value of the second list exists in the first list, increases a counter corresponding to the value of the first list, which ranks immediately next to the value of the second list, by one.

In accordance with a tenth embodiment of the present invention, there is provided an information processing system that includes a plurality of processing modules each having a memory for storing a list composed of values and a transmitting path for logically connecting the plurality of processing modules to one another in a loop and transmits/receives and processes data among the plurality of processing modules, wherein each of the processing modules includes: (a) a means which transmits a first list, which is composed of pairs of a value and the number of value stored in the memory of each of the processing module, to the other processing modules in the information processing system; (b) a means that receives at least one second list which is composed of the pairs of value and the number of value transmitted to each of the processing module, from the other processing module; (c) a means that compares the values of the second list with the values of the first list; and (d) a means which, when a value which ranks lower than a value of the second list exists in the first list, increases a counter corresponding to the value of the first list by the number of the values corresponding to the value of the second list.

In accordance with an eleventh embodiment of the present invention, there is provided an information processing system which includes a plurality of processing modules each having a memory for storing a list composed of values and a transmitting path for logically connecting the plurality of processing modules to one another in a loop and transmits/receives and processes data among the plurality of processing modules, wherein each of the processing modules includes: (a) a means that transmits a first list composed of values stored in the memory of each of the processing module to the other processing modules in the information processing system; (b) a means that receives at least one second list composed of values transmitted to each of the processing module, from the other processing module; (c) a means which, when a value of the second list exists in the first list, cancels the value of the second list, and, when the identical values exist in two or more second lists, cancels the value of one or more second lists, which appear later among the two or more second lists; and (d) a means which, when a value which ranks lower than a value of the second list exists in the first list, increases a counter corresponding to the value of the first list, which ranks immediately next to the value of the second list, by one.

In accordance with a twelfth embodiment of the present invention, there is provided an information processing system according to any one of the seventh to eleventh embodiments, which is further modified so that each of the processing modules comprises the memory that stores table-format data represented by an array of records including field values contained in an information field in a form of a value list in which the field values are stored in order of field value numbers corresponding to the field values and an array of pointers in which information for specifying the field value numbers is stored in order of records, and wherein the list composed of the values is the value list, which constructs the table-format data.

In accordance with a thirteenth embodiment of the present invention, there is provided a program for embodying the following functions in an information processing system which includes a plurality of processing modules each having a memory for storing a list composed of values and a transmitting path for logically connecting the plurality of processing modules to one another in a loop and transmits/receives and processes data among the plurality of processing modules, the functions being executed by a computer of each of the processing modules, wherein the program includes: (a) a function that transmits a first list composed of values stored in the memory of each of the processing module to the other processing modules in the information processing system; (b) a function that receives at least one second list composed of values transmitted to each of the processing modules, the other processing modules; (c) a function that compares the values of the second list with the values of the first list; and (d) a function which, when a value of the second list is identical to a value of the first list, increases a counter corresponding to the identical value of the first list by one.

In accordance with an embodiment of the present invention, there is provided a program for embodying the following functions in an information processing system which includes a plurality of processing modules each having a memory for storing a list composed of values and a transmitting path for logically connecting the plurality of processing modules to one another in a loop and transmits/receives and processes data among the plurality of processing modules, the functions being executed by a computer of each of the processing modules and wherein the program includes: (a) a function that transmits a first list which is composed of pairs of a value and the number of value stored in the memory of each of the processing modules to the other processing modules in the information processing system; (b) a function that receives at least one second list which is composed of the pairs of value and the number of value transmitted to each of the processing modules, from the other processing modules; (c) a function that compares the values of the second list with the values of the first list; and (d) a function which, when a value of the second list is identical to a value of the first list, increases a counter corresponding to the identical value of the first list by the number of the values corresponding to the value of the second list.

In accordance with a fifteenth embodiment of the present invention, there is provided a program for embodying the following functions in an information processing system which includes a plurality of processing modules each having a memory for storing a list composed of values and a transmitting path for logically connecting the plurality of processing modules to one another in a loop and transmits/receives and processes data among the plurality of processing modules, the functions being executed by a computer of each of the processing modules, wherein the program includes: (a) a function that transmits a first list composed of values stored in the memory of each of the processing modules to the other processing modules in the information processing system; (b) a function which receives at least one second list composed of values transmitted to each of the processing modules, from the other processing modules; (c) a function that compares the values of the second list with the values of the first list; and (d) a function which, when a value which ranks lower than a value of the second list exists in the first list, increases a counter corresponding to the value of the first list, which ranks immediately next to the value of the second list, by one.

In accordance with a sixteenth embodiment of the present invention, there is provided a program for embodying the following functions in an information processing system which includes a plurality of processing modules each having a memory for storing a list composed of values and a transmitting path for logically connecting the plurality of processing modules to one another in a loop and transmits/receives and processes data among the plurality of processing modules, the functions being executed by a computer of each of the processing modules and wherein the program includes: (a) a function that transmits a first list, which is composed of pairs of a value and the number of value stored in the memory of each of the processing modules, to the other processing modules in the information processing system; (b) a function that receives at least one second list which is composed of the pairs of value and the number of value transmitted to each of the processing modules, from the other processing modules; (c) a function that compares the values of the second list with the values of the first list; and (d) a function which, when a value which ranks lower than a value of the second list exists in the first list, increases a counter corresponding to the value of the first list ranked immediately next to the value in the second list by the number of the values corresponding to the value of the second list.

In accordance with a seventeenth embodiment of the present invention, there is provided a program for embodying the following functions in an information processing system which includes a plurality of processing modules each having a memory for storing a list composed of values and a transmitting path for logically connecting the plurality of processing modules to one another in a loop and transmits/receives and processes data among the plurality of processing modules, the functions being executed by a computer of each of the processing modules and wherein the program includes: (a) a function that transmits a first list composed of values stored in the memory of each of the processing modules to the other processing modules in the information processing system; (b) a function that receives at least one second list composed of values transmitted to each of the processing modules from other processing modules; (c) a function which, when a value of the second list exists in the first list, cancels the value of the second list, and, when the identical values exist in two or more second lists, cancels the value of one or more second lists, which appear later among the two or more second lists; and (d) a function which, when a value which ranks lower than a value of the second list exists in the first list, increases a counter corresponding to the value of the first list, which ranks immediately next to the value of the second list, by one.

In accordance with an eighteenth embodiment of the present invention, there is provided a program according to any one of the thirteenth through the seventeenth embodiments, wherein each of the processing modules comprises a memory that stores table-format data represented by an array of records including field values contained in an information field in a form of a value list in which the field values are stored in order of field value numbers corresponding to the field values and an array of pointers in which information for specifying the field value numbers is stored in order of records, and wherein the list composed of the values is the value list, which constructs the table-format data. In accordance with a nineteenth embodiment of the present invention, there is provided a computer-readable recoding medium having the program according to any one of the program embodiment (i.e., the thirteenth to the eighteenth embodiments) recorded thereon.

### SUMMARY OF THE INVENTION

The proposed method and apparatus for searching for and tabulating the table-format data uses the new data management mechanism which is usable on an ordinary computer system. In principle, the data management mechanism has a value management table and an array of pointers to the value management table.

### BRIEF DESCRIPTION OF THE DRAWINGS

FIG. 1 is an explanatory diagram illustrating a conventional data management mechanism.

FIG. 2 is an explanatory diagram illustrating a conventional data management mechanism.

FIG. 3 is a block diagram schematically showing an information processing system according to an embodiment of the invention.

FIG. 4 is a view showing an example of the structure of a PMM according to an embodiment of the invention.

FIG. 5 is an explanatory diagram illustrating an example of table-format data.

FIG. 6 is an explanatory diagram illustrating a storage structure of conventional table-format data.

FIG. 7 is an explanatory diagram illustrating a storage structure of table-format data according to an embodiment of the invention.

FIG. 8 is a flowchart of a tabulating process according to an embodiment of the invention.

FIG. 9 is an explanatory diagram illustrating the result of a local sorting process.

FIG. 10 is an explanatory diagram illustrating a rank assigning process according to an embodiment of the invention.

FIG. 11 is an explanatory diagram illustrating a local dimension value number assigning process according to an embodiment of the invention.

FIG. 12 is an explanatory diagram illustrating a global dimension value number assigning process according to an embodiment of the invention.

FIG. 13 is an explanatory diagram illustrating the result of the global dimension value number assigning process.

FIG. 14 is an explanatory diagram illustrating a local tabulating process according to Embodiment 1 of the invention.

FIG. 15 is an explanatory diagram illustrating the local tabulating process according to Embodiment 1 of the invention.

FIG. 16 is an explanatory diagram illustrating a first global tabulating process according to Embodiment 1 of the invention.

FIG. 17 is an explanatory diagram illustrating calculation of the global tabulation result according to Embodiment 1 of the invention.

FIG. 18 is an explanatory diagram illustrating a process for preventing a global tabulation value from being repeated, according to Embodiment 1 of the invention.

FIG. 19 is an explanatory diagram illustrating a process for generating a result table according to Embodiment 1 of the invention.

FIG. 20 is an explanatory diagram illustrating the result table according to Embodiment 1 of the invention.

FIG. 21 is an explanatory diagram illustrating a second global tabulating method according to Embodiment 1 of the invention.

FIG. 22 is a flowchart of a rank assigning method according to Embodiment 1 of the invention.

FIG. 23 is an explanatory diagram illustrating the rank assigning method according to Embodiment 1 of the invention, wherein FIG. 23A shows a first step, FIG. 23B shows a second step, FIG. 23C shows a third step, and FIG. 23D shows a fourth step.

FIG. 24 is an explanatory diagram illustrating the rank assigning method according to Embodiment 1 of the invention, wherein FIG. 24A shows a first step, FIG. 24B shows a second step, FIG. 24C shows a third step, and FIG. 24D shows a fourth step.

FIG. 25 is an explanatory diagram illustrating a local tabulating process according to Embodiment 2 of the invention.

FIG. 26 is an explanatory diagram illustrating the local tabulating process according to Embodiment 2 of the invention.

FIG. 27 is an explanatory diagram illustrating a first global tabulating method according to Embodiment 2 of the invention.

FIG. 28 is an explanatory diagram illustrating calculation of the global tabulation result according to Embodiment 2 of the invention.

FIG. 29 is an explanatory diagram illustrating a process for preventing the global tabulation result from being repeated, according to Embodiment 2 of the invention.

FIG. 30 is an explanatory diagram illustrating a process for generating a result table according to Embodiment 2 of the invention.

FIG. 31 is an explanatory diagram illustrating the result table according to Embodiment 2 of the invention.

FIG. 32 is an explanatory diagram illustrating a second global tabulating method according to Embodiment 2 of the invention.

FIG. 33 is an explanatory diagram illustrating an example of a storage structure of table-format data according to Embodiment 3 of the invention.

FIG. 34 is an explanatory diagram illustrating a counting process according to Embodiment 3 of the invention.

FIG. 35 is an explanatory diagram illustrating another counting process according to Embodiment 3 of the invention.

FIG. 36 is an explanatory diagram illustrating an example of a storage structure of table-format data according to Embodiment 4 of the invention.

FIGS. 37A to 37D are explanatory diagrams illustrating a rank assigning process according to Embodiment 4 of the invention, respectively.

FIG. 38 is a flowchart of the rank assigning process according to Embodiment 4 of the invention.

FIGS. 39A to 39E are explanatory diagrams illustrating a rank assigning process according to Embodiment 5 of the invention, respectively.

FIG. 40 is a flowchart of the rank assigning process according to Embodiment 5 of the invention.

FIGS. 41A to 41E are explanatory diagrams illustrating a rank assigning process according to Embodiment 6 of the invention.

FIG. 42 is a flowchart of the rank assigning process according to Embodiment 6 of the invention.

FIG. 43 is an explanatory diagram illustrating an example in a state where a compiling process is completed.

FIG. 44 is a flowchart of a local sorting process according to an embodiment of the invention.

FIG. 45 is an explanatory diagram illustrating an example of an initial state of a local sorting process.

FIG. 46 is an explanatory diagram illustrating an example of a counting-up process in each PMM.

FIG. 47 is an explanatory diagram illustrating an example of a process of generating an array of accumulated numbers.

FIG. 48 is an explanatory diagram illustrating an example of the array of accumulated numbers.

FIG. 49 is a detailed flowchart of the local sorting process.

FIG. 50 is an explanatory diagram illustrating an example in a state where the local sorting process is performed in each PMM.

FIG. 51 is an explanatory diagram illustrating an example in a state where the local sorting process is performed in each PMM.

FIG. 52 is an explanatory diagram illustrating an example in a state where the local sorting process is performed in each PMM.

FIGS. 53A to 53F are explanatory diagrams illustrating the local sorting processes according to the other embodiments of the invention, respectively.

### DETAILED DESCRIPTION OF THE INVENTION

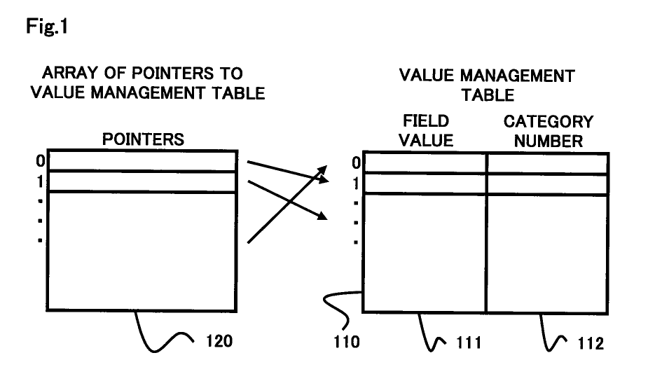

FIG. 1 is an explanatory diagram illustrating a conventional data management mechanism and shows a value management table 110 and an array of pointers to the value management table 120. The value management table 110 is defined as a table in which, for each field in table-format data, field values (reference numeral 111) corresponding to field value numbers and category numbers (reference numeral 112) related to the field values are stored in order of the ordered (integer-type) field value numbers which are assigned to the field values belonging to the fields. The array of pointers to the value management table 120 is defined as an array in which pointers to the field value numbers contained in a column (namely, a field) in the table-format data, that is, pointers to the value management table 110, are stored in order of the record numbers of the table-format data.

By combining the array of pointers to the value management table 120 with the value management table 110, when a certain record number is given, it is possible to extract the stored field value number corresponding to that record number using the array of pointers to the value management table 120 pertaining to the field in question, and then extract the stored field value corresponding to that field value number within the value management table 110, thereby obtaining the field value from the record number. Therefore, in the same manner as with a conventional data table, it is possible to access all data (field values) with coordinates consisting of the record number (row) and field (column).

The data management mechanism which includes the value management table generated for any one of the fields of table-format data and an array of pointers to the value management table may in particular be referred to as an “information block” in the following explanation.

While the conventional data table offers the integrated management of all data using the coordinates consisting of rows corresponding to records and columns corresponding to fields, the information blocks are characterized in that the data are completely separated by column in the table format, namely by field. According to this data management mechanism, since large amounts of data are separated by field, it is possible to load only the data related to the fields required for searching or tabulating processes into a high-speed storage device such as a memory, and as a result, the access time to the data is reduced and thus the searching and tabulating processes are speeded up. Accordingly, even data having an extremely large number of fields can be handled without adversely affecting performance.

In addition, in the case of the information blocks, since the field values are stored in the value management table and the record numbers which indicate the positions of the values are associated with the array of pointers to the value management table, there is no need for the field values to be arranged in order of the record numbers. Therefore, data can be sorted on field values to be suited to the searching and tabulating processes. To this end, the determination of whether or not a field value matching a target value exists in the data can be performed at high speed. Furthermore, since field value numbers correspond to the field values, even if the field values are composed of long data or text strings, the field values can be handled as integers.

Moreover, according to this data management mechanism, since all of the field value numbers of the value management table 110 correspond to different field values, the number of comparison operations between a specific value and the field values which are required to extract a record containing a field value having the specific value is no more than the number of the kinds of the field values, that is, the number of field value numbers, and thus the number of comparison operations is greatly decreased. Accordingly, the searching and tabulating processes are speeded up. At this time, a location is required to store the results of determining whether or not a certain field value matches, and thus, for example, the category number 112 can be used as this storage place.

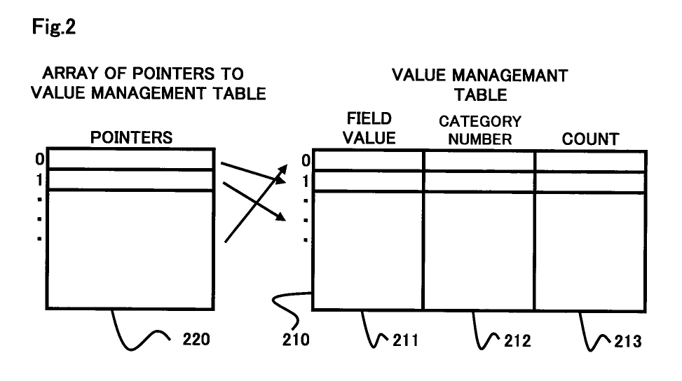

FIG. 2 shows an information block which includes a value management table 210 including an array of field values 211 containing the field values, an array of category numbers containing the category numbers, and an array of counts containing the counts. The array of counts 214 contains numbers which indicate how many field values of a certain field exists within all data, that is, the number of records which have a predetermined field value. By preparing such an array of counts 214 within the value management table 210, the information “which data exists? (how much does data exist?)”, “which row from the top this data is located?”, or “what is 00-th data from the top?” required at the time of searching, sorting or tabulating processes can be obtained immediately, thereby speeding up searching, sorting and tabulating processes.

However, even in the data management mechanism, as the number of the records increases, the list of the values or the array of pointers, especially the array of pointers very increases, but the amount of the processable data is restricted by used hardware resources.

Large-scale data processing is required even in the field other than the information processing on the table-format data. Recently, since computers are introduced into various places in a whole society and a network including Internet is widely used in these days, large amounts of data are accumulated here and there. In order to process large amounts of data, large amounts of calculations are required. To this end, it is natural that a parallel process is tried to be introduced.

A parallel process architecture is broadly classified into a “shared memory type” and a “distributed memory type”. The former (shared memory type) allows a plurality of processor to share an enormous memory space. In this manner, sine traffic between a group of processors and the shared memory bottlenecks, it is difficult to establish an actual system using at least hundred processors. Accordingly, for example, when calculating the square root of billion floating point variables, an acceleration ratio of a single CPU is at most 100. Experimentally, an upper limit of the acceleration ratio is about 30.

In the latter (distributed memory type), processors have respective local memories, which are combined to one another to establish a system. In this manner, it is possible to design a hardware system including several hundreds to several tens of thousands processors. Accordingly, when calculating the square root of billion floating point variables, an acceleration ratio of a single CPU can be several hundreds to several tens of thousands times.

[Patent Document 1] International Patent Publication No. WO 00/10103 pamphlet

### Problems to be Solved by the Invention

However, the parallel process architecture of “distributed memory type” has several problems.

[First problem: Divisional management of enormous array] A first problem of the “distributed memory type” relates to the divisional management of data.

Since enormous data (hereinafter, referred to as an array, because the enormous data is an array) cannot be stored in a local memory pertaining to a single processor, the enormous data is necessarily divided into a plurality of local memories and is managed. Unless an efficient and flexible divisional management mechanism is introduced, it is apparent that various problems are involved at the time of developing and executing a program.

[Second problem: low efficiency in communication among processors] When each processor of the distributed memory type system tries to access to an enormous array, each processor can rapidly access to an element of an array on its own local memory, but the access to an element of an array on a local memory pertaining to the other processor requires communication between the processors. The communication between the processors has performance lower than that of communication between local memories and thus it takes at least 100 clocks to perform the communication between the processors. To this end, at the time of sorting process, the whole enormous array must be accessed and thus the amount of the communication between the processors increases, thereby extremely deteriorating the performance.

Detailed description on this problem is as follows: In 1999, some of personal computers were constructed as the “shared memory type” computers using one to several CPUs. Since a typical CPU used in the personal computer operates in an internal clock which is five times to six times the clock of a memory bus and includes an automatic parallel executing function and a pipeline processing function, it is possible to process one piece of data in about one clock (memory bus). To this end, a “distributed memory type” multiprocessor system has many processors and thus the process speed thereof may be delayed by 100 times that of a single processor (shared memory type).

[Third problem: Provision of program] A third problem of the “distributed memory type” relates to how a program is provided to a plurality of processors. A MIMD (multiple instruction stream, multiple data stream) for loading respective programs to a plurality of processors and cooperatively operating all the programs requires a large load for preparing, compiling and transmitting the programs. In an SIMD (single instruction stream, multiple data stream) for operating a plurality of processors using a same program, the degree of freedom of the program is reduced and thus a program capable of obtaining a desired result may not be developed.

Accordingly, an information processing technology using the conventional distributed memory type parallel architecture, there is a need for processing large amounts of data while large amounts of data are held in each of the processors without being shared by the processors, such that the amount of the communication among the processors is reduced.

Accordingly, it is an object of the invention to provide an information processing method of processing data among a plurality of processors with a small amount of communication at high speed when large amounts of data are processed using a parallel computer architecture. In addition, it is another object of the invention to provide an information processing system for realizing the information processing method. In addition, it is another object of the invention to provide a program executed by a computer, for realizing the information processing method.

### Means for Solving the Problems

The invention employs a distributed memory type parallel processing architecture in which a value list which is a substantial element of table-format data, and an array of pointers are locally stored in an individual processing module and indexes such as sequence number (or orders) of data rather than data itself are globally held among the plural processing modules. In addition, the invention employs an algorithm for integrally controlling process and communication such that data stored in several memories is input/output and processed by a single command.

In order to achieve the above-described object, according to the first embodiment of the invention, there is provided an information processing method of transmitting/receiving and processing data among a plurality of processing modules in an information processing system in which the plurality of processing modules each having a memory for storing a list composed of values is logically connected to one another in a loop, comprising the steps of: allowing each of the processing modules to transmit a first list composed of values stored in the memory of each of the processing modules to the other processing modules in the information processing system; allowing each of the processing modules to receive at lease one second list composed of values transmitted from the other processing modules to each of the processing modules; allowing each of the processing modules to compare the values of the second list with the values of the first list; and when a value of the second list is identical to a value of the first list, allowing each of the processing modules to increase a counter corresponding to the identical value in the first list by one. Accordingly, when values such as integers, text strings and floating-point numbers are repeatedly distributed among the plurality of processing modules, the values can be mutually exchanged among the processing modules and thus the number of matched values can be counted.

In order to achieve the above-described object, according to the second embodiment of the invention, there is provided an information processing method of transmitting/receiving and processing data among a plurality of processing modules in an information processing system in which the plurality of processing modules each having a memory for storing a list composed of values is logically connected to one another in a loop, comprising the steps of: allowing each of the processing modules to transmit a first list which is composed of pairs of a value and the number of value stored in the memory of each of the processing module, to the other processing modules in the information processing system; allowing each of the processing module to receive at lease one second list which is composed of the pairs of value and the number of value transmitted to each of the processing module, from the other processing module; allowing each of the processing modules to compare the values of the second list with the values of the first list; and when a value of the second list is identical to a value of the first list, allowing each of the processing modules to increase a counter corresponding to the identical value in the first list by the number of the values identical to the value of the second list. Accordingly, when values such as integers, text strings and floating-point numbers are repeatedly distributed among the plurality of processing modules, upon counting the number of occurrence of the values matched by exchanging the values and the number of the values which exist in each of the processing modules, among the processing modules, a communication amount necessary for exchanging data can be reduced.

In order to achieve the above-described object, according to a third embodiment of the invention, there is provided an information processing method of transmitting/receiving and processing data among a plurality of processing modules in an information processing system in which the plurality of processing modules each having a memory for storing a list composed of values is logically connected to one another in a loop, comprising the steps of: allowing each of the processing modules to transmit a first list composed of values stored in the memory of each of the processing module to the other processing modules in the information processing system; allowing each of the processing modules to receive at lease one second list composed of values transmitted to each of the processing module, from the other processing module; allowing each of the processing modules to compare the values of the second list with the values of the first list; and when a value which ranks lower than a value of the second list exists in the first list, allowing each of the processing modules to increase a counter corresponding to the value of the first list, which ranks immediately next to the value of the second list, by one. Accordingly, when values such as integers, text strings and floating-point numbers are repeatedly distributed among the plurality of processing modules, the values can be mutually exchanged among the processing modules to calculate an accumulated number and thus ranks can be assigned to the values.

In order to achieve the above-described object, according to the fourth embodiment of the invention, there is provided an information processing method of transmitting/receiving and processing data among a plurality of processing modules in an information processing system in which the plurality of processing modules each having a memory for storing a list composed of values is logically connected to one another in a loop, comprising the steps of: allowing each of the processing modules to transmit a first list, which is composed of pairs of value and the number of value stored in the memory of each of the processing module, to the other processing modules in the information processing system; allowing each of the processing modules to receive at lease one second list which is composed of the pairs of value and the number of value transmitted to each of the processing module, from the other processing module; allowing each of the processing modules to compare the values of the second list with the values of the first list; and when a value which ranks lower than a value of the second list exists in the first list, allowing each of the processing modules to increase a counter corresponding to the value of the first list ranked immediately next to the value in the second list by the number of the values identical to the value of the second list. Accordingly, when values such as integers, text strings and floating-point numbers are repeatedly distributed among the plurality of processing modules, upon calculating accumulated number and ranking the values by exchanging the values and the number of the values which exist in each of the processing modules, among the processing modules, communication amount necessary for exchanging data can be reduced.

In order to achieve the above-described object, according to the fifth embodiment of the invention, there is provided an information processing method of transmitting/receiving and processing data among a plurality of processing modules in an information processing system in which the plurality of processing modules each having a memory for storing a list composed of values is logically connected to one another in a loop, comprising the steps of: allowing each of the processing modules to transmit a first list composed of values stored in the memory of each of the processing module to the other processing modules in the information processing system; allowing each of the processing modules to receive at lease one second list composed of values transmitted to each of the processing module, from the other processing module; when a value of the second list exists in the first list, allowing each of the processing modules to cancel the value of the second list, and, when the identical values exist in two or more second lists, allowing each of the processing modules to cancel the value of one or more second lists, which appear later among the two or more second lists; and when a value which ranks lower than a value of the second list exists in the first list, allowing each of the processing modules to increase a counter corresponding to the value of the first list, which ranks immediately next to the value of the second list, by one. Accordingly, when values such as integers, text strings and floating-point numbers are repeatedly distributed among the plurality of processing modules, the values can be mutually exchanged among the processing modules and thus a common sequence number, which shared among the plurality of the processing modules, can be assigned to the values of each of the plurality of processing modules.

According to the sixth embodiment of the invention, in the information processing method according to any one of the first to fifth embodiments, each of the processing modules stores table-format data represented by an array of records including field values contained in an information field in the memory in a form of a value list in which the field values are stored in order of field value numbers corresponding to the field values and an array of pointers in which information for specifying the field value numbers is stored in order of records, and the list composed of the values is the value list, which constructs the table-format data. Accordingly, data in the list is arranged in ascending order or descending order in advance and thus the operation for comparison can be performed at high speed.

In order to achieve the above-described object, according to a seventh embodiment of the invention, there is provided an information processing system which includes a plurality of processing modules each having a memory for storing a list composed of values and a transmitting path for logically connecting the plurality of processing modules to one another in a loop and transmits/receives and processes data among the plurality of processing modules, each of the processing modules comprising: a means which transmits a first list composed of values stored in the memory of each of the processing module to the other processing modules in the information processing system; a means which receives at lease one second list composed of values transmitted to each of the processing module, from the other processing module; a means which compares the values of the second list with the values of the first list; and a means which, when a value of the second list is identical to a value of the first list, increases a counter corresponding to the identical value in the first list by one. Accordingly, when values such as integers, text strings and floating-point numbers are repeatedly distributed among the plurality of processing modules, the values can be mutually exchanged among the processing modules and thus the number of matched values can be counted.

In order to achieve the above-described object, according to an eighth embodiment of the invention, there is provided an information processing system which includes a plurality of processing modules each having a memory for storing a list composed of values and a transmitting path for logically connecting the plurality of processing modules to one another in a loop and transmits/receives and processes data among the plurality of processing modules, each of the processing modules comprising: a means which transmits a first list which is composed of pairs of a value and the number of value stored in the memory of each of the processing module to the other processing modules in the information processing system; a means which receives at least one second list which is composed of the pairs of value and the number of value transmitted to each of the processing module, from the other processing module; a means which compares the values of the second list with the values of the first list; and a means which, when a value of the second list is identical to a value of the first list, increases a counter corresponding to the identical value in the first list by the number of the values corresponding to the value of the second list. Accordingly, when values such as integers, text strings and floating-point numbers are repeatedly distributed among the plurality of processing modules, upon counting the number of occurrence of the values matched by exchanging the values and the number of the values which exist in each of the processing modules, among the processing modules, communication amount necessary for exchanging data can be reduced.

In order to achieve the above-described object, according to a ninth embodiment of the invention, there is provided an information processing system which includes a plurality of processing modules each having a memory for storing a list composed of values and a transmitting path for logically connecting the plurality of processing modules to one another in a loop and transmits/receives and processes data among the plurality of processing modules, each of the processing modules comprising: a means which transmits a first list composed of values stored in the memory of each of the processing module to the other processing modules in the information processing system; a means which receives at least one second list composed of values transmitted to each of the processing module, from the other processing module; a means which compares the values of the second list with the values of the first list; and a means which, when a value which ranks lower than a value of the second list exists in the first list, increases a counter corresponding to the value of the first list, which ranks immediately next to the value of the second list, by one. Accordingly, when values such as integers, text strings and floating-point numbers are repeatedly distributed among the plurality of processing modules, the values can be mutually exchanged among the processing modules to calculate an accumulated number and thus ranks can be assigned to the values.

In order to achieve the above-described object, according to a tenth embodiment of the invention, there is provided an information processing system which includes a plurality of processing modules each having a memory for storing a list composed of values and a transmitting path for logically connecting the plurality of processing modules to one another in a loop and transmits/receives and processes data among the plurality of processing modules, each of the processing modules comprising: a means which transmits a first list, which is composed of pairs of a value and the number of value stored in the memory of each of the processing module, to the other processing modules in the information processing system; a means which receives at least one second list which is composed of the pairs of value and the number of value transmitted to each of the processing module, from the other processing module; a means which compares the values of the second list with the values of the first list; and a means which, when a value which ranks lower than a value of the second list exists in the first list, increases a counter corresponding to the value of the first list ranked immediately next to the value in the second list by the number of the values corresponding to the value of the second list. Accordingly, when values such as integers, text strings and floating-point numbers are repeatedly distributed among the plurality of processing modules, upon calculating accumulating totals and ranking the values by exchanging the values and the number of the values which exist in each of the processing modules, among the processing modules, data amount necessary for exchanging data can be reduced.

In order to achieve the above-described object, according to the eleventh embodiment of the invention, there is provided an information processing system which includes a plurality of processing modules each having a memory for storing a list composed of values and a transmitting path for logically connecting the plurality of processing modules to one another in a loop and transmits/receives and processes data among the plurality of processing modules, each of the processing modules comprising: a means which transmits a first list composed of values stored in the memory of each of the processing module to the other processing modules in the information processing system; a means which receives at least one second list composed of values transmitted to each of the processing module, from other processing module; a means which, when a value of the second list exists in the first list, cancels the value of the second list, and, when the identical values exist in two or more second lists, cancels the value of one or more second lists, which appear later among the two or more second lists; and a means which, when a value which ranks lower than a value of the second list exists in the first list, increases a counter corresponding to the value of the first list, which ranks immediately next to the value of the second list, by one. Accordingly, when values such as integers, text strings and floating-point numbers are repeatedly distributed among the plurality of processing modules, the values can be mutually exchanged among the processing modules and thus a common sequence number, which shared among the plurality of the processing modules, can be assigned to the values of each of the plurality of processing modules.

According to the twelfth embodiment of the invention, in the information processing method according to any one of the seventh to eleventh embodiments, each of the processing module comprises the memory which stores table-format data represented by an array of records including field values contained in an information field in a form of a value list in which the field values are stored in order of field value numbers corresponding to the field values and an array of pointers in which information for specifying the field value numbers is stored in order of records, and the list composed of the values is the value list, which constructs the table-format data. Accordingly, data in the list is arranged in ascending order or descending order in advance and thus the operation for comparison can be performed at high speed.

In order to achieve the above-described object, according to any one of the thirteenth to the eighteenth embodiments of the invention, there is provided a program for causing a computer to carry out the steps of the information processing method or for causing the computer to perform the functions of the information processing system. Accordingly, it is possible to provide a program for causing the computer to perform various functions according to the present invention. This program can be provided to the computer using a communication line or a recording medium.

According to the eighteenth embodiment of the invention, there is provided a computer-readable recoding medium having the program according to any one of the thirteenth to seventeenth embodiments recorded thereon.

### EFFECT OF THE INVENTION

According to the invention, it is possible to provide an information processing method and an information processing system capable of realizing a parallel process at high speed by using a new data structure and parallel processing algorithm based on a distributed memory type parallel processing architecture.

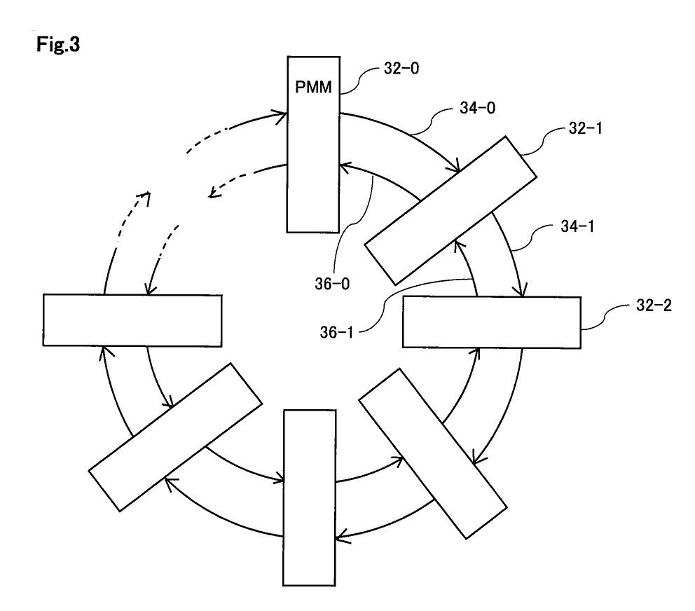

### BEST MODE FOR CARRYING OUT THE INVENTION

[Hardware construction] Hereinafter, embodiments of the invention will be described with reference to the attached drawings. FIG. 3 is a block diagram schematically illustrating an information processing system according to an embodiment of the invention. In the present embodiment, a processing module is constructed by a memory module with a processor (hereinafter, referred to as “PMM”). As shown in FIG. 3, in the present embodiment, in order to logically connect a plurality of processing modules in a loop, memory modules PMM 32-0, PMM 32-1, PMM 32-2, . . . having a plurality of processors are arranged in a ring, and adjacent memory modules are connected to each other by a first bus (for example, reference numerals 34-0 and 34-1) for transmitting data in a clockwise direction and a second bus (for example, reference numerals 36-0 and 36-1) for transmitting data in a counterclockwise direction. Packet communication among the PMMs is performed through the first bus and the second bus. In the present embodiment, a transmitting path (packet transmitting path) for performing the packet communication is referred to as the first bus and the second bus.

In the present embodiment, the PMMs are connected to one another in the ring through the first bus (first transmitting path) for transmitting a packet in a clockwise direction and the second bus (second transmitting path) for transmitting a packet in a counterclockwise direction. This construction is advantageous because a packet transmission delay time can be equalized.

The physical connection among the processing modules is not limited to the present embodiment, and may be variously changed such that the processing modules can be logically connected in the loop. For example, various types of connections such as a bus type, a star type and so on may be used.

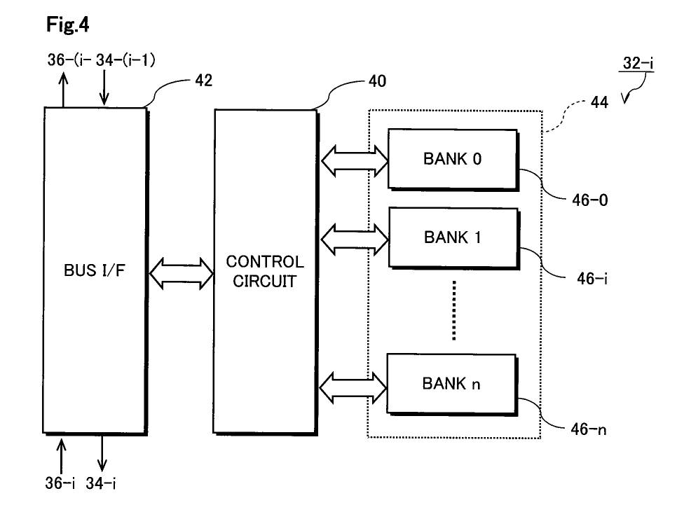

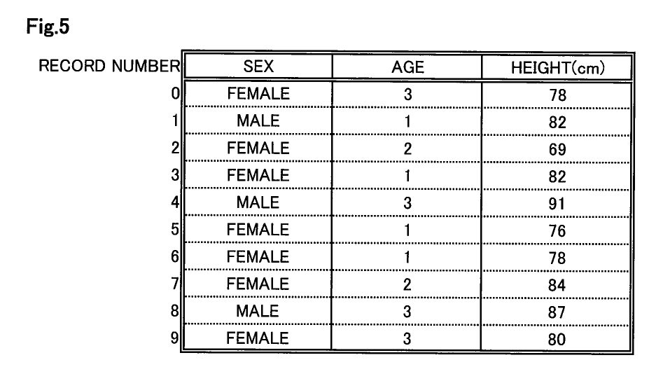

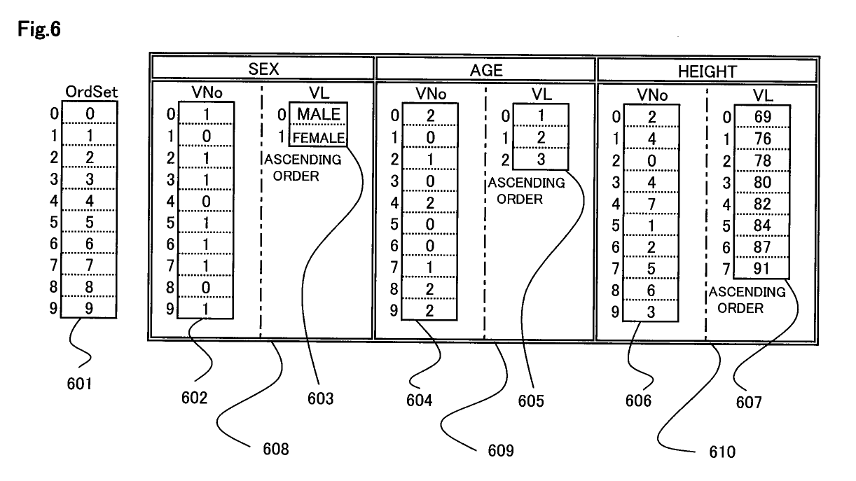

FIG. 4 shows an example of the structure of the PMM 32. As shown in FIG. 4, each PMM 32-i includes a control circuit 40 for controlling access to a memory and execution of operation according to a common command of the PMMs, a bus interface (I/F) 42, and a memory 44. The memory 44 has a plurality of banks BANK 0, 1, . . . , and n (reference numerals 46-0, . . . , and n) and can store the below-described array. The control circuit 40 can transmit/received at a to/from an external computer. The control circuit 40 may allow a different computer to access to a desired bank of the memory by the bus arbitration.

[Object to be processed] An example of the information process in the present embodiment is a tabulating process. The tabulation is, for example, defined as tabulation of field values (measure) contained in a different field for each field value (dimension value) of a certain field (dimension) from table-format data represented by an array of records including field values corresponding to an information field. The tabulation of the measure may be defined as counting of the number of measures, calculation of the sum of the measures, or calculation of the average of the measures. The number of the dimensions may be at least two. For example, FIG. 5 is logical table-format data showing sex, age and height of children in any child-care center. A process for obtaining the number of persons by sex or the sum of the heights of persons by sex/age belongs to the tabulating process which is an example of the information process according to the present embodiment.

[Conventional data storage structure] The table-format data shown in FIG. 5 is stored as a data structure shown in FIG. 6 in a single computer by using the data management mechanism proposed in the above-described International Patent Publication No. WO00/10103. As shown in FIG. 5, in an array 601 (hereinafter, abbreviated to “OrdSet”) for matching sequence numbers of the records of the table-format data with other sequence numbers of internal data, the sequence numbers of the internal data are arranged as values for the records of the table-format data. In this example, since the entire table-form at data is represented by the internal data, the record number of the table-format data is identical to the sequence number of the internal data.

For example, it can be seen from the array OrdSet 601 that, in the set, the order of the internal data corresponding to the record 0 of the table-format data is “0”. The actual sex value of the record having the order “0”, that is, “male” or “female”, can be retrieved by using an array of pointers 602 (hereinafter, the array of pointers is abbreviated to “VNo”) to a value list 603 (hereinafter, the value list is abbreviated to “VL”) in which actual values are sorted in a predetermined order. The array of pointers 602 stores pointers indicating an element of the actual value list 603 in the order stored in the array OrdSet 601. Accordingly, the field value of the sex corresponding to the record “0” of the table-format data can be retrieved by (1) retrieving the order “0” corresponding to the record “0” from the array OrdSet 601, (2) retrieving the element “1” corresponding to the order “0” from the array of pointers 602 to the value list, and (3) retrieving the element “female” indicated by the element “1” retrieved from the array of pointers 602 to the value list from the value list 603. Even in the other records or the age and the height, it is possible to retrieve the field value in the same way.

The table-format data is expressed by the combination of the value list VL and the array of pointers VNo to the value list and the combination is also referred to as “information block”. In FIG. 6, the information blocks on the sex, the age and the height are shown by information blocks 608, 609 and 610, respectively.

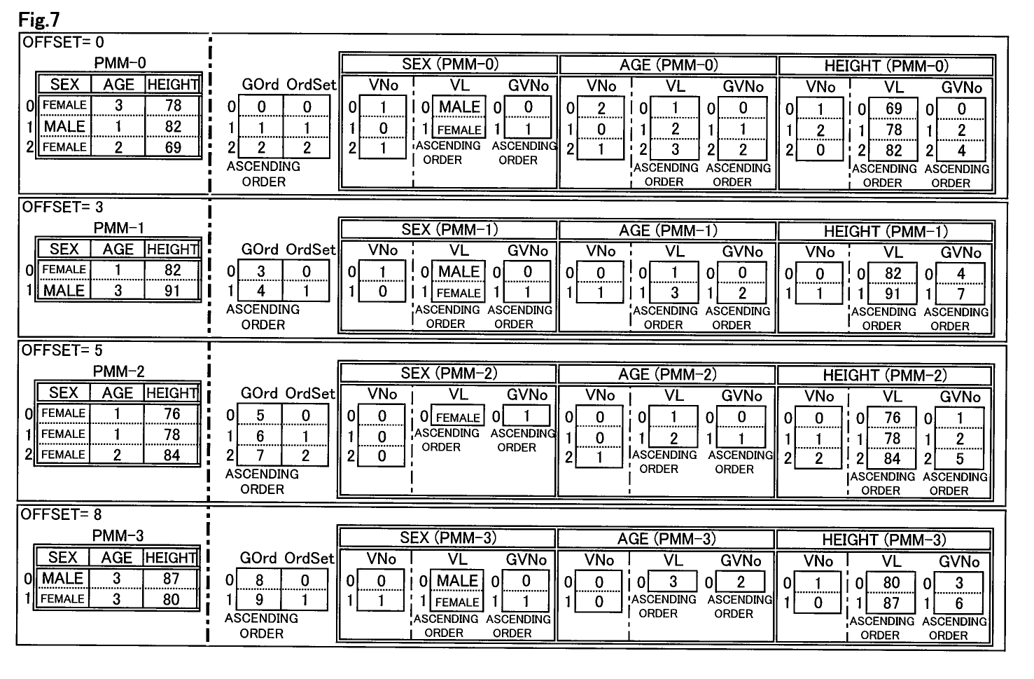

When a single computer has a single memory (a plurality of memories which is physically provided and accessed in a single address space may be considered to the single memory), the array of order sets OrdSet, the value list VL for configuring the information blocks and the array of pointers VNo are stored in the memory. However, in order to hold large amounts of records, the capacity of the memory increases depending on the size of the records and thus the records need be preferably distributed. In view of the parallelization of the process, it is preferable that the distributed information is separately managed. Accordingly, in the present embodiment, the plurality of PMMs separately manages the record data without being duplicated and performs tabulation at high speed by the packet communication among the PMMs.

[Data storage structure according to the present embodiment] FIG. 7 is an explanatory diagram illustrating a data storage structure according to an embodiment of the invention. In FIG. 7, for example, the table-format data shown in FIGS. 5 and 6 is distributed to four processing modules PMM-0, PMM-1, PMM-2 and PMM-3 and separately managed. For the convenience of explanation, the number of the processing modules is four, but the invention is not limited by the number of the processing modules.

In the present embodiment, in order to assign the rank to the record which is separately managed by each PMM in all the records included in the four PMMs PMM-0 to PMM-3, global record numbers are assigned to the records. In FIG. 7, the global record numbers are represented by “GOrd”. The global record numbers GOrd represents which rank each element of the array OrdSet in each PMM occupies in all the records. Since the array OrdSet is arranged such that the ranks of all data are mapped into each of the PMMs with the rank preserved, the array of global record numbers GOrd may be arranged in the ascending order. In addition, in each PMM, the size of the array GOrd (=array of global order sets) is identical to that of the array OrdSet (array of order sets).

In the present embodiment, a global field value number for representing in which order the field value separately controlled in each PMM, that is, each value of the value list VL, is in the field values included in all the PMMs is set. In FIG. 7, the global field value number is shown as “GVNo”. Since the value list VL is arranged in order of the values (for example, ascending order or descending order), the array of the global field value numbers GVNo is set in the ascending order (or descending order). The size of the array GVNo is identical to that of the array VL. By identifying in which order the field values included in the processing module are in all the field values, it is possible to integrate the tabulation results of the respective processing modules.

In FIG. 7, a value OFFSET assigned to each PMM represents which order a first record divided by the PMM is in the integrated records shown in FIG. 6. As described above, the array OrdSet of each PMM is arranged such that the rank of all data is preserved in each PMM, the sum of the offset value OFFSET and the value of the element of the array OrdSet in the PMM is identical to the array of global record numbers GOrd. Preferably, the offset value is notified to each PMM and each PMM may determine the global record numbers based on the offset value OFFSET.

The array of global record numbers GOrd and the array of global field value numbers GVNo of each PMM may be previously calculated by the outside of each PMM to be set to each PMM or may be set by each PMM using the below-described compiling process.

[Array of global sets GOrd and array of global field value numbers GVNo] Next, the array GOrd and the array GVNo used in the present embodiment will be described. The array of global order set GOrd represents the location (rank) of each record in the global table-format data obtained by collecting local table-format data of the respective PMMs. That is, in the present embodiment, the location information of the record is divided into a global component and a local component by the array of global order sets GOrd and the array of order sets OrdSet and thus the global table-format data can be processed while each PMM can separately handle the data.

In the following description of the embodiments, the PMM has the information block for each field. However, even in a case where the PMM has raw table-format data, the array GOrd similarly functions.

For example, in the following embodiments where the compiling process is completed, the field value for each field is retrieved in order of the values of the array of global order sets GOrd to generate the entire view of all the table-format data.

### EMBODIMENT 1

[Tabulating process] Next, the tabulating process according to the present embodiment will be described. A tabulating algorithm according to Embodiment 1 is constructed to perform an identical process in all the processing modules. The tabulating algorithm is constructed to perform the tabulating process by applying a single tabulating process command to a plurality of processing modules and operating the plurality of processing module in parallel. Since all the processing modules perform the identical operation, it is possible to realize a parallel process only by preparing one program.

In the tabulating algorithm according to Embodiment 1, a shared global dimension value number is assigned to dimension values for tabulation in all the process modules, measures are tabulated for each the dimension value number in each of the processing modules, and the measures are tabulated globally, that is, in all the processing modules. To this end, according to the tabulating algorithm according to Embodiment 1, the value list and the array of pointers to the value list are locally held in each of the processing modules. According to this tabulating algorithm, the value list and the array of pointers are not commonly held in the plurality of processing modules and a reference, in other words, the rank of the dimension value is globally held in the plurality of processing modules. As the result, since the accesses from the plurality of processing modules to the mutual memories, for obtaining data necessary for the tabulation, is avoided and only data necessary for determining the rank of the dimension value is communicated among the processing modules, the amount of the communication is reduced and the process is speeded up.

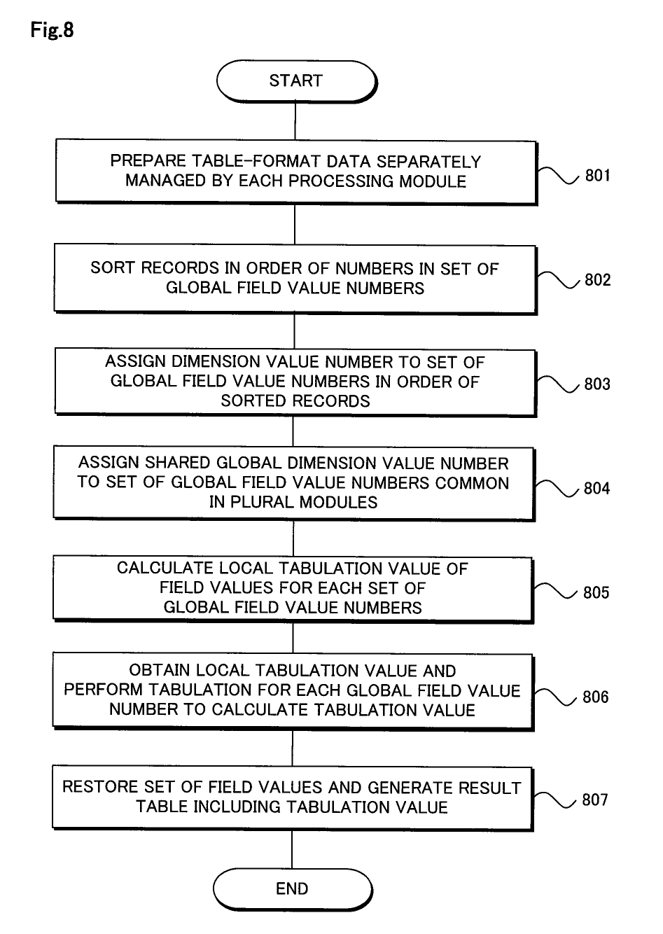

FIG. 8 is a flowchart of the tabulating process according to Embodiment 1. As shown in FIG. 8, first, table-format data separately managed by each of the processing modules is prepared (step 801). More specifically, each of the processing modules stores global record numbers uniquely assigned to the records of the relevant processing module in the plurality of processing modules and global field value numbers assigned to the field values of the relevant processing module such that the global field value numbers are ranked among the plurality of processing modules in the memory.

Next, each of the processing modules sorts the records in order of the numbers in the set of global field value numbers of the fields specified in at least one dimension (step 802).

Each of the processing modules assigns the dimension value numbers to the set of global field value numbers corresponding to the records in order of the sorted records and stores them in the memory of each of the processing modules (step 803).

Next, each of the processing modules obtains the sets of global field value numbers from the other processing modules, counts the number of the sets which rank higher than the set of global field value numbers of the relevant processing module, and increases the dimension value number of the set of global field value numbers of the relevant processing module by the counted number, such that the shared global dimension value number is assigned to the set of global field value numbers in the plurality of processing modules (step 804).

Subsequently, each of the processing modules tabulates field values of the field of any information according to a predetermined rule to calculate a local tabulation value for each set of global field value numbers (step 805). Finally, each of the processing modules obtains the local tabulation value for each set of global field value numbers from the other processing modules and tabulates the obtained tabulation value for each set of global field value numbers to calculate the tabulation value (step 806).

After the step 806 for calculating the tabulation value, each of the processing modules restores the set of field values from the set of global field value numbers and generates a result table including the set of field values and the tabulation value corresponding to the set of field values (step 807). As the result, since the table is held in a table form, it is possible to easily obtain different dimensional tabulation by tabulating the table again. For example, it is possible to easily obtain the tabulation result by sex from the tabulation result obtained by age/sex.

The tabulating process according to Embodiment 1 will be described in detail based on the table-format data shown in FIG. 5. For example, when the table-format data shown in FIG. 5 is separately managed by the plurality of processing modules and the above-described step 801 is performed, the data storage structure shown in FIG. 7 is obtained.

A tabulating process “for obtaining the number of the persons by sex/age” or a tabulating process “for obtaining the sum of the heights of the persons by sex/age” is applicable to the data shown in FIG. 7. The sex and age are dimensions and the number of the persons and the heights of the persons are measures. The number of the persons can be tabulated by increasing the count corresponding to a matched dimension by a specific number and the sum of the heights of persons can be tabulated by adding the field value of the height corresponding to a matched dimension. In Embodiment 1, a number counting process for obtaining the sum of the heights of the persons by sex/age will be described.

In the step 802, in each of the processing modules, that is, each local environment, the records of the data shown in FIG. 7 are sorted in two dimensions including the dimension “age” and the dimension “sex”. In a case of two-dimensional sorting, the sort is sequentially performed in proper order of dimension. In general, as the number of the kinds of the field values increases, the rank is frequently replaced according to the sort. Accordingly, it is efficient that the sort is performed in descending order from the dimension having large kinds of field values. In the present embodiment, when the sex and the age are compared, since the number of the kinds (three: one year old, two years old and three years old) of the field values of the age is larger than that of the kinds (two: male and female) of the field values of the sex, the sort is performed in order of the age and the sex.

In the present embodiment, the sort in the local environment corresponds to replacement of the ranks of the elements of the array of order sets OrdSet. For example, it is assumed that the initial elements of the array of the order sets are 0 (that is, record 0), 1 (that is, record 1) and 2 (that is, record 2), and the value of the age of the record 0 is 3, the value of the age of the record 1 is 1 and the value of the age of the record 2 is 2. When the records are rearranged in ascending order of age, the record 1, the record 2 and the record 3 are sequentially arranged. The sorted result is displayed by replacing the array of the order sets in order of 1, 2 and 0. For the next process, the order after the local sort is set to the array OrdSet of the order sets.

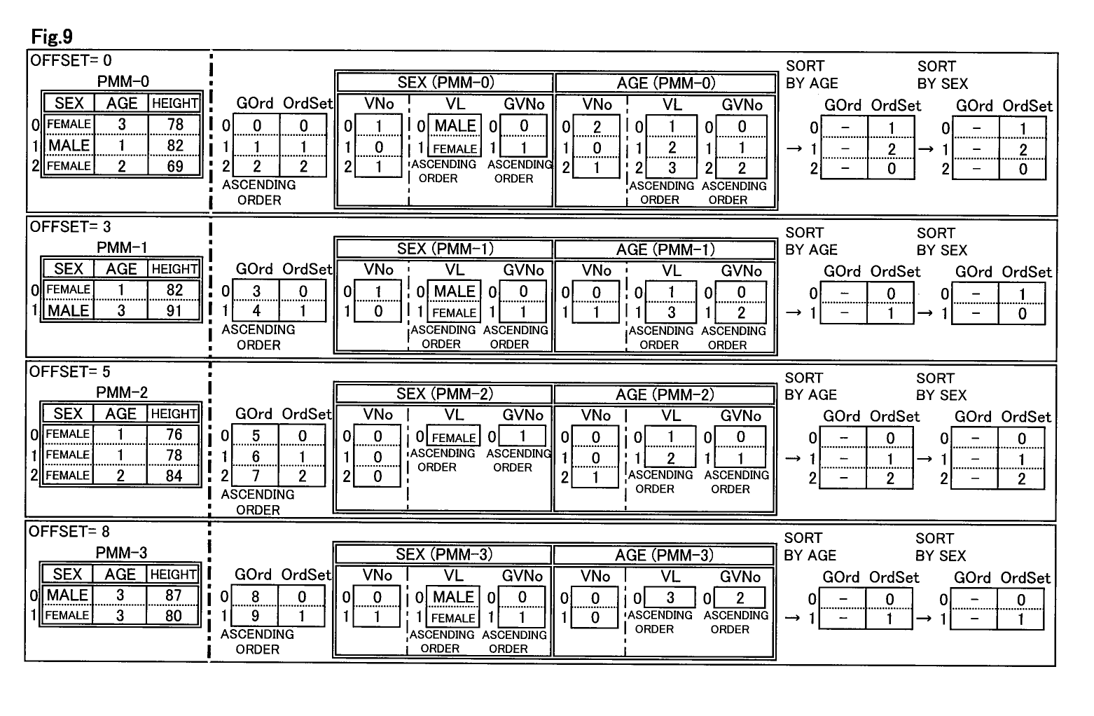

FIG. 9 shows a result obtained by sequentially sort the data shown in FIG. 7 by age or sex in each of the processing modules. In FIG. 9, for simplification, the information block on the height is not shown. The sort by the age is performed in ascending order and the sort by the sex is performed in order of male and female. By this local sort, the records in PMM-0 are ranked in order of the record 1 (male, one year old, 82 cm), the record 2 (female, two years old, 69 cm) and the record 0 (female, three years old, 78 cm), the records in PMM-1 are ranked in order of the record 1 (male, three years old, 91 cm) and the record 0 (female, one year old, 82 cm), the records in PMM-2 are ranked in order of the record 0 (female, one year old, 76 cm), the record 1 (female, one year old, 78 cm) and the record 2 (female, two years old, 84 cm), and the records in PMM-3 are ranked in order of the record 0 (male, three year old, 87 cm) and the record 1 (female, three years old, 80 cm). This local sort will be described later.

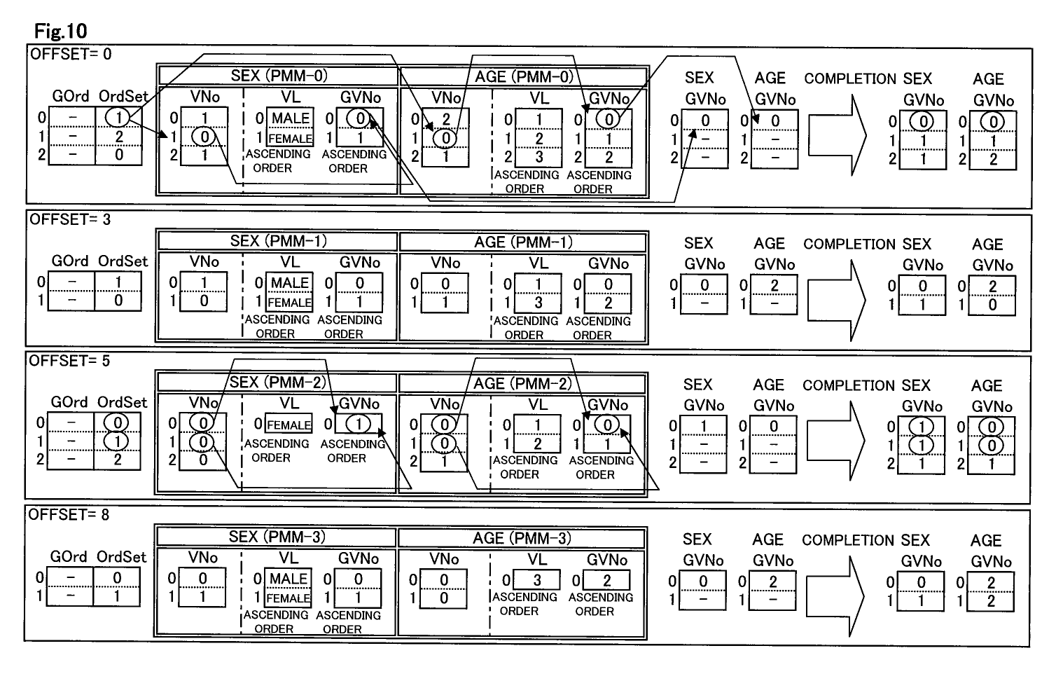

In the step 803, each of the processing modules assigns a sequence number to the set of field value numbers of the selected dimension (sex and age in the present embodiment) in order of the locally sorted record (that is, in order of the elements of array of order sets OrdSet after replacement). FIG. 10 is an explanatory diagram illustrating a sequence number assigning process according to the present embodiment. For simplification, the information block on the height is omitted.

With respect to the record 1 of the PMM-0, the value number of the sex is “0” and the global field value number corresponding to the value number “0” is “0”. The value number of the age is “0” and the global field value number corresponding to the value number of the age “0” is “0”. Accordingly, the set of the field value numbers corresponding to the record 1 in the PMM-0 is (0, 0) and the ranks are assigned to (0, 0) in order of the locally sorted records. Assigning the rank to the set of field value numbers can be realized by internally applying the identical rank “0” to the global field value number of the sex and the global field value number of the age. In the present example, since the record 1 in the PMM-0 is a first record sorted locally, the rank “0” is assigned to the set of field value numbers (0, 0). Since the records in the PMM-0 is ranked in order of the record 1, the record 2 and the record 0, the rank “1” is assigned to the set of global field value numbers (1, 1) corresponding to the record 2 and the order “2” is assigned to the set of global field value numbers (1, 2) corresponding to the record 0.

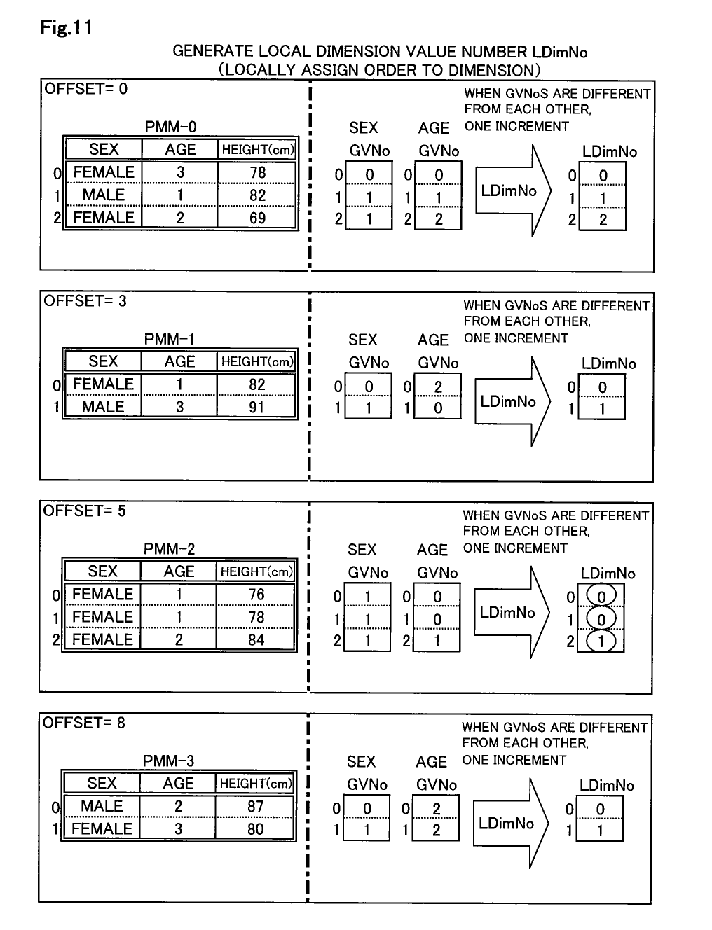

Since the order is set in correspondence with the record, when the number of the records having the identical dimension value is at least two in the PMM, an individual order is assigned to each record. For example, in FIG. 10, since both the record 0 and the record 1 in the PMM-2 are female and one year old, both the sets of global field value numbers thereof are (0, 1). For searching or sorting processes, different records need be separately treated even when the sets of global value numbers are identical. For example, by combining the set of global field value numbers and the array of global record numbers GOrd, all the records can be separately treated. However, for tabulating process, the records having the identical set of global field value numbers, that is, the records having the identical dimension value, must be treated as the identical dimension. To this end, in the present embodiment, the order is reassigned such that the identical rank is assigned to the records having the identical set of global field value numbers. Hereinafter, the reassigned rank is referred to as local dimension value number LDimNo. The local dimension value number increases one by one when the sets of global field value numbers are different from each other. FIG. 11 is an explanatory diagram illustrating a local dimension value number assigning process. In this example, in the PMM-0, PMM-1 and PMM-3, the order and the local dimension value number are identical to each other, but, in the PMM-2, the local dimension value numbers become “0”, “0” and “1” in order of the sorted record.

Next, in the step 804, each of the processing modules converts the local dimension value number LDimNo given to the set of global field value numbers into a common global dimension value number GDimNo in the plurality of processing modules to assign global ranks to the dimension values. When the global ranks are assigned to the dimension values, tabulation is performed for each dimension value in each of the processing modules and the tabulation results are integrated, thereby obtaining a total tabulation result, as described below.

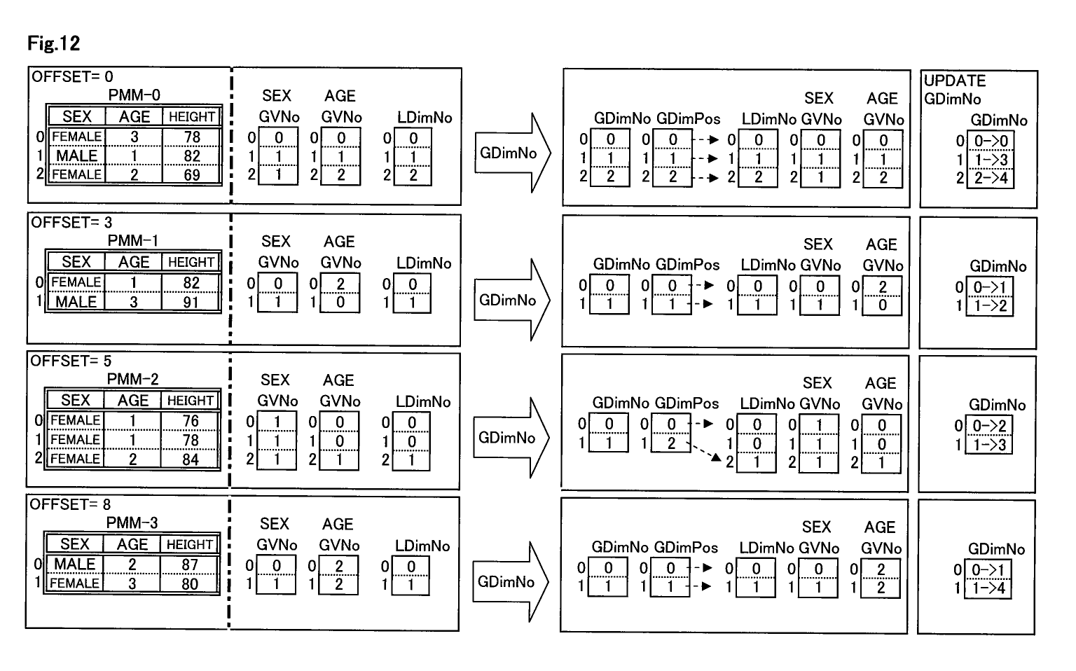

FIG. 12 is an explanatory diagram illustrating a global dimension value number assigning process. The process for assigning the global dimension value number commonly assigns the ranks to the sets of global field value numbers ranked in each of the processing modules, in the plurality of processing modules. To this end, each of the processing modules provides the region for the global dimension value number GDimNo and generates an initial value of the global dimension value number GDimNo from the local dimension value number LDimNo. In the records assigned with the identical local dimension value number LDimNo, only one region for the global dimension value number GDimPos is provided. To this end, a correspondence table GDimPos between the global dimension value number GDimNo and the local dimension value number LDimNo is simultaneously generated.

Next, each of the processing modules obtains the sets of global field value numbers from the other processing modules, counts the number of the sets ranked higher than the set of global field value numbers of the relevant processing module, and increases the global dimension value number of the set of global field value numbers of the relevant processing module by the counted number, such that the common global dimension value number is assigned to the sets of global field value numbers in the plurality of processing modules. In a method of assigning a common sequence number in the plurality of processing modules, that is, the global dimension value number, to a value individually ranked in each of the processing modules, that is, the local dimension value number, a duplication of the identical value must be eliminated such that different global dimension value numbers are not assigned to the identical value. Such a rank assigning method will be described later.

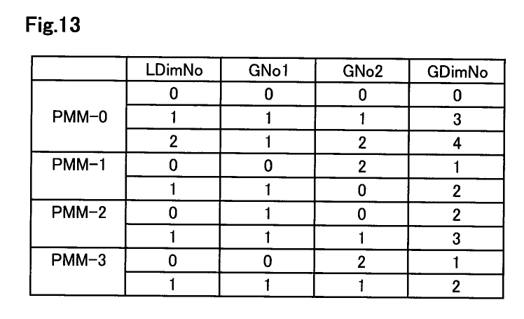

FIG. 13 shows a table of the local dimension value number LDimNo, the global field value number GVNo1 of the sex, the global field value number GVNo2 of the age and the global dimension value number GDimNo in the processing modules PMM-0 to PMM-3 according to the example shown in FIG. 12. As can be seen from FIG. 13, the global dimension value number GDimNo is assigned the numbers 0, 1, 2 and 4 in order of the numbers in the set of global field value numbers when the global field value number GVNo1 of the sex is set to a high-order digit and the global field value number GVNo2 of the age is set to a low-order digit.

In the step 805, each of the processing modules tabulates the field values for each set of global field value numbers, that is, for each global dimension value number, in the relevant processing module. In this example, the processing modules PMM-0 to PMM-3 sum up the heights with respect to sex and age, respectively.

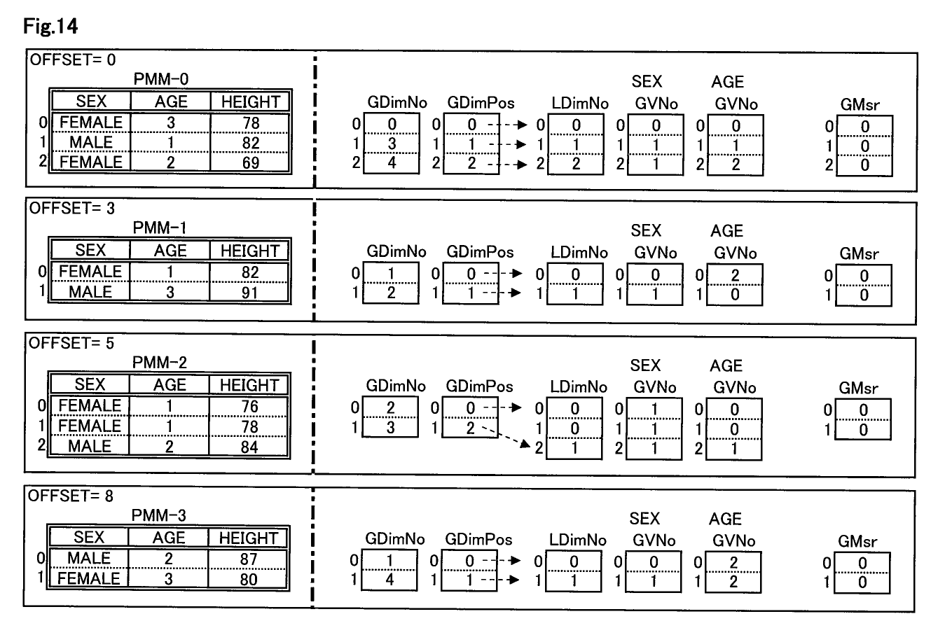

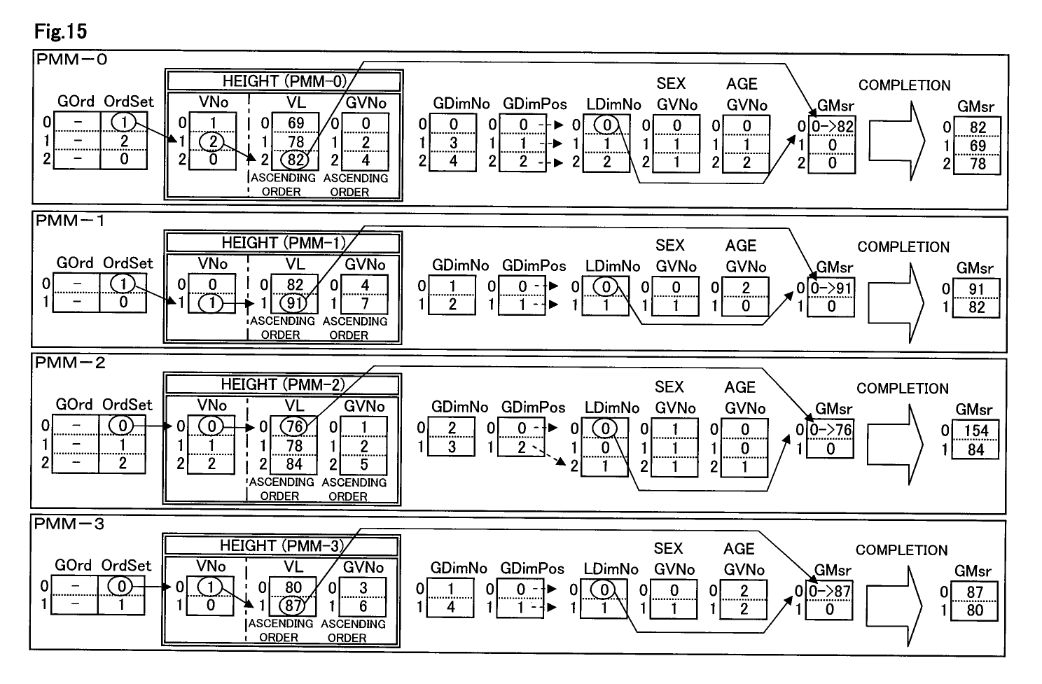

FIGS. 14 and 15 are explanatory diagrams illustrating a process for tabulating the field values for each global dimension value number in each of the processing modules. First, as shown in FIG. 14, an array GMsr having the same size as that of the array of global dimension value numbers GDimNo is generated as a region for storing the measure. In this example, since the sums of the heights are tabulated, a region for storing a floating-point number or an integer is generated. Next, as shown in FIG. 15, each of the processing modules retrieves the field values to be tabulated in order of the elements of the array OrdSet replaced in order of the set of the global dimension value numbers and tabulates the field values in the array of measures GMsr.

For example, in the PMM-0, since the first element of the array of order sets OrdSet is “1” (that is, record 1), the content of the index “1” in the array of pointers VNo to the value list in the information block on the height is referenced. Since a value “2” is stored in the array of pointer, the value of the height of the record 0 of the PMM-0 is “82”, which is obtained by obtaining the content of the index “2” of the value list VL. The value “82” is tabulated in the array of measures GMsr. In this example, since the tabulation value is the sum, the value “82” is added.

Next, it must be determined to which element of the array of measures GMsr the value “82” is added. That is, the index of the array of measures GMsr must be specified. As described above, since the array of local dimension value numbers LDimNo is arranged in order of the set of global dimension value numbers, the ranks, that is, the indexes, of the elements of the array of order sets OrdSet and the array of local dimension value numbers LDimNo correspond to each other. To this end, the measure corresponding to the top of the array OrdSet is preferably tabulated in the storage region of the array GMsr represented by the first element of the array LDimNo. In the example of FIG. 15, since the first element of the array LDimNo corresponding to the first element of the array OrdSet is “0”, the value “82” is added to a location represented by the index “0” of the array of measures GMsr.

Even in the processing modules PMM-1, PMM-2 and PMM-3, the heights “91”, “76” and “87” of the first elements of the arrays OrdSets, respectively, are obtained and tabulated in the first regions of the array of measures GMsrs, respectively. Hereinafter, in the processing modules PMM-0 to PMM-3, the field values of elements on and after the second element of the array OrdSet are obtained and tabulated in the array of measures GMsrs.

In the PMM-2, since both the local dimension value numbers LDimNos of the first element “0” and the second element “1” of the array OrdSet are “0”, both their respective heights “76” and “78” are tabulated in the first region of the array of measures GMsrs and thus the tabulation result of the leading region of the array GMsr becomes 76+78=154.

Subsequently, in the step 806, each of the processing modules obtains the local tabulation value for each set of global field value numbers from the other processing modules and tabulates the obtained tabulation value for each set of global field value numbers, thereby calculating the tabulation value. The global tabulation can be realized by the two following methods according to the construction of the physical transmitting path among the processing modules.

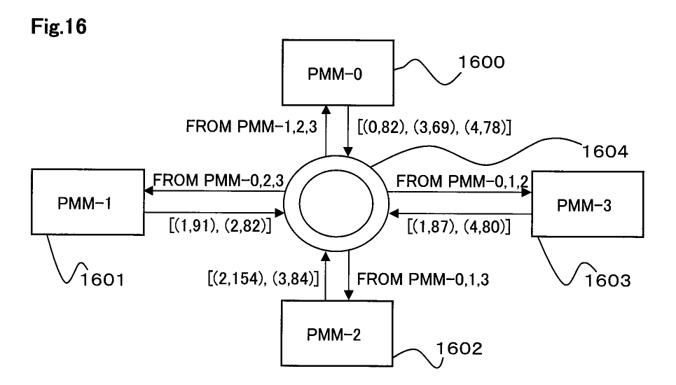

In a first global tabulating method, each of the processing modules transmits the set of the global dimension value number GDimNo and the measure GMsr tabulated in correspondence with the global dimension value number GDimNo to the other processing modules. This method is suitable when a plurality of transmitting paths can be provided among the processing modules. FIG. 16 is an explanatory diagram illustrating the first global tabulating method. The four processing modules PMM-0 (reference numeral 1600), PMM-1 (reference numeral 1601), PMM-2 (reference numeral 1602) and PMM-3 (reference numeral 1603) are connected to one another through a transmitting path 1604.

For example, the processing module PMM-0 transmits three sets of the global dimension value numbers GDimNos and the measures GMsrs, that is,

(0, 82)

(3, 69)

(4, 78)

to the other processing modules PMM-1, PMM-2 and PMM-3 as the tabulation result in the local environment shown in FIG. 15. In addition, the processing module PMM-0 receives two sets

(1, 91)

(2, 82)

transmitted from the processing module PMM-1, two sets

(2, 154)

(3, 84)

transmitted from the processing module PMM-2, and two sets

(1, 87)

(4, 80)

transmitted from the processing module PMM-3 through the transmitting path 1604. The processing modules PMM-1, PMM-2 and PMM-3 also transmit their own local tabulation results to the other processing modules and receive the local tabulation results from the other processing modules.

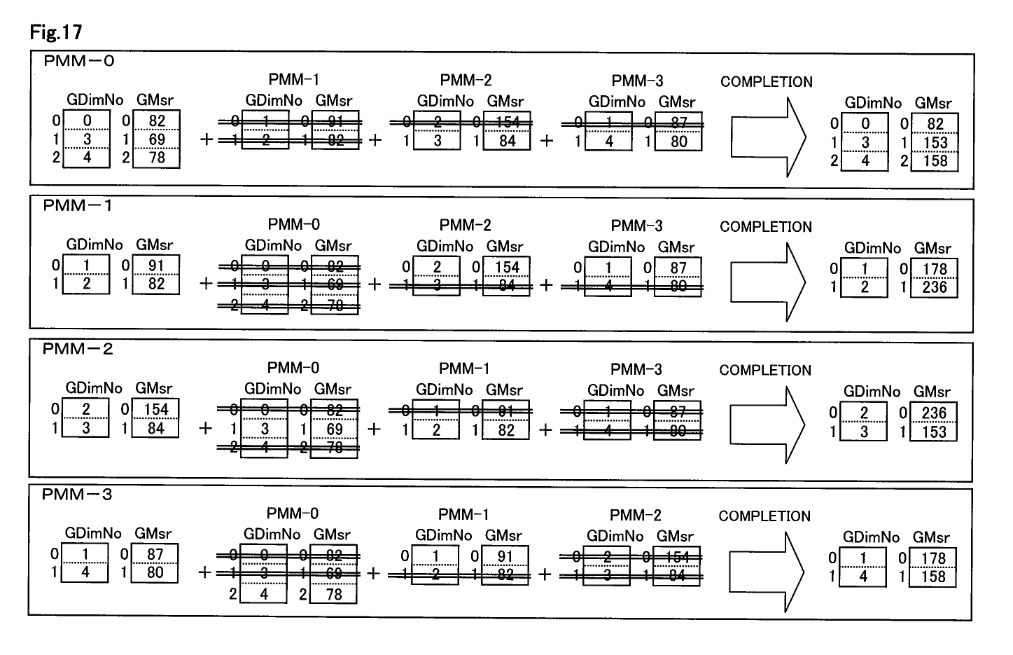

Each of the processing modules adds the mutually exchanged local tabulation results for each global dimension value number in each of the processing modules to calculate the global tabulation result. FIG. 17 is an explanatory diagram illustrating the calculation of the global tabulation result. Among the local tabulation results received by each of the processing modules from the other processing modules, data used for actual global tabulation in each of the processing modules is only data including the global dimension value number identical to the global dimension value number of the local tabulation result of each of the processing modules. In FIG. 17, among the data received by each of the processing modules from the other processing modules, data which is not used for the actual global tabulation is represented by a double cancel line. Each of the processing modules can add the measures received from the other processing modules in parallel. Accordingly, it is possible to increase the overall processing speed.

By adding the local tabulation results, as shown in FIG. 17, each of the processing modules obtains the global tabulation result. For example, since the global dimension value number “0” exists only in the PMM-0, the tabulation result of the global dimension value number “0” appears only in the PMM-0. On the other hand, since the global dimension value number “3” is locally tabulated in the two processing modules and PMM-2, the global tabulation result of the global dimension value number “3” appears in the two processing modules and PMM-2. Here, both the global tabulation values of the global dimension value number “3” in the processing modules PMM-0 and PMM-2 have the identical value “153”.

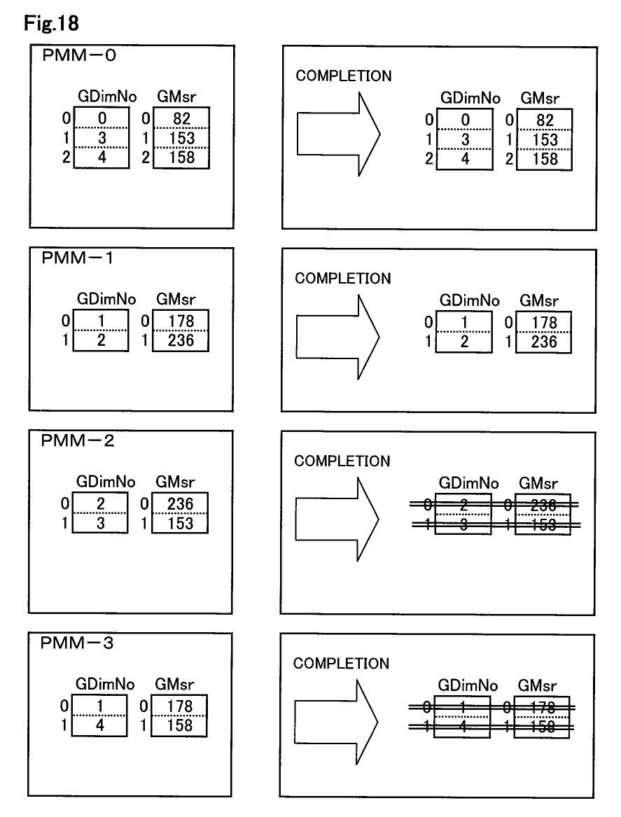

It is preferable that the repeated global tabulation results are deleted for the following process. To this end, the ranks are previously assigned to the processing modules and each of the processing modules may delete the global tabulation value of the relevant processing module when a processing module which ranks higher than the processing module has the same global tabulation value as the global tabulation value of the relevant processing module. FIG. 18 is an explanatory diagram illustrating a process for preventing the global tabulation value from being repeated. In FIG. 18, a double cancel line denotes the cancel of the repeated global tabulation value. By applying this process, one global tabulation value for each global dimension value number is held in all the processing modules.

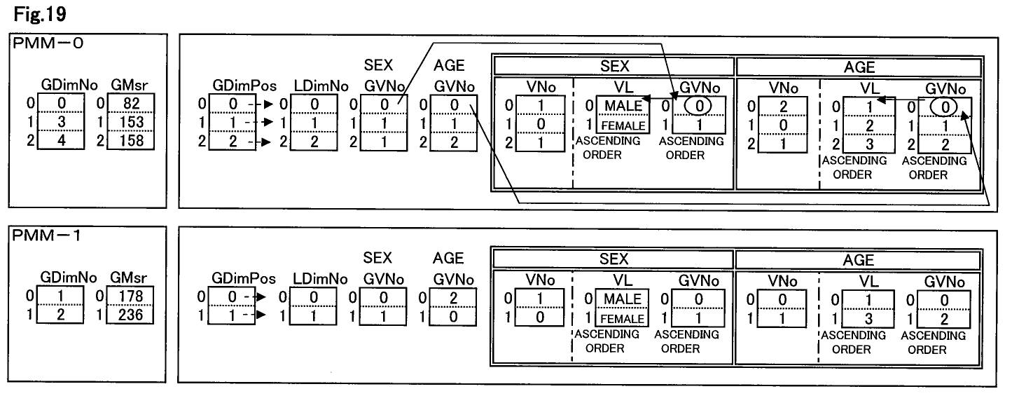

Finally, in the step 807, the processing module having a final global tabulation value restores the set of field values from the set of global field value numbers and generates a result table including the set of field values and the tabulation value corresponding to the set of field values. FIG. 19 is an explanatory diagram illustrating a process for generating the result table. By expressing the tabulation result in a result table form, the result table can be used for another tabulating process. In the example shown in FIG. 18, since the final global tabulation value is held in the processing modules PMM-0 and PMM-1, the result table is generated in the processing modules PMM-0 and PMM-1.

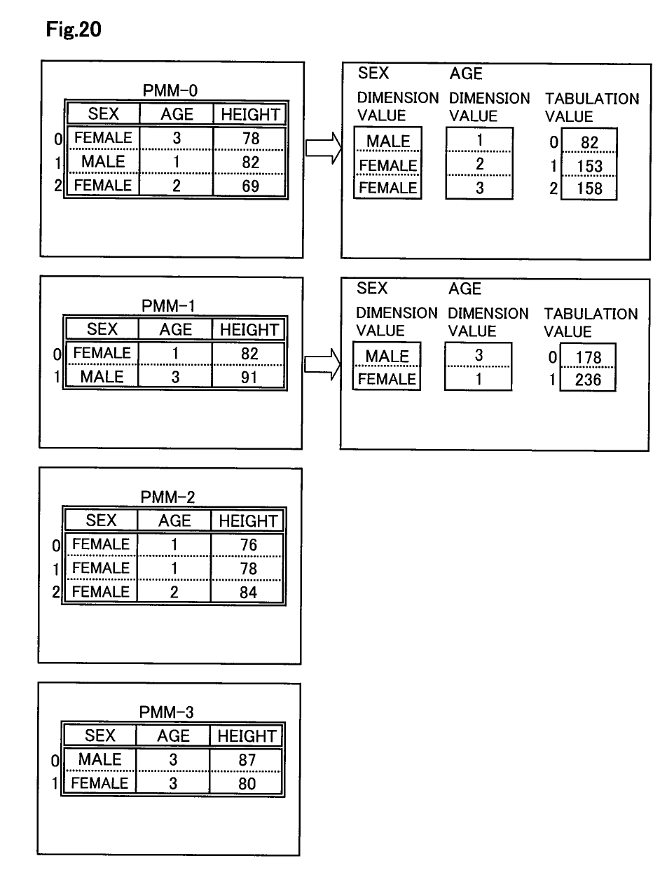

For example, in the processing module PMM-0, the global tabulation result of the global dimension value number “0” is “82”. The local dimension value number LDimNo of the global dimension value number GDimNo “0” can be obtained by using the correspondence table GDimPos between the global dimension value number and the local dimension value number described with reference to FIG. 12. In the example shown in FIG. 19, since the value of the GDimPos of the GDimNo “0” is “0”, the first element “0” of the array LDimNo is the local dimension value number. The global field value number “0” of the sex and the global field value number “0” of the age correspond to the local dimension value number “0”. The field value, that is, the dimension value, corresponding to the global field value number “0” of the sex, is “male” and the field value, that is, the dimension value, corresponding to the global field value number “0” of the age is “1”. Accordingly, with respect to the global dimension value number “0”, it is possible to obtain the dimension value of the sex “male”, the dimension value of the age “1”, and the tabulation value (=sum of the heights) “82”. By performing the identical process on the other global dimension value numbers of the processing module PMM-0 and the global dimension value numbers of the processing module PMM-1, it is possible to obtain the result table. FIG. 20 is an explanatory diagram illustrating the generated result table. The processing modules PMM-0 and PMM-1 generate the result tables of the dimension value of the sex, the dimension value of the age, and the tabulation value, respectively. The processing modules PMM-2 and PMM-3 do not generate the result table.

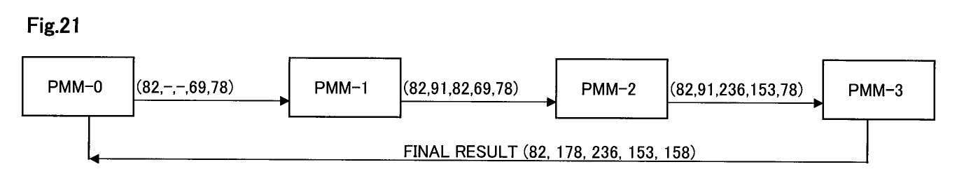

Although, in FIGS. 16 to 18, the first global tabulating method is described, in a modified example of the present embodiment, a second global tabulating method is performed. FIG. 21 is an explanatory diagram illustrating the second global tabulating method. In this tabulating method, the orders are previously assigned to the processing modules and the array GMsr which is the local tabulation result is sequentially transmitted from a high-rank processing module to a low-rank processing module. After the second processing module, the local tabulation result of the relevant processing module is added to the tabulation result array GMsr received from the previous processing module and the tabulation result array GMsr after adding is transmitted to the next processing module. The tabulation result array which circulates through a series of processing modules and returns to a highest-rank processing module by adding the tabulation result and sequentially transmitting the tabulation result array GMsr to the next processing module includes all the global tabulation results of the global dimension value numbers.

In the example shown in FIG. 21, first, the tabulation result array (82, -, -, 69, 78) is transmitted from the highest-rank processing module PMM-0 to the next processing module PMM-1. Here, “-” means that the local tabulation result is not obtained. The processing module PMM-1 adds the local tabulation result (-, 91, 82, -, -) of the relevant processing module to the received tabulation result array (82, -, -, 69, 78) to generate another tabulation result array (82, 91, 82, 69, 78) and transmits the generated tabulation result array to the next processing module PMM-2. Similarly, the processing modules PMM-2 adds the local tabulation result (-, -, 154, 84, -) of the relevant processing module to the received tabulation result array to generate another tabulation result array (82, 91, 236, 153, 78) and transmits the obtained tabulation result array to the next processing module PMM-3. Similarly, the processing module PMM-3 adds the local tabulation result (-, 87, -, -, 80) of the relevant processing module to the received tabulation result array to generate another tabulation result array (82, 178, 236, 153, 158). Since the processing module PMM-3 is a lowest-rank processing module, the tabulation result array output from the processing module PMM-3 is the final tabulation result.

[Order assigning process] Like the information processing system according to the present embodiment, in the information processing system in which a plurality of processing modules each having a memory for storing the list of ranked values is logically connected in a loop, an information processing method of assigning a common rank to the values individually ranked in each of the processing modules in the plurality of processing modules, that is, a rank assigning method, is required.

For example, as described with reference to FIG. 12, when the global dimension value number is given, the rank assigning process for assigning the common rank to the values individually ranked in each of the processing modules in the plurality of processing modules is used. The rank assigning process is also used in the case where the global field value number is set in the below-described compiling process, in addition to the case where the global dimension value number is given. The rank assigning process is characterized in that only a single number is given to the identical value. Accordingly, this rank assigning process is particularly referred to as an identical value canceling type rank assigning process.

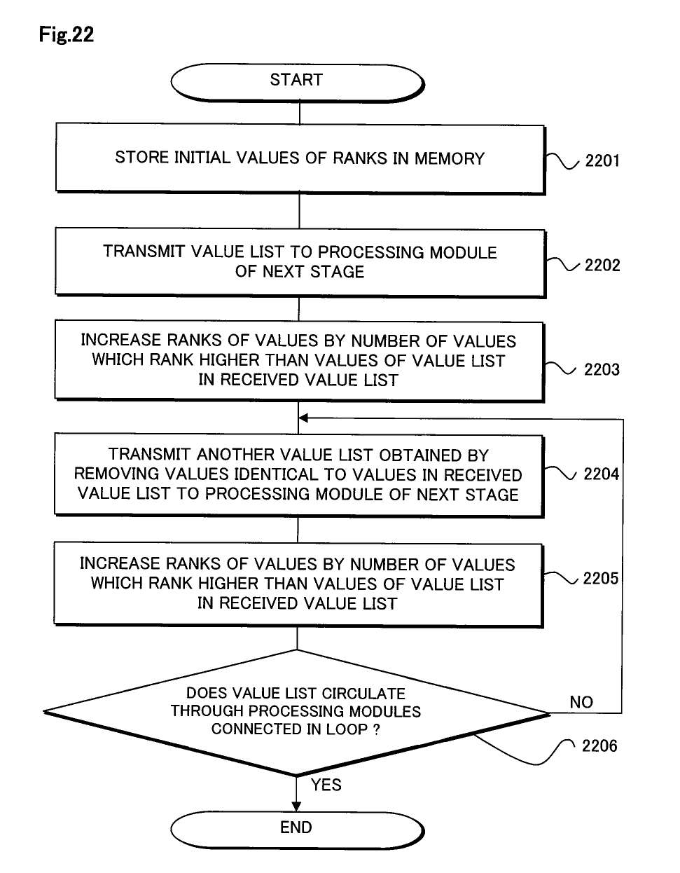

FIG. 22 is a flow chart of the rank assigning method according to Embodiment 1 of the invention. In FIG. 22, each of the processing modules stores initial values of the ranks of the values of the value list in the memory of the relevant processing module (step 2201).

Next, each of the processing modules transmits the value list stored in the memory of the relevant processing module to a processing module logically arranged in a next stage (step 2202). Each of the processing modules counts the number of the values, which rank higher than the values of the value list of the relevant processing module, in the value list which is received from the processing module logically arranged in a previous stage, increases the ranks of the values of the value list of the relevant processing module by the counted number, updates the ranks of the values of the value list of the relevant processing module, and stores the updated ranks in the memory (step 2203).

Next, each of the processing modules transmits another value list obtained by removing the values identical to the values of the value list of the relevant processing module from the values of the received value list to the processing module which is logically arranged in the next stage (step 2204), and counts the number of the values, which rank higher than the values of the value list of the relevant processing module, in another value list which is received from the processing module logically arranged in a previous stage, increases the orders of the values of the value list of the relevant processing module by the counted number, updates the ranks of the values of the value list of the relevant processing module, and stores the updated ranks in the memory (step 2205).

Subsequently, each of the processing modules repeatedly performs the step 2204 and the step 2205 until the value list transmitted to the processing module logically arranged in the next stage in the transmission step 2202 is received by the processing module logically arranged in the previous stage through the other processing modules which are logically connected to one another in the loop (step 2206).

According to this rank assigning method, each of the processing modules can receive the value lists of the other processing modules without repetition and assign the global rank to the values of the relevant processing module. As described above, when each of the processing modules has the value list ranked previously, it is possible to efficiently assign the global rank. This is because the ranks can be only compared in ascending (or descending) order when the value list is previously ranked. Even in the case where the value list of each of the processing modules is not ranked, it is possible to obtain the similar result. In this case, for example, each of the processing modules sequentially compares the values of the value lists received from the other processing modules with the values of the value list of the relevant processing module with respect to all the combinations, counts the number of values ranked higher than the values of the relevant processing module, that is, the high-rank values, and updates the ranks of the values of the relevant processing module.

In the rank assigning method according to the present embodiment, each of the processing modules need not store the value list received from the other processing modules and can assign the common ranks to all the processing modules only by assigning the rank to the value list of the relevant processing module. Since this rank assigning method is not influenced by the order of the value lists received from the other processing modules, this rank assigning method does not depend on the physical connection among the processing modules. Accordingly, by multiplexing the transmitting path and the rank updating circuit, it is possible to more increase the speed.

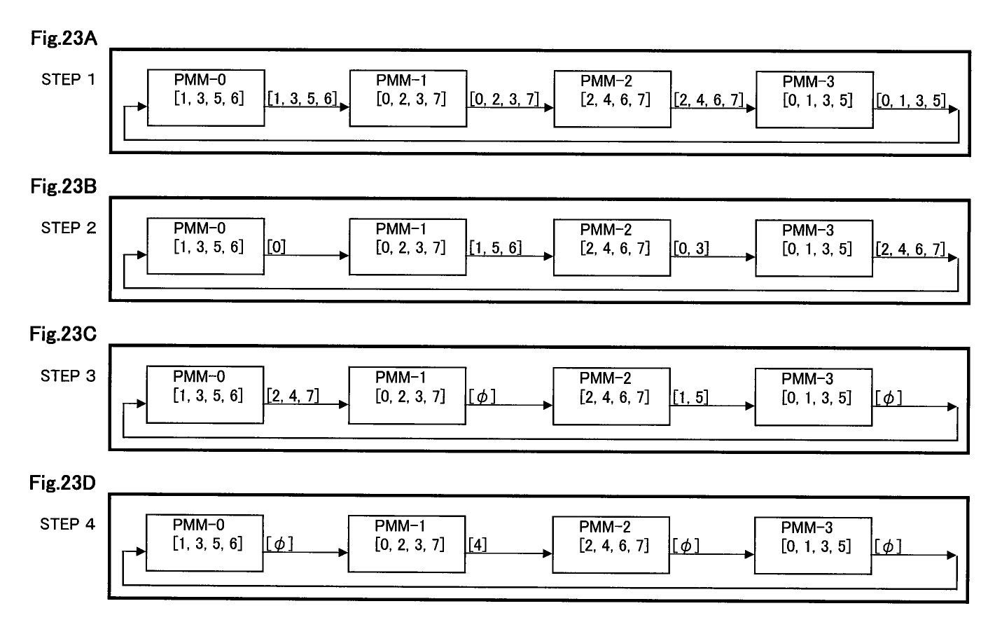

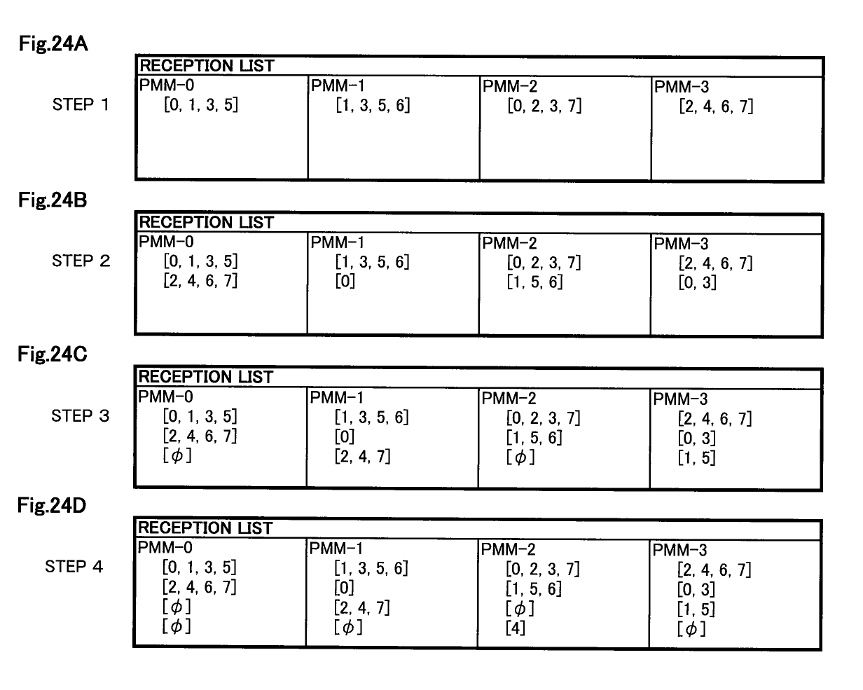

FIGS. 23 and 24 are explanatory diagrams illustrating the rank assigning process. In FIG. 23, the value list transmitted from each of the processing modules PMM to a next processing module PMM is shown in each step. In FIG. 24, the value list received by the PMM from the previous PMM is shown in each step. In this example, in an initial state, the processing module PMM-0 holds the value list [18, 21, 24], the processing module PMM-1 holds the value list [16, 28], the processing module PMM-2 holds the value list [16, 20, 33], and the processing module PMM-3 holds the value list [18, 24].

Upon the completion of the step 3, each of the processing modules PMM can receive the value lists from all the other processing modules. At this time, each of the processing modules adds the received value lists to the value list of the relevant processing modules to assign the ranks to all the values. Upon the completion of the step 4, it can be seen that all the values can be received without repetition.

[Compiling process] The compiling process is to set the global record numbers GOrd and the global field value numbers GVNo used for managing the data in each of the processing modules. The global record numbers GOrd can be easily set by using the above-described offset values OFFSET. On the other hand, the global field value numbers GVNo are the common ranks which are assigned in all the processing modules based on the individual value list of each of the processing modules.

Accordingly, each of the processing modules can set the global field value numbers GVNo using the above-described rank assigning process.

### EMBODIMENT 2

In Embodiment 2, a number counting process for obtaining the number of persons by sex/age based on the table-format data shown in FIG. 5 will be described. Even in Embodiment 2, the tabulating process is performed by the flowchart shown in FIG. 8, similar to Embodiment 1.

For example, when the table-format data shown in FIG. 5 is separately managed by the plurality of processing modules and the above-described step 801 is performed, the data storage structure shown in FIG. 7 is obtained. In the step 802, the records of the data shown in FIG. 7 are sorted in two dimensions including the dimension “age” and the dimension “sex” in each of the processing modules, that is, each local environment. The step 802 of Embodiment 2 is similar to the step 802 of Embodiment 1.

In the step 803, each of the processing modules assigns the rank to the set of the field value numbers of the selected dimension (the sex and the age in the present example) in order of the records sorted locally (that is, in order of the elements of the array of order sets OrdSet after replacement) The step 803 of Embodiment 2 is similar to the step 803 of Embodiment 1.

Next, in the step 804, each of the processing modules converts the local dimension value number LDimNo given to the set of global field value numbers into the common global dimension number GDimNo in the plurality of processing modules to assign the global ranks to the dimension values. The step 804 of Embodiment 2 is similar to the step 804 of Embodiment 1.

Subsequently, in the step 805, each of the processing modules tabulates the field value for each set of global field value numbers, that is, for each global dimension value number, in the relevant processing module. In the present example, the processing modules PMM-0 to PMM-3 count the number of persons by sex/age in the modules, respectively.

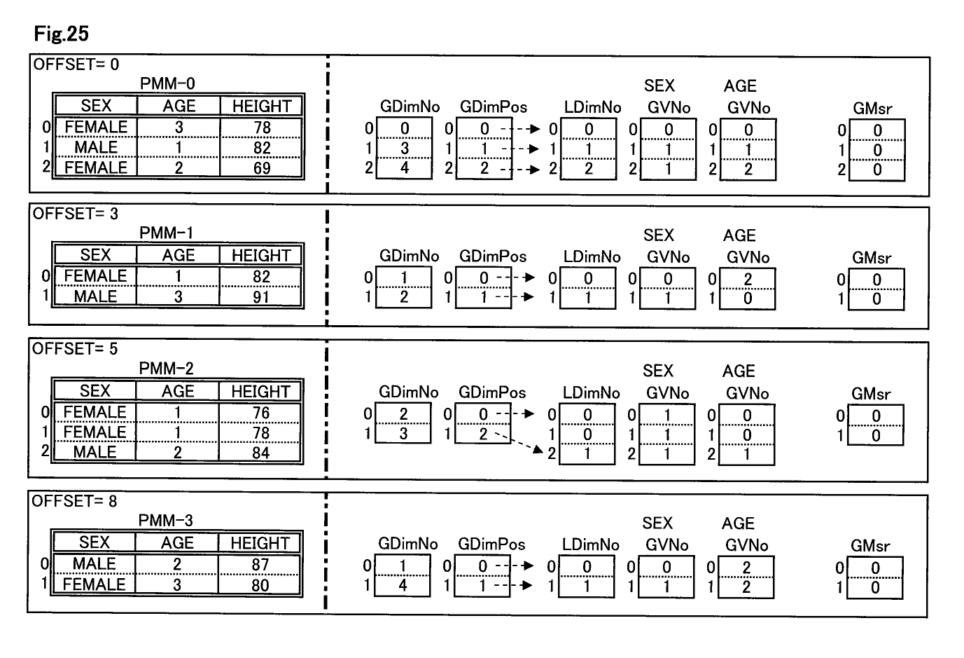

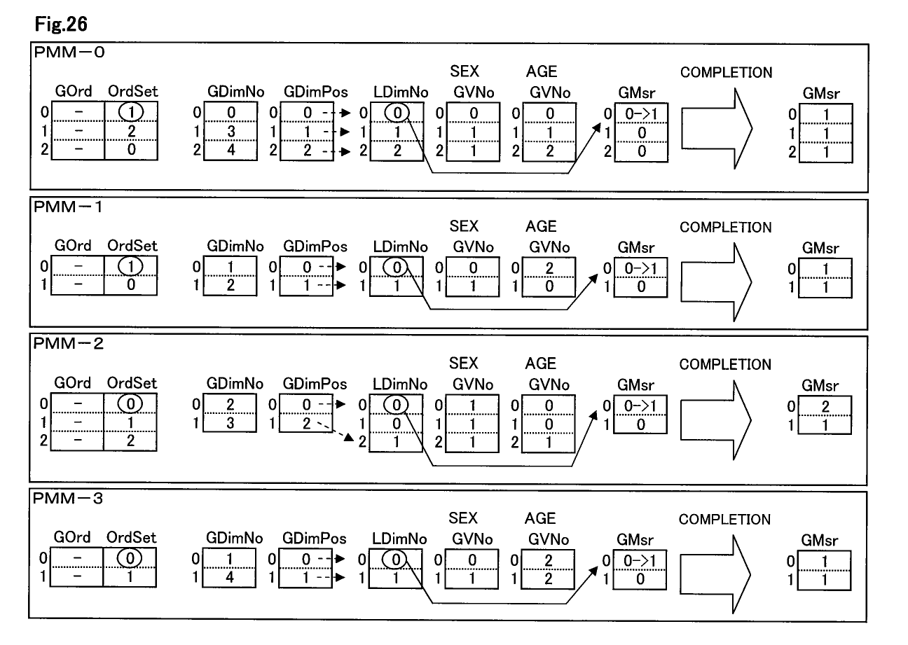

FIGS. 25 and 26 are explanatory diagrams illustrating a process for tabulating the field value for each global dimension value number in each of the processing modules. First, as shown in FIG. 25, an array GMsr having the same size as that of the array of global dimension value numbers GDimNo is generated as a region for storing the measures. In this example, since the number of the persons is tabulated, an integer storage region is generated. Next, as shown in FIG. 26, a value to be tabulated is retrieved in order of the elements of the array OrdSet replaced in order of the set of global dimension value numbers in each of the processing modules and tabulated in the array of measures GMsr.

In the present example, the value to be tabulated is “1”. Next, it must be determined to which element of the array of measures GMsr the value “1” is added. That is, the index of the array of measures GMsr must be specified. As described above, since the array of local dimension value numbers LDimNo is arranged in order of the set of global dimension value numbers, the ranks, that is, the indexes, of the elements of the array of order sets OrdSet and the array of local dimension numbers LDimNo correspond to each other. To this end, the measure of the first element of the array OrdSet is tabulated in the storage region of the array of measures GMsr represented by the first element of the array LDimNo. In the example shown in FIG. 26, since the first element of the array LDimNo corresponding to the first element of the array OrdSet is “0”, the value “1” is added (increased) to a location represented by the index “0” of the array of measures GMsr.

The processing modules PMM-1, PMM-2 and PMM-3 also increase the first regions of the array of measures GMsr, respectively. Hereinafter, in the processing modules PMM-0 to PMM-3, the arrays of measures GMsr corresponding to the elements after the second element of the array OrdSet increase.

On the other hand, in the processing module PMM-2, both the local dimension value numbers LDimNo corresponding to the first element “0” and the second element “1” of the array OrdSet are “0”, both the numbers of the persons thereof are tabulated in the first region of the array of measures GMsr and thus the tabulation result of the first region of the array GMsr becomes 1+1=2.

Subsequently, in the step 806, each of the processing modules obtains the local tabulation value for each set of global field value numbers from the other processing modules and tabulates the obtained tabulation value for each set of global field value numbers, thereby calculating the tabulation value. In the present example, since the number of the persons is increased by a specified number, each of the processing modules counts the number of the value. This global tabulation can be realized, for example, by the two following method according to the construction of the physical transmitting path among the processing modules, similar to Embodiment 1.

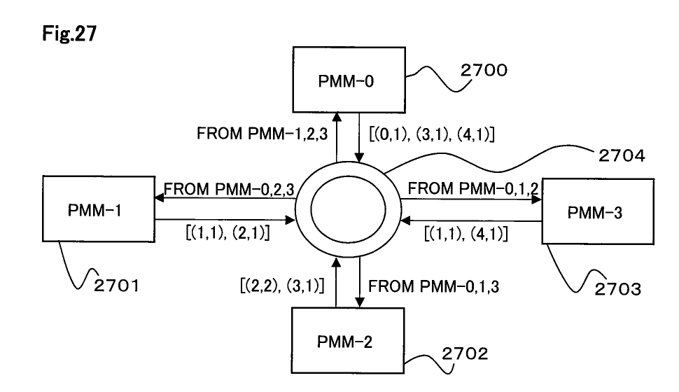

In a first global tabulating method, each of the processing modules transmits the set of the global dimension value number GDimNo and the measure GMsr tabulated in correspondence with the global dimension value number GDimNo to the other processing modules. This method is suitable when a plurality of transmitting paths can be provided among the processing modules. FIG. 27 is an explanatory diagram illustrating the first global tabulating method. The four processing modules PMM-0 (reference numeral 2700), PMM-1 (reference numeral 2701), PMM-2 (reference numeral 2702) and PMM-3 (reference numeral 2703) are connected to one another through a transmitting path 2704.

For example, the processing module PMM-0 transmits three sets of the global dimension value numbers GDimNo and the measures GMsr, that is,

(0, 1)

(3, 1)

(4, 1)

to the other processing modules PMM-1, PMM-2 and PMM-3 as the tabulation result in the local environment shown in FIG. 26. In addition, the processing module PMM-0 receives two sets

(1, 1)

(2, 1)

transmitted from the processing module PMM-1, two sets

(2, 2)

(3, 1)

transmitted from the processing module PMM-2, and two sets

(1, 1)

(4, 1)

transmitted from the processing module PMM-3 through the transmitting path 2704. The processing modules PMM-1, PMM-2 and PMM-3 also transmit their own local tabulation results to the other processing modules and receive the local tabulation results from the other processing modules.

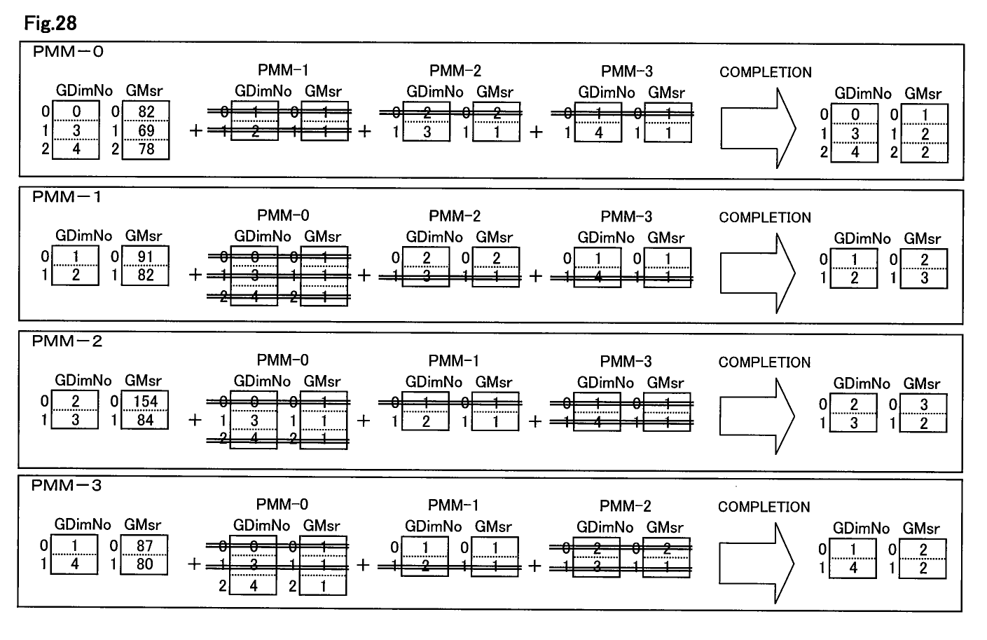

Each of the processing modules adds the mutually exchanged local tabulation results for each global dimension value number in each of the processing modules to calculate the global tabulation result. FIG. 28 is an explanatory diagram illustrating the calculation of the global tabulation result. Among the local tabulation results received by each of the processing modules from the other processing modules, data used for actual global tabulation in each of the processing modules is only data including the global dimension value number identical to the global dimension value number of the local tabulation result of each of the processing modules. In FIG. 28, among the data received by each of the processing modules from the other processing modules, data which is not used for the actual global tabulation is represented by a double cancel line. Each of the processing modules can add the measures received from the other processing modules in parallel. Accordingly, it is possible to increase the overall processing speed.

By adding the local tabulation results, as shown in FIG. 28, each of the processing modules obtains the global tabulation result. For example, since the global dimension value number “0” exists only in the processing module PMM-0, the tabulation result of the global dimension value number “0” appears only in the processing module PMM-0. On the other hand, since the global dimension value number “3” is locally tabulated in the two processing modules PMM-0 and PMM-2, the global tabulation result of the global dimension value number “3” appears in the two processing modules PMM-0 and PMM-2. Here, both the global tabulation values of the global dimension value number “3” in the processing modules PMM-0 and PMM-2 have the identical value “2”.

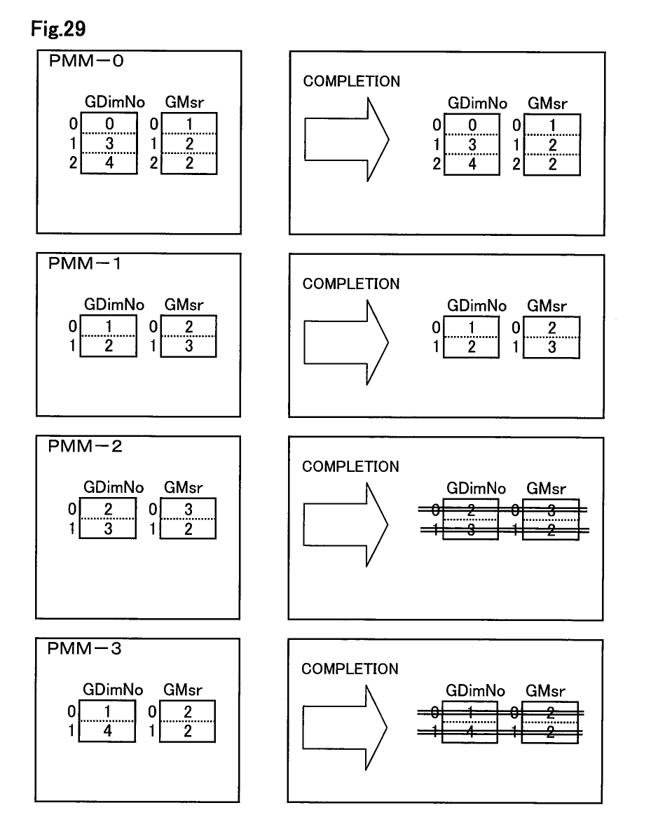

It is preferable that the duplicated global tabulation results are deleted for the following process. To this end, the ranks are previously assigned to the processing modules and each of the processing modules may delete its global tabulation value of the relevant processing module when a processing module which ranks higher than the relevant processing module has the same global tabulation value as the global tabulation value of the global dimension value number of the relevant processing module. FIG. 29 is an explanatory diagram illustrating a process for preventing the global tabulation value from being repeated. In FIG. 29, a double cancel line denotes the cancellation of the repeated global tabulation value. By applying this process, one global tabulation value for each global dimension value number is held in all the processing modules.

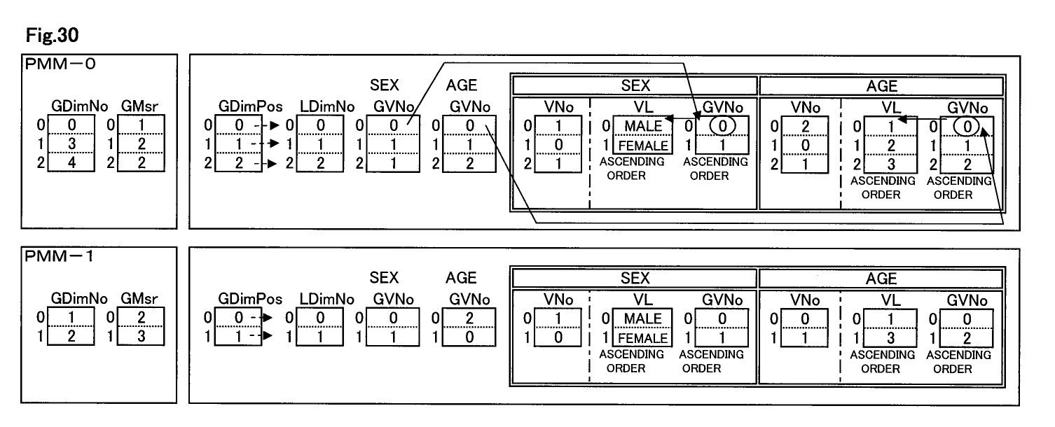

Finally, in the step 807, the processing module having a final global tabulation value restores the set of field values from the set of global field value numbers and generates a result table including the set of field values and the tabulation value corresponding to the set of field values. FIG. 30 is an explanatory diagram illustrating a process for generating the result table. By expressing the tabulation result in a result table form, the result table can be used for another tabulating process. In the example shown in FIG. 29, since the final global tabulation value is held in the processing modules PMM-0 and PMM-1, the result table is generated in the processing modules PMM-0 and PMM-1.

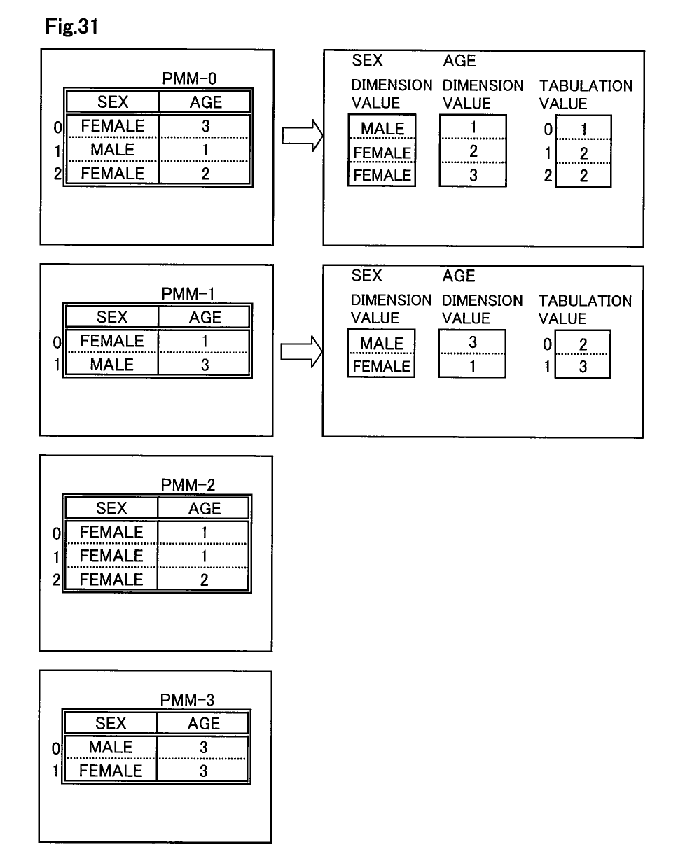

For example, in the processing module PMM-0, the global tabulation result of the global dimension value number “0” is “1”. The local dimension value number LDimNo of the global dimension value number GDimNo “0” can be obtained by using the correspondence table GDimPos between the global dimension value number and the local dimension value number described with reference to FIG. 12. In the example shown in FIG. 30, since the value of GDimPos of the GDimNo “0” is “0”, the first element “0” of the array LDimNo is the local dimension value number. The global field value number “0” of the sex and the global field value number “0” of the age correspond to the local dimension value number “0”. The field value, that is, the dimension value, corresponding to the global field value number “0” of the sex is “male” and the field value, that is, the dimension value, corresponding to the global field value number “0” of the age is “1”. Accordingly, with respect to the global dimension value number “0”, it is possible to obtain the dimension vale of the sex “male”, the dimension value of the age “1”, and the tabulation value (=the number of the persons) “1”. By performing the identical process on the other global dimension value numbers of the processing module PMM-0 and the global dimension value numbers of the processing module PMM-1, it is possible to obtain the result table. FIG. 31 is an explanatory diagram illustrating the generated result table. The processing modules PMM-0 and PMM-1 generate the result tables of the dimension value of the sex, the dimension value of the age, and the tabulation value, respectively. The processing modules PMM-2 and PMM-3 do not generate the result table.

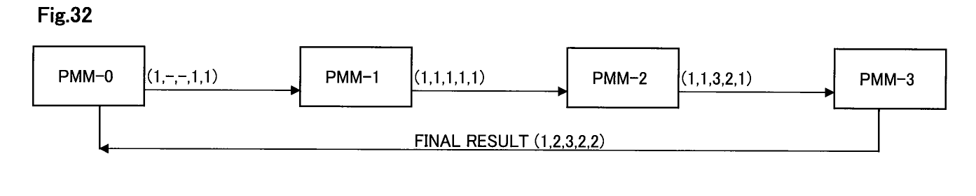

Although, in FIGS. 27 to 29, the first global tabulating method is described, in a modified example of the present embodiment, a second global tabulating method is performed. FIG. 32 is an explanatory diagram illustrating the second global tabulating method. In this tabulating method, the ranks are previously assigned to the processing modules and the array GMsr which is the local tabulation result is sequentially transmitted from a high-rank processing module to a low-rank processing module. On and after the second processing module, the local tabulation result of the relevant processing module is added to the tabulation result array GMsr received from the previous processing module and the tabulation result array GMsr after being added is transmitted to the next processing module. The tabulation result array which circulates through a series of processing modules and returns to an initial highest-rank processing module becomes an array including all the global tabulation results for the global dimension value numbers by adding the tabulation result and sequentially transmitting the tabulation result array GMsr to the next processing module.

In the example shown in FIG. 32, first, the tabulation result array (1, -, -, 1, 1) is transmitted from the highest-rank processing module PMM-0 to the next processing module PMM-1. Here, “-” means that the local tabulation result is not obtained. The processing module PMM-1 adds the local tabulation result (-, 1, 1, -, -) of the relevant processing module to the received tabulation result array (1, -, -, 1, 1) to generate another tabulation result array (1, 1, 1, 1, 1) and transmits the generated tabulation result array to the next processing module PMM-2. Similarly, the processing module PMM-2 adds the local tabulation result (-, -, 2, 1, -) of the relevant processing module to the received tabulation result array to generate another tabulation result array (1, 1, 3, 2, 1) and transmits the obtained tabulation result array to the next processing module PMM-3. Similarly, the processing module PMM-3 adds the local tabulation result (-, 1, -, -, 1) of the relevant processing module to the received tabulation result array to generate another tabulation result array (1, 2, 3, 2, 2). Since the processing module PMM-3 is a lowest-rank processing module, the tabulation result array output from the processing module PMM-3 is the final tabulation result.

On the other hand, the tabulation value (=the sum of the heights) obtained in Embodiment 1 is divided by the tabulation value (=the number of the persons) obtained in Embodiment 2 to obtain the tabulation value of an average height.

### EMBODIMENT 3

Although, in Embodiments 1 and 2, the tabulating process using the number counting process is described, the process for counting the number of matched values is a basic inter-processor information processing technology necessary for processing large amounts of data based on a distributed memory type parallel architecture where the large amounts of data are not shared among the processors, but held in each processors such that communication among the processors is minimized.

By using this counting process, it is possible to determine the number of occurrence of the value, which is at most singly contained in one module, in all the processing modules.

For example, when a certain assembling factory purchases a plurality of parts for manufacturing a certain product A from any one of a plurality of factories for producing the part, the kinds of the parts which can be supplied from the respective factories may be different from one another. At this time, when the number of factories for producing the part is recognized in order to prevent the number of the parts from being insufficient with respect to any part, the process for counting the number can be used. That is, when the factories for producing the part apply to each of the processing modules and model numbers of the parts apply to the field values, it is possible to obtain the number of the factories for producing the part by counting the number of the field values matched with a specified model number.

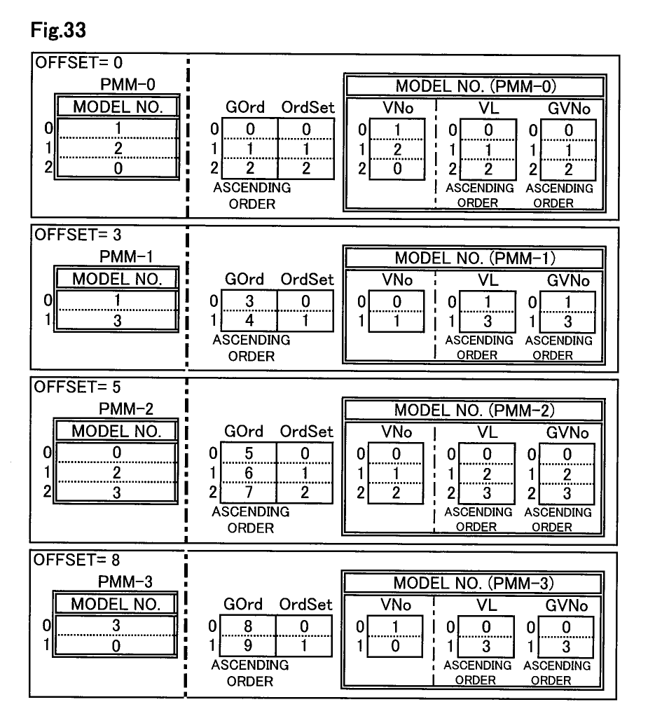

FIG. 33 shows a state where the table-format data representing the model numbers of the parts which can be supplied by the factories is separately managed by the processing modules PMM-0 to PMM-3. For simplification, the fields except the model number (for example, part price and so on) are not shown. An operation region for storing the count value in correspondence with the model number VNo is generated and the initial value thereof is set to 1.

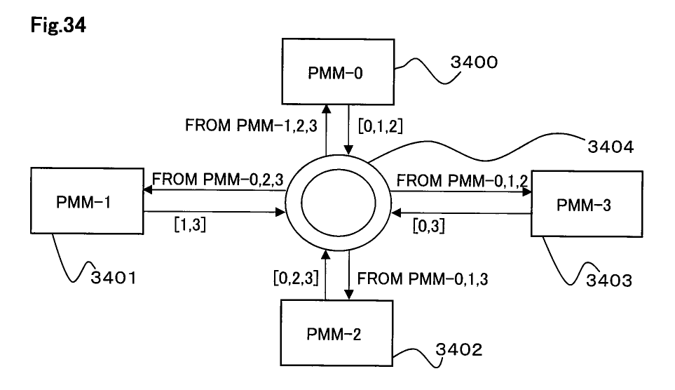

FIG. 34 is an explanatory diagram illustrating a process for counting the matched number when each of the processing modules transmits the field values contained in the relevant processing module to the other processing modules using a plurality of transmitting paths.

Four processing modules PMM-0 (reference numeral 3400), PMM-1 (reference numeral 3401), PMM-2 (reference numeral 3402) and PMM-3 (reference numeral 3403) are connected to one another through a transmitting path 3404. For example, the processing modules PMM-0 transmits the set of global field value numbers GVNo of the model numbers in the local environment shown in FIG. 30, that is,

(0, 1, 2)

to the other processing modules PMM-1, PMM-2 and PMM-3. In addition, the processing module PMM-0 receives the sets of global field value numbers transmitted from the processing modules PMM-1, PMM-2 and PMM-3, that is,

(1, 3)

(0, 2, 3) and

(0, 3)

through the transmitting path 3404. The processing modules PMM-1, PMM-2 and PMM-3 also transmit sets of field value numbers of the relevant processing module to the other processing modules and receive the sets of field value numbers from the other processing modules, respectively.

For example, the initial value of the count value storage region of the processing module PMM-0 is

storage region of GVNo “0”: “1”,

storage region of GVNo “1”: “1”, and

storage region of GVNo “2”: “1”

The storage region of GVNo “3” does not exist.

When the processing module PMM-0 receives (1, 3) from the processing module PMM-1, the count value storage region is counted up as expressed by

storage region of GVNo “0”: “1”,

storage region of GVNo “1”: “1” “2”, and

storage region of GVNo “2”: “1”.

Next, when the processing module PMM-0 receives (0, 2, 3) from the processing module PMM-2, the count value storage region is counted up as expressed by

storage region of GVNo “0”: “1” “2”,

storage region of GVNo “1”: “2”, and

storage region of GVNo “2”: “1” “1”→“2”.

Next, when the processing module PMM-0 receives (0, 3) from the processing module PMM-3, the count value storage region is counted up as expressed by

storage region of GVNo “0”: “2” “3”,

storage region of GVNo “1”: “2”, and

storage region of GVNo “2”: “2”.

When the processing modules PMM-1, PMM-2 and PMM-3 receive the sets of field value numbers from the other processing modules and increase the count corresponding to the field values matched with field value numbers of the relevant processing module by one, respectively,

storage region of GVNo “1”: “2” and

storage region of GVNo “3”: “3”

are obtained as the count value region of the processing module PMM-1,

storage region of GVNo “0”: “2”,

storage region of GVNo “2”: “2”, and

storage region of GVNo “3”: “3”

are obtained as the count value region of the processing module PMM-2, and

storage region of GVNo “0”: “3” and

storage region of GVNo “3”: “3”

are obtained as the count value region of the processing module PMM-3.

In this step, since the repeated count result is obtained, finally

storage region of GVNo “0”: “3”,

storage region of GVNo “1”: “2”,

storage region of GVNo “2”: “2”, and

storage region of GVNo “3”: “3”

are obtained, for example, by deleting the repeated portion.

Although, in the above-described example, the processing module PMM-0 performs the sequential counting-up function, the processing module may simultaneously perform transmission/reception of the set of field values from each of the processing modules to the other processing modules and the counting-up function in each of the processing modules. For example, when the count values of GVNo “0” to GVNo “3” are expressed by a vector form such as (the count of GVNo “0”, the count of GVNo “1”, the count of GVNo “2”, and the count of GVNo “3”), the processing module PMM-0 can obtain a final count value (3, 2, 2, 3) by adding the vector (1, 1, 1, 0) representing the count value of the relevant processing module, the vector (0, 1, 0, 1) representing the count value received from the processing module PMM-1, the vector (1, 0, 1, 1) representing the count value received from the processing module PMM-2, and the vector (1, 0, 0, 1) representing the count value received from the processing module PMM-3.

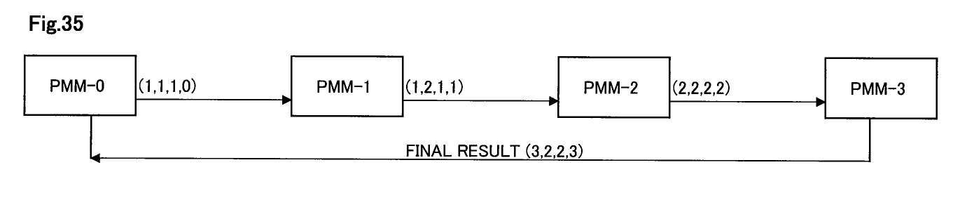

In FIG. 35, ranks are previously assigned to processing modules and the count value of each of the processing modules is sequentially transmitted from a high-rank processing module to a low-rank processing module. After a second processing module, each count value in the relevant processing module is added to the count value received from the previous processing module and the added count value is transmitted to the next processing module. The count value which circulates through a series of processing modules and returns to a highest-rank processing module by adding the count value and sequentially transmitting the added count value to subsequent processing modules is a final count value (3, 2, 2, 3).

### EMBODIMENT 4

Although, in Embodiments 1 to 3, the number of the matched field values is counted, data may be ranked in a process for processing large amounts of data. For example, when the grade points of subjects of an achievement test are obtained as a table-format data, the sums thereof are tabulated and ordered in descending order.

Even in the present embodiment, the case where processing modules PMM0 to PMM3 separately control data of a plurality of examinees is considered. When the record of any examinee is managed by the identical processing module, the total scores of the examinees can be locally in each of the processing modules. Accordingly, in the present example, a process for assigning ranks to the total scores after calculating the total scores of the examinees will be described.

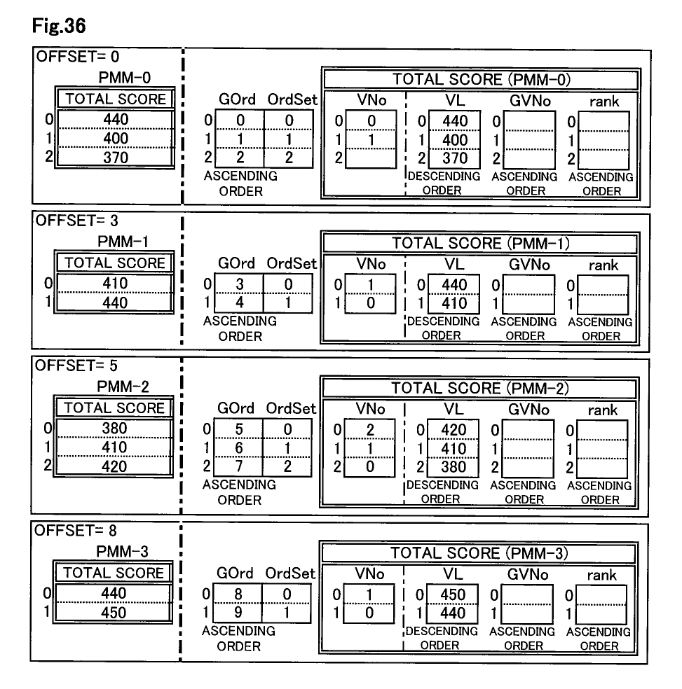

FIG. 36 is an explanatory diagram illustrating a table-format data storage structure according to Embodiment 4 of the invention. As shown in FIG. 36, a newly calculated total score is added as a new field of the table-format data. Although the global field value number GVNo is generally assigned to the new field “total score” by a compiling process among the PMMs, in the present embodiment, a rank is assigned to the new field “total score” in addition to the global field value number GVNo. Assignment of the global field value number is “identical value canceling” type ranking in that the identical number is assigned to the field value having the identical value. In contrast, the assignment of the rank is performed in consideration of the identical value since the values of the global order set arrays GOrd are different from each other although the field values are identical (individual examinee in the present example).

The global field value number can be assigned by the above-described compiling process. Accordingly, hereinafter, a simple rank-assigning process for assigning the rank will be described.

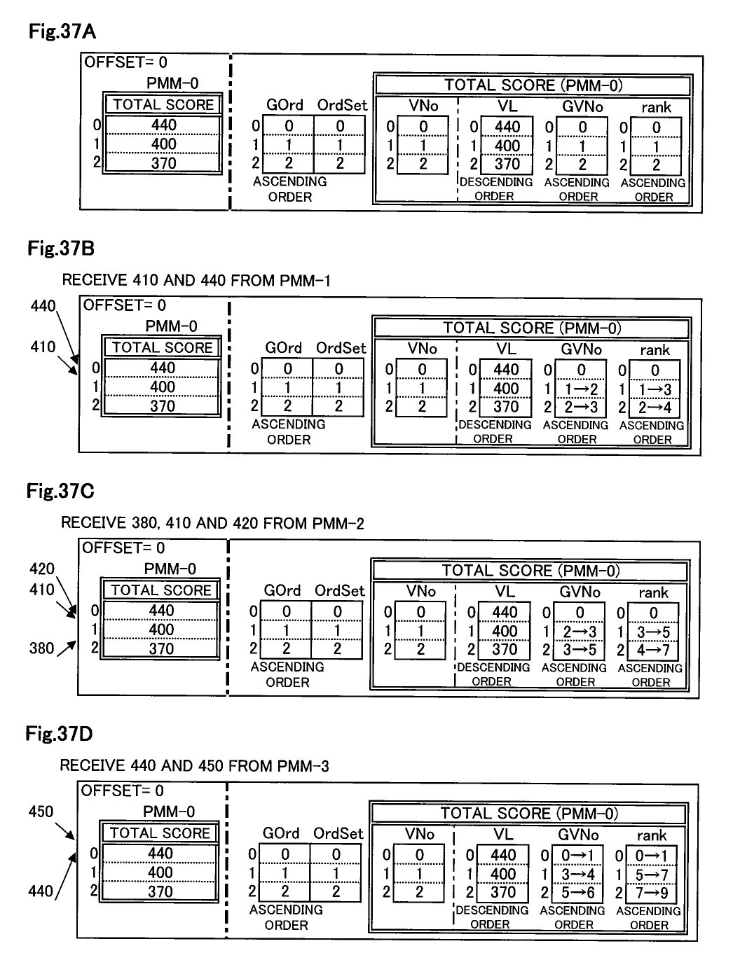

FIGS. 37A to 37D are explanatory diagrams illustrating the rank-assigning process for assigning the rank and the global field value number to the processing module PMM-0 according to Embodiment 4 of the invention. FIG. 37A shows an initial state of the processing module PMM-0, FIG. 37B shows a state after receiving field values 440 and 410 from the processing module PMM-1, FIG. 37C shows a state after receiving field values 420, 410 and 380 from the processing module PMM-2, and FIG. 37D shows a state after receiving field values 450 and 440 from the processing module PMM-3.

The global field value number GVNo can be, for example, assigned according to the sequence number assigning method described with reference to FIGS. 22 to 24.

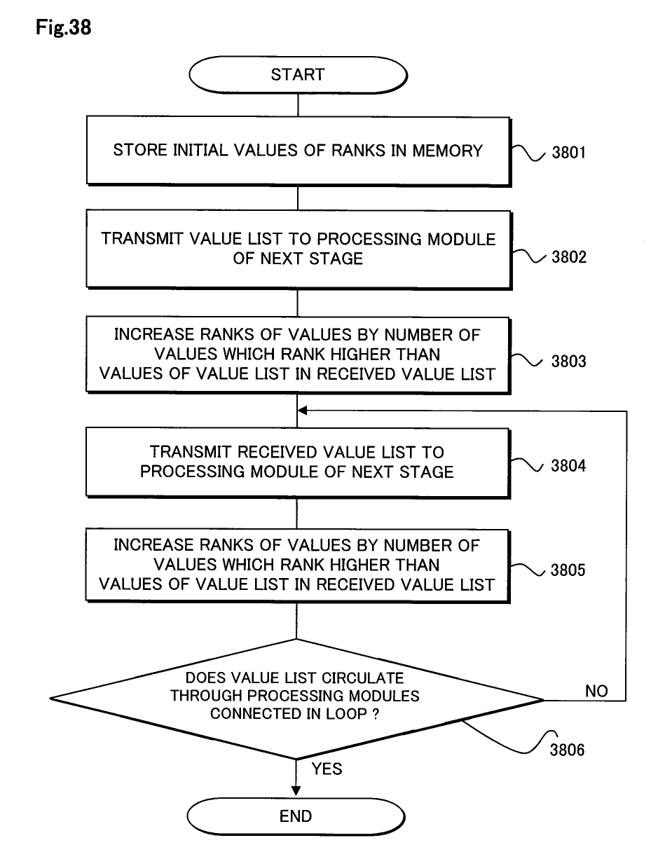

FIG. 38 is a flowchart of the rank assigning method according to Embodiment 4. As shown in FIG. 38, each of the processing modules stores initial values of the ranks of the values of the total score list of the relevant processing module in the memory of each of the processing modules (step 3801).

Next, each of the processing modules transmits the list of the values (total score in the present example) stored in the memory of the relevant processing module to a processing module logically arranged in a next stage (step 3802). Each of the processing modules counts the number of the values, which rank higher than the values of the value list of the relevant processing module, in the value list which is received from the processing module logically arranged in a previous stage, and increases the ranks of the values of the value list of the relevant processing module by the counted number, updates the ranks of the values of the value list of the relevant processing module, and stores the updated ranks in the memory (step 3803).

Next, each of the processing modules transmits the values of the received value list to a processing module logically arranged in a next stage (step 3804). Each of the processing modules counts the number of the values, which rank higher than the values of the value list of the relevant processing module, in another value list which is received from the processing module logically arranged in a previous stage, and increases the ranks of the values of the value list of the relevant processing module by the counted number, updates the ranks of the values of the value list of the relevant processing module, and stores the updated ranks in the memory (step 3805).

Subsequently, each of the processing modules repeatedly performs the step 3804 and the step 3805 until the value list transmitted to the processing module logically arranged in the next stage is received by the processing module logically arranged in the previous stage through the other processing modules which are logically connected in the loop (step 3806).

According to this rank assigning method, each of the processing modules can receive the value lists of the other processing modules without repetition and assign global rank to the values of the relevant processing module. As described above, when each of the processing modules has the previously value list ranked previously, it is possible to efficiently assign the global ranks. This is because the ranks can be only compared in ascending (or descending) order when the value list is previously ranked. Even in the case where the value list of each of the processing modules is not ranked, it is possible to obtain the similar result. In this case, for example, each of the processing modules sequentially compares the values of the value list received from the other processing modules with the values of the value list of the relevant processing module in all the combinations, counts the number of values ranked higher than the values of the relevant processing module, that is, the high-rank values, and updates the ranks of the values of the relevant processing module.

In the rank assigning method according to Embodiment 4, each of the processing modules need not store the value list received from the other processing modules and can assign the common ranks to all the processing modules only by assigning the rank to the value list of the relevant processing module. Since this rank assigning method is not influenced by the order of the value lists received from the other processing modules, this rank assigning method does not depend on the physical connection among the processing modules. Accordingly, by multiplexing the transmitting path and the rank assigning updating circuit, it is possible to more increase the speed.

### EMBODIMENT 5

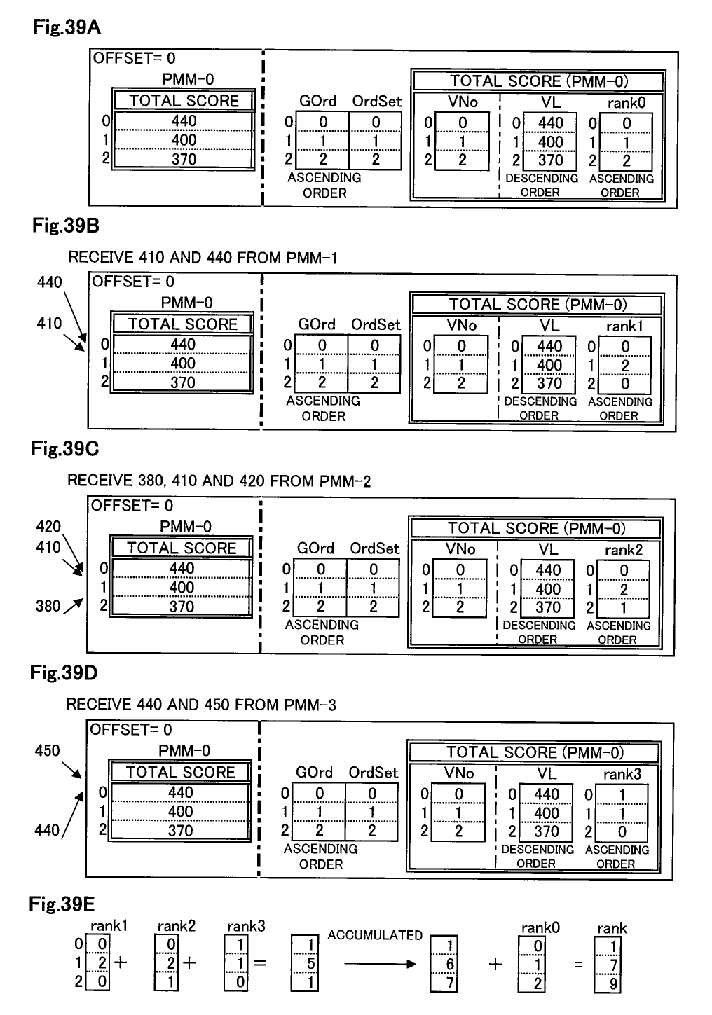

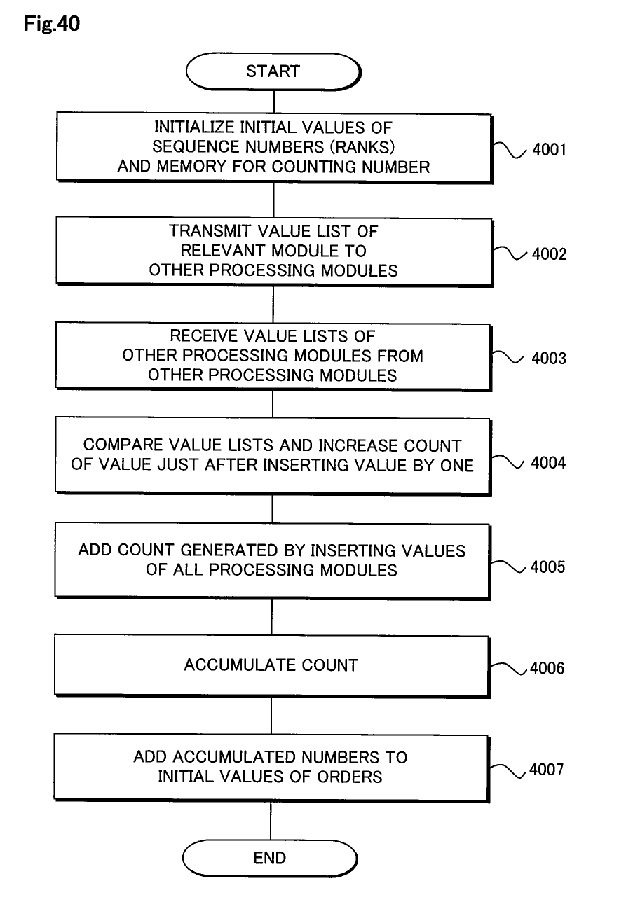

In Embodiment 4, the rank assigning process is performed the same order as that of the rank assigning process for assigning the global field value number. However, when the communication among the processing modules is performed in parallel, the rank assigning process is more preferably realized by two steps of performing the communication among the processing modules in parallel to count the number and accumulating the number. For example, the process for assigning the rank to the total scores based on the example of the table-format data storage structure shown in FIG. 36 is performed by the rank assigning process according to Embodiment 5 of the invention shown in FIGS. 39A to 39E. FIG. 40 is a flowchart of the rank assigning process according to Embodiment 5 of the invention.

Step 4001: The processing module PMM-0 has the values of total scores 440, 400 and 370 calculated in the relevant processing module as a value list (440, 400, 370). The operation region rank0, rank1, rank2 and rank3 for counting the number are initialized. The operation region rank0 has initial values (0, 1, 2) of the ranks of the value list (440, 400, 370) of the relevant processing module. The operation regions rank1, rank2 and rank3 are initialized to (0, 0, 0). FIG. 39A shows an initial state of the processing module PMM-0.

Step 4002: The processing module PMM-0 transmits the value list (440, 400, 370) of the relevant processing module to the other processing modules PMM-1, PMM-2 and PMM-3.

Step 4003: The processing module PMM-0 receives the value lists of the processing module from the other processing modules PMM-1, PMM-2 and PMM-3. In the present example, as shown in FIGS. 39B, 39C and 39D, the processing module PMM-0 receives the value lists (410, 440), (380, 410, 420) and (440, 450) from the processing modules PMM-1, PMM-2 and PMM-3, respectively.

Step 4004: The processing module PMM-0 compares value list of the relevant processing module with the value lists received from the other processing modules PMM-1, PMM-2 and PMM-3 and updates operation regions rank1, rank2 and rank 3 for counting the number. For example, FIG. 39B shows a process executed when the processing module PMM-0 receives the value list (410, 440) from the processing module PMM-1.

Since the value list of the total score is arranged in descending order, the value 410 of the processing module PMM-1 is ranked lower than the value 440 of the processing module PMM-0 and higher than the value 400 of the processing module PMM-0. In this case, since the value 410 is inserted just before the value 400, the processing module PMM-0 increases the count of the value 400 (that is, the second row from the top of rank1) by one. Since the value 440 of the processing module PMM-1 is identical to the value 440 of the processing module PMM-0 and inserted just before the value 400, the processing module PMM-0 increases the count of the value 400 by one again. As the result, the result of counting the value list received from the processing module PMM-1 in the processing module PMM-0 becomes (0, 2, 0), as shown in the operation region rank1 of FIG. 39B.

As shown in FIG. 39C, the processing module PMM-0 compares the value list (440, 400, 370) of the relevant processing module with the value list (380, 410, 420) received from the processing module PMM-2 and increases the count of the operation region rank2 of the relevant processing module just after inserting the values of the processing module PMM-2 one by one. For example, the processing module PMM-0 increases the count of the value 370 of the relevant processing module by one with respect to the value 380 of the processing module PMM-2, increases the count of the value 400 of the relevant processing module by one with respect to the value 410 of the processing module PMM-2, and increases the value 400 of the relevant processing module by one with respect to the value 420 of the processing module PMM-2. As the result, the operation region rank2 becomes (0, 2, 1).

As shown in FIG. 39D, the processing module PMM-0 compares the value list (440, 400, 370) of the relevant processing module with the value list (440, 450) received from the processing module PMM-3 and increases the count of the operation region rank3 of the relevant processing module just after inserting the value of the processing module PMM-3 one by one. For example, the processing module PMM-0 increases the count of the value 400 of the relevant processing module by one with respect to the value 440 of the processing module PMM-3 and increases the count of the value 440 of the relevant processing module by one with respect to the value 450 of the processing module PMM-3. As the result, the operation region rank3 becomes (1, 1, 0).

Step 4005: The processing module PMM-0 adds rank1, rank2 and rank3 to calculate the rank change of the value list of the relevant processing module PMM-0 by all the value lists received from the processing modules PMM-1, PMM-2 and PMM-3. In the present example, as shown in FIG. 39E, rank1=(0, 2, 0), rank2=(0, 2, 1) and rank3=(1, 1, 0) are added to obtain (1, 5, 1).

Step 4006: The processing module PMM-0 accumulates the added result. In the present example, the added result=(1, 5, 1) is accumulated to obtain an accumulated number=(1, 6, 7). The added result=(1, 5, 1) represents that one value exists before the first value 440, five values exist between the first value 440 and the second value 400, and one value exists between the second value 400 and the third value 370 in the value list of the processing module PMM-0. Accordingly, the rank of the value 440 decreases by one, the rank of the value 400 decreases by 6 (=1+5), and the rank of the value 370 decreases by 7 (=6+1), by inserting the value lists of the processing modules PMM-1, PMM-2 and PMM-3.

Step 4007: The processing module PMM-0 finally adds the rank decreasing value=(1, 6, 7) obtained in the step 4006 to the initial value rank0=(0, 1, 2) of the ranks of the values 440, 400 and 370 to calculate a final rank (1, 7, 9) of the value list=(440, 400, 370).

The steps 4001 to 4007 can be performed in the other processing modules PMM-1, PMM-2 and PMM-3 in parallel. The rank rank=(5, 1) is obtained with respect to the value list=(410, 440) of the processing module PMM-1, the rank (8, 5, 4) is obtained with respect to the value list=(380, 410, 420) of the processing module PMM-2, and the rank (1, 0) is obtained with respect to the value list=(440, 450) of the processing module PMM-3. In the present example, since the identical rank1 is assigned to the identical value, for example, the value 440, and the number of the values 440 is three, the rank 4 (=1+3) is assigned to the value 420 which is subsequently larger than the value 440.

By the above-described process, the rank assigning process is completed.

In Embodiment 5, the value lists received from the other processing modules are not ranked in ascending or descending order. However, in the present example, for example, when the value lists received from the other processing modules are ranked in descending order, it is possible to more efficiently compare the value lists to each other.

When the global field value numbers are already assigned to the total scores using the compiling process among the processing modules PMMs, the processing modules may transmit/receive the global field value numbers to/from one another, instead of the total score. In this case, the comparison between the value lists can be realized by comparison between the global field value numbers.

### EMBODIMENT 6

In Embodiment 5, when a certain processing module has the value list, the other value lists are transmitted from the other processing modules to the processing module and the ranks are assigned to the values (rank-assigning process) in the value list of the processing module. For example, in Embodiment 5, when the values of the total scores of the processing modules PMM-2 are 380, 420 and 420, (380, 420, 420) is transmitted as the value list. However, when the identical value is transmitted in plural, it is efficient that lists of pairs of the value and the number of the value are transmitted. That is, the list of the pairs of the value and the number of the value, such as [(the value 1, the number of the value 1), (the value 2, the number of the value 2), . . . ] is transmitted instead of the list (the value 1, value 2, . . . ).

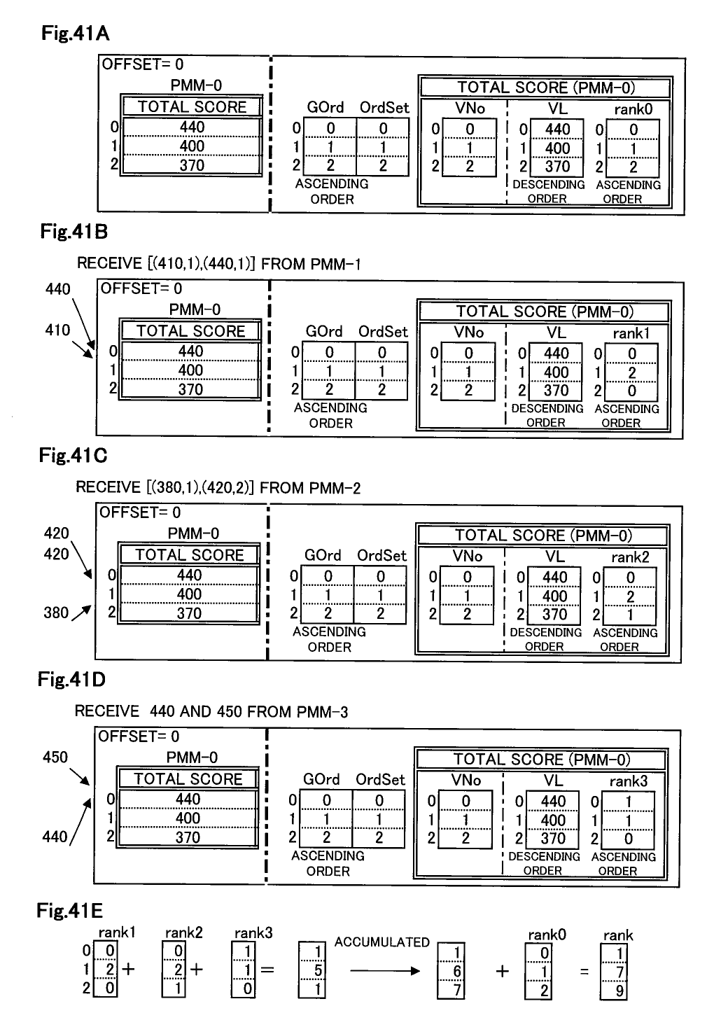

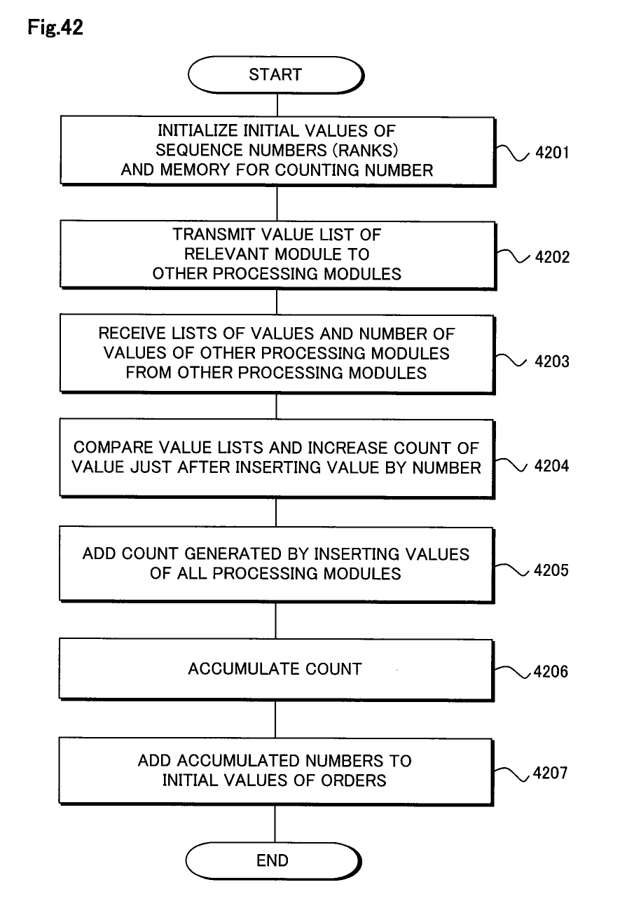

Accordingly, in Embodiment 6, the list of the pairs of the value and the number of the value are transmitted among the processing modules and the ranks are assigned to the values. FIGS. 41A to 41E show an example in which the list of the pair of the value and the number of the value is transmitted among the processing modules and the processing module PMM-2 transmits [(380, 1), (420, 2)]. FIG. 42 is a flowchart of a rank assigning process according to Embodiment 6 of the invention.

Step 4201: The processing module PMM-0 has the values of total scores 440, 400 and 370 calculated in the relevant processing module as a value list (440, 400, 370). Operation regions rank0, rank1, rank2 and rank3 for counting the number are initialized. The operation region rank0 has initial values (0, 1, 2) of the ranks of the value list (440, 400, 370) of the relevant processing module. The operation regions rank1, rank2 and rank3 are initialized to (0, 0, 0). FIG. 41A shows an initial state of the processing module PMM-0.

Step 4202: The processing module PMM-0 transmits the list of the values of the relevant processing module and the number of the values [(440, 1), (400, 1), (370, 1)] to the other processing modules PMM-1, PMM-2 and PMM-3.

Step 4203: The processing module PMM-0 receives the value lists of each of the processing modules from the other processing modules PMM-1, PMM-2 and PMM-3. In the present example, as shown in FIGS. 41B, 41C and 41D, the processing module PMM-0 receives the lists [(410, 1), (440, 1)], [(380, 1), (420, 2)] and [(440, 1), (450, 1)] from the processing modules PMM-1, PMM-2 and PMM-3, respectively.

Step 4204: The processing module PMM-0 compares the value list of the relevant processing module with the lists of the values and the number of the values, which are received from the other processing modules PMM-1, PMM-2 and PMM-3, and updates operation regions rank1, rank2 and rank3 for counting the number. For example, FIG. 41B shows a process executed when the processing module PMM-0 receives the list of the values and the number of the values [(410, 1), (440, 1)] from the processing module PMM-1.

Since the list of the total score is arranged in descending order, the value 410 of the processing module PMM-1 is ranked lower than the value 440 of the processing module PMM-0 and higher than the value 400 of the processing module PMM-0. In this case, since the value 410 is inserted just before the value 400, the processing module PMM-0 increases the count of the value 400 (that is, the second row from the top of rank1) by the number of value 410 (in this example, 1). Since the value 440 of the processing module PMM-1 is identical to the value 440 of the processing module PMM-0 and inserted just before the value 400, the processing module PMM-0 increases the count of the value 400 by the number of value 410 (in this example, 1) again. As the result, the result of counting the list of received value from the processing module PMM-1 in the processing module PMM-0 becomes (0, 2, 0), as shown in the operation region rank1 of FIG. 41B.

As shown in FIG. 41C, the processing module PMM-0 compares the list (440, 400, 370) of the value of the relevant processing module with the value list of the values and the number of the values [(380, 1), (420, 2)] received from the processing module PMM-2 and increases the count of the operation region rank2 of the relevant processing module just after inserting the values of the processing module PMM-2 by the number of the inserted values. For example, the processing module PMM-0 increases the count of the value 370 of the relevant processing module by one with respect to the value 380 of the processing module PMM-2 and increases the count of the value 400 of the relevant processing module by two with respect to the value 420 of the processing module PMM-2. As the result, the operation region rank2 becomes (0, 2, 1).

As shown in FIG. 41D, the processing module PMM-0 compares the value list (440, 400, 370) of the relevant processing module with the list of the values [(440, 1), (450, 1)] received from the processing module PMM-3 and increases the count of the operation region rank3 of the relevant processing module just after inserting the value of the processing module PMM-3 by the number of the inserted values. For example, the processing module PMM-0 increases the count of the value 400 of the relevant processing module by one with respect to the value 440 of the processing module PMM-3 and increases the count of value 440 of the relevant processing module by one with respect to the value 450 of the processing module PMM-3. As the result, the operation region rank3 becomes (1, 1, 0).

Step 4205: The processing module PMM-0 adds rank1, rank2 and rank3 to calculate the rank change of the value list of the relevant processing module PMM-0 by all the value lists received from the processing modules PMM-1, PMM-2 and PMM-3. In the present example, as shown in FIG. 41E, rank1=(0, 2, 0), rank2=(0, 2, 1) and rank3=(1, 1, 0) are added to obtain (1, 5, 1).

Step 4206: The processing module PMM-0 accumulates the added result. In the present example, the added result=(1, 5, 1) is accumulated to obtain an accumulated number=(1, 6, 7). The added result=(1, 5, 1) represents that one value exists before the first value 440, five values exist between the first value 440 and the second value 400, and one value exists between the second value 400 and the third value 370 in the value list of the processing module PMM-0. Accordingly, the rank of the value 440 decreases by one, the rank of the value 400 decreases by 6 (=1+5), and the rank of the value 370 decreases by 7 (=6+1), by inserting the value lists of the processing modules PMM-1, PMM-2 and PMM-3.

Step 4207: The processing module PMM-0 finally adds the rank decreasing value=(1, 6, 7) obtained in the step 4206 to the initial value rank0=(0, 1, 2) of the ranks of the values 440, 400 and 370 to calculate a final rank (1, 7, 9) of the value list=(440, 400, 370).

The steps 4201 to 4207 can be performed in the other processing modules PMM-1, PMM-2 and PMM-3 in parallel. The rank (5, 1) is obtained with respect to the value list=(410, 440) of the processing module PMM-1, the rank (8, 5, 4) is obtained with respect to the value list=(380, 410, 420) of the processing module PMM-2, and the rank (1, 0) is obtained with respect to the value list=(440, 450) of the processing module PMM-3. In the present example, since the identical rank 1 is assigned to the identical value, for example, the value 440, and the number of the values 440 is three, the rank 4 (=1+3) is assigned to the value 420 which is subsequently larger than the value 440. By the above-described process, the rank assigning process is completed.

In Embodiment 6, the lists of the values and the number of the values, which are received from the other processing modules, are not ranked in ascending or descending order. However, in the present example, for example, when the lists of the value and the number of the values, which are received from the other processing modules, are ranked in descending order, it is possible to more efficiently compare the value lists to each other.

When the global field value numbers are already assigned to the total scores using the compiling process among the processing modules PMMs, the processing modules may transmit/receive the global field value numbers and the list of the numbers to/from one another, instead of the total score. For example, in this case, since the values 440, 400 and 370 transmitted from the processing module PMM-0 to the other processing modules correspond to the global field value numbers 1, 4 and 6, the processing module PMM-0 transmits [(1, 1), (4, 1), (6, 1)] instead of [(440, 1), (400, 1), (370, 1)]. In this case, the comparison between the values can be realized by comparison between the global field value numbers.

When the global field value numbers are already assigned to the values, each of the processing modules may transmit a “number list” in which the numbers of the values are arranged in order of the global field value numbers, instead of the values, the list of the values and the number of the values of the relevant processing module, or a list of the global field value number and the number. In the above-described example, the processing module PMM-0 transmits (0, 1, 0, 0, 1, 0, 1). In this case, since the global field value number can be obtained by detecting in which rank a non-zero value is located in the list, it is possible to easily perform the comparison between the global field value numbers.

Finally, detailed matter which is not described in Embodiments 1 to 6 will be described.

[Local sorting process] The local sorting process is performed as a portion of the global tabulating process or a portion of the global sorting process, as described with reference to FIG. 9 of Embodiment 1. In the present embodiment, since the local sorting process is separately performed in each of the processing modules, it is possible to increase the speed of the tabulating process by increasing the speed of the local sorting process.

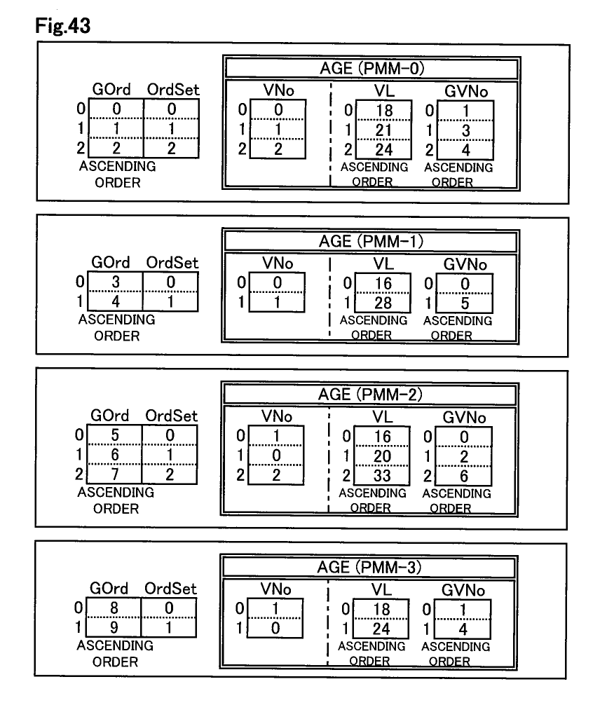

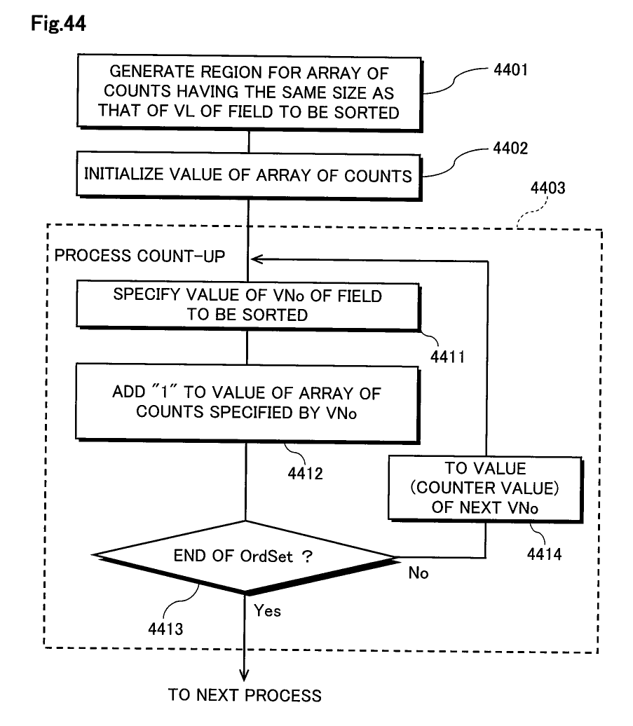

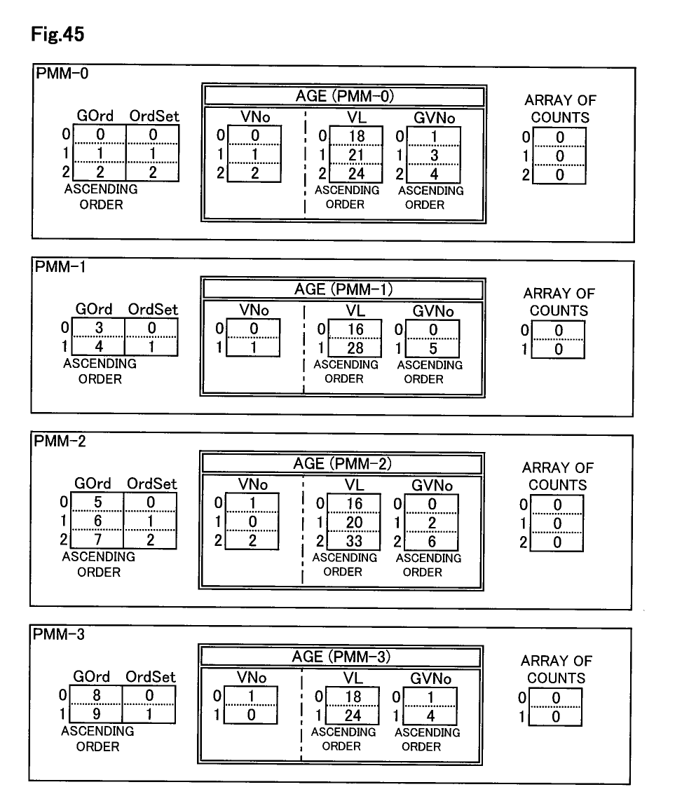

Hereinafter, the local sorting process will be described. The local sorting process begins in a state where the compiling process is completed, as shown in FIG. 43. FIG. 44 is a flowchart of the local sorting process. As shown in FIG. 44, each of the processing modules PMM generates a region for an array of counts having the same size as that of the value list VL of fields to be sorted (step 4401) and an initial value “0” is assigned to the values of the region (4402). FIG. 45 shows a state where a region having the same size as that of the value list VL is generated in each of the processing modules PMM with respect to the field “age” and the initial value “0” is assigned to the values of the region.

Next, each of the processing modules PMM performs a counting-up process of the array of counts (step 4403). More specifically, each of the processing modules PMM specifies the values of the array of pointers VNo of the fields to be sorted with reference to the values of the array of order sets OrdSet (step 4411). Next, each of the processing modules PMM counts up the position value represented by the value of the array of pointers VNo among the array of counts (step 4412). Such a process is repeated to the end of the array of order sets OrdSet (steps 4413 and 4414).

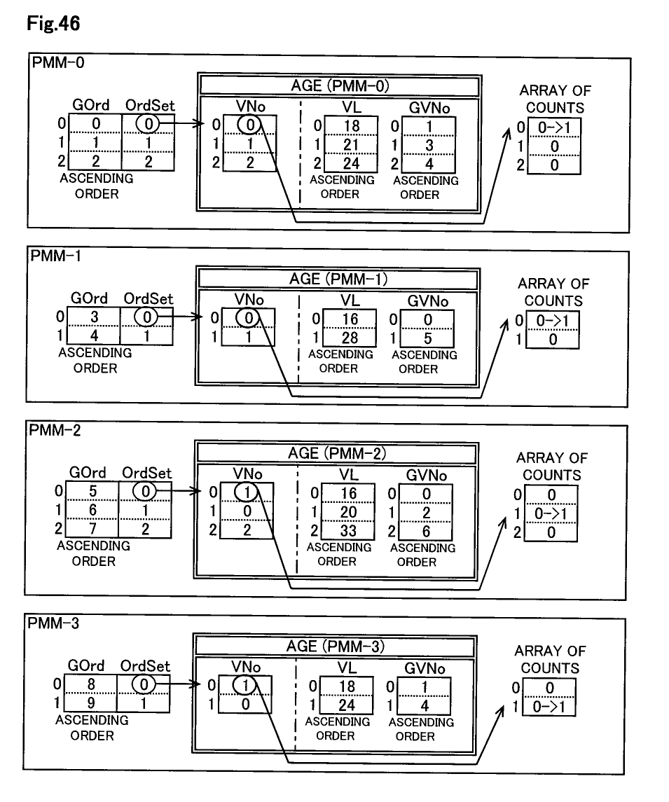

FIG. 46 shows an example of the count-up process in each of the processing modules PMM. For example, in the processing module PMM-0, the value of the array of pointers of the age, which is represented by the element “0” of the array of order sets OrdSet, is “0”. Accordingly, a “0-th” position of the array of counts, that is, the first value is counted up from “0” to “1”. In the other processing modules PMMs, the similar process is performed.

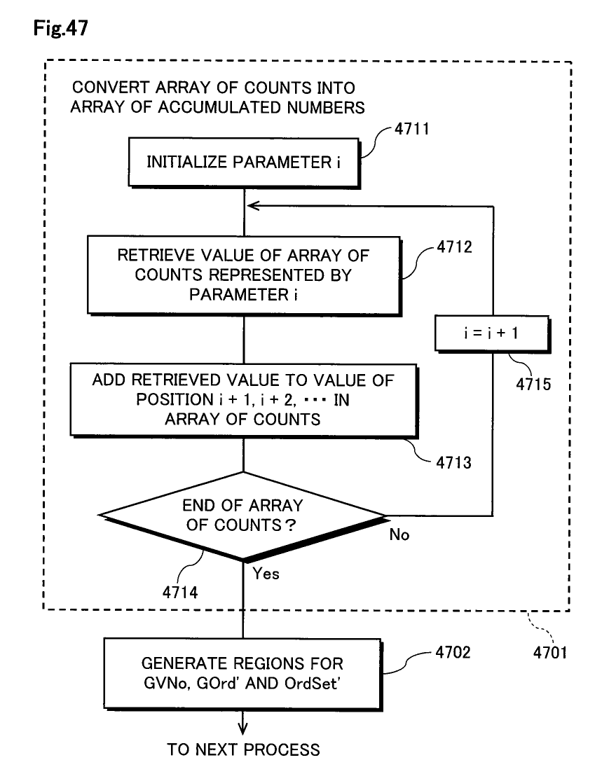

When the count-up process is completed, as shown in FIG. 47, each of the processing modules PMM accumulates the elements of the array of counts and converts the array of counts into an array of accumulated numbers (step 4701). The accumulated numbers, which are the elements of the array of accumulated numbers, represents the first position of the record indicating the field value of the position where the accumulated number is positioned, in consideration of the count representing the number of the records indicating the field value. More specifically, each of the processing modules PMM initializes a parameter “i” representing the position of the array (step 4711), retrieves the value of the array of counts represented by the parameter (step 4712), and adds the value retrieved in the step 4712 to the values of the array of counts positioned after the position represented by the parameter “i”, that is, “i+1”, “i+2”, . . . (step 4713). The steps 4712 and 4713 are repeated by the number of the elements (field values) of the value list VL (steps 4714 and 4715).

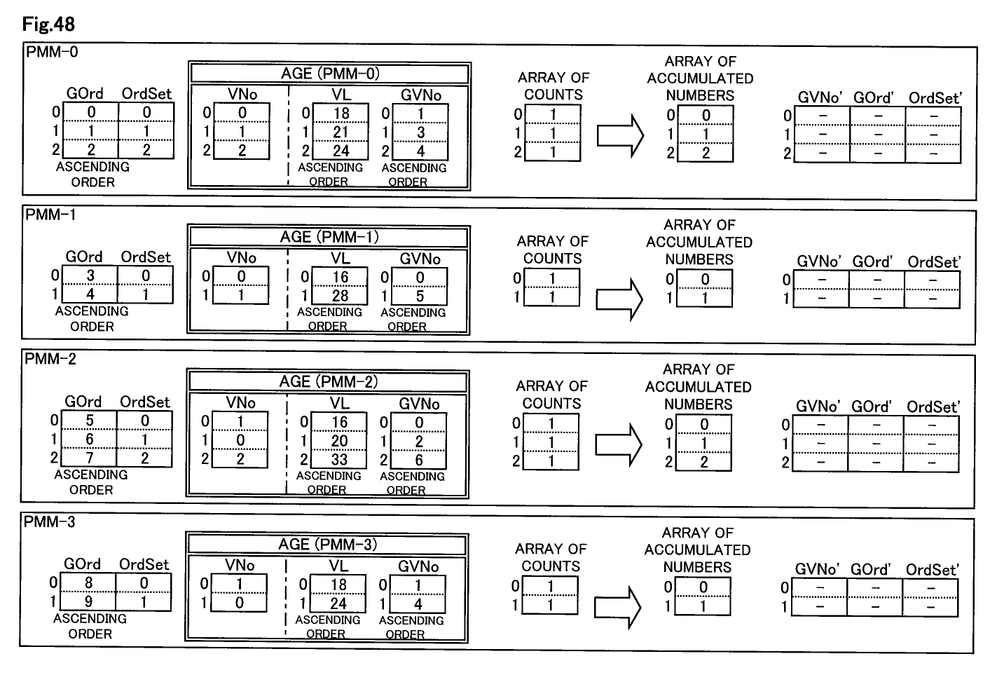

By the above-described steps, for example, it is possible to obtain the array of accumulated numbers shown in FIG. 48. Each of the processing modules PMM may generate a region for the arrays GVNo, GOrd′ and OrdSet′ for storing the orders of all the PMMs (step 4702). The sizes of the arrays are identical to the size of the value list VL.

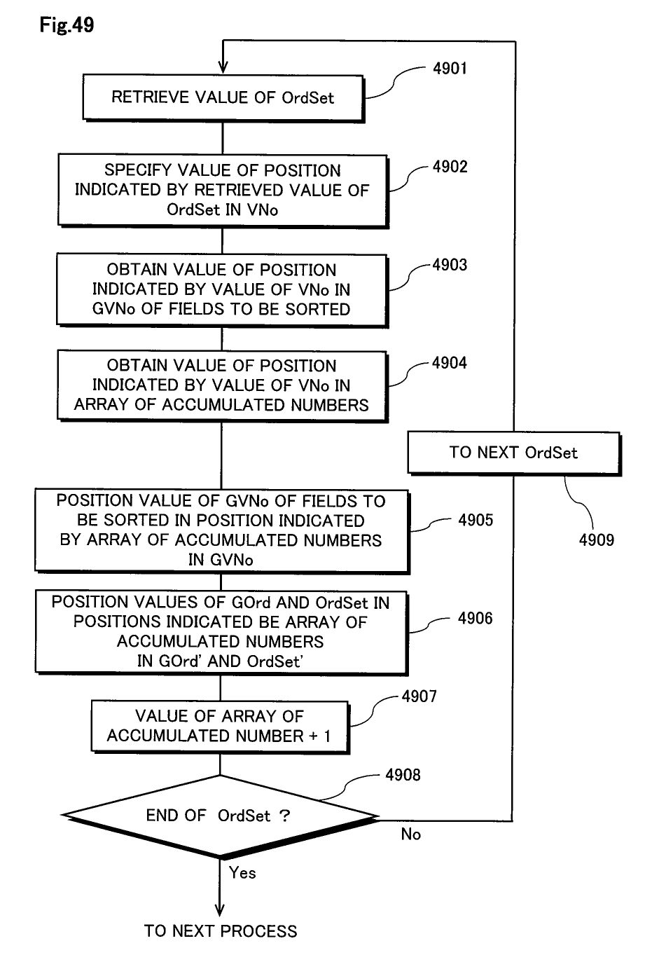

Next, the local sorting process of each of the processing modules PMM is performed. As shown in FIG. 49, each of the processing modules PMM retrieves the value of the array of order sets OrdSet (step 4901) and then specifies the position value (pointer value) indicated by the value of the array OrdSet in the array of pointers VNo (step 4902). Thereafter, each of the processing modules PMM obtains the position value indicated by the value of the array of pointers VNo in the array of global field value numbers GVNo to be sorted (step 4903). This value is used for the process for storing the values described later. On the other hand, even in the array of accumulated numbers, the value indicated by the array of pointers VNo is obtained (step 4904). This value is used for specifying the position of the array in the below-described process for storing the value.

Next, the process for storing the value is performed. Each of the processing modules PMM positions the value of the array GVNo of the fields to be sorted, which is obtained in the step 4902, at the position indicated by the value of the array of accumulated numbers obtained in the step 4904 in the generated arrays GVNo (step 4905). Each of the processing modules PMM positions the values of the array of global order sets GOrd and the array of order sets OrdSet at the positions indicated by the values of the array of accumulated numbers obtained in the step 4904 in the arrays GOrd′ and OrdSet′, respectively (step 4906). Next, the value of the array of accumulated numbers used for the process increases by one (step 4907).

The steps 4901 to 4907 are sequentially performed with respect to all the values of the array OrdSet (steps 4908 and 4909).

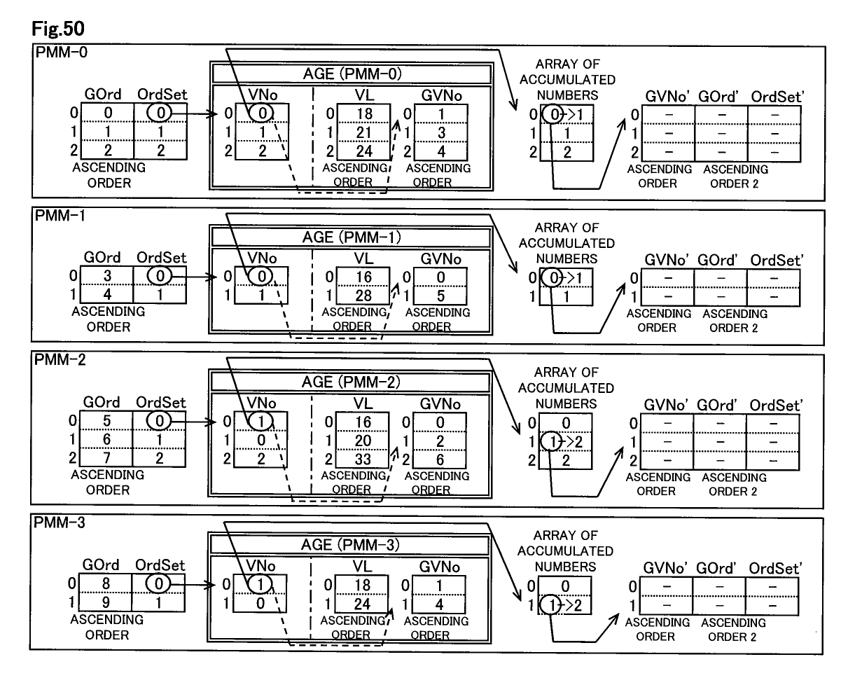

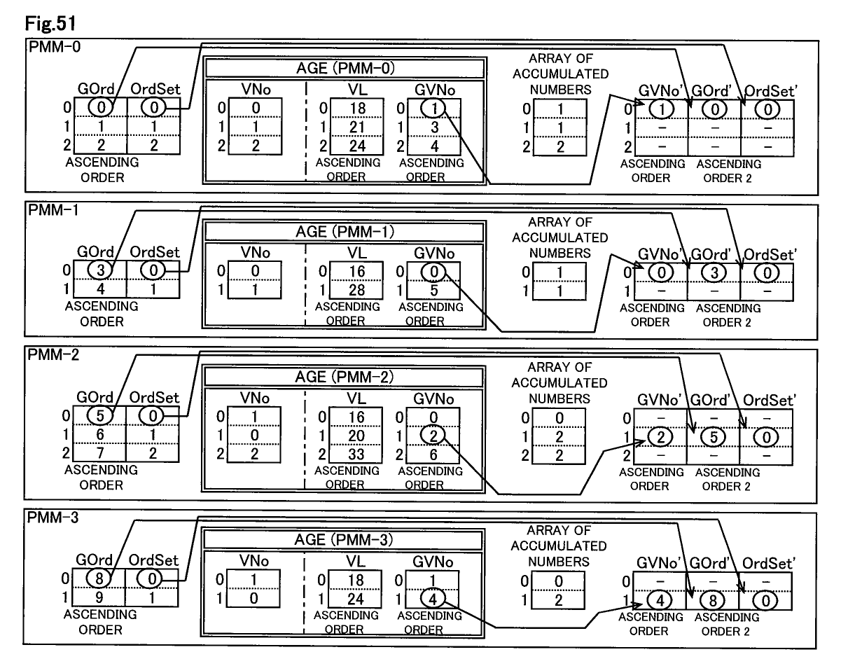

FIGS. 50 and 51 show a state where the local sorting process is performed in each of the processing modules PMM. For example, with respect to the processing module PMM-0, in FIG. 50, the value “0” of the array OrdSet is retrieved (step 4901), the value “0” of the array VNo indicated by the value “0” of the array OrdSet is specified (step 4902), the value “1” of the array GVNo indicated by the value “0” of the array VNo is obtained (step 4903), and the value “0” of the array of accumulated numbers indicated by the value “0” of the array VNo is obtained (step 4904). After obtaining the array of accumulated numbers, the value of the array of accumulated numbers is changed from “0” to “1” (step 4907).

With respect to the processing module PMM-0, in FIG. 51, the value “1” of the array GVNo of the field “age”, the value “0” of the array GOrd and the value “0” of the array OrdSet are positioned at the array GVNo, GOrd′ and OrdSet′ indicated by the values of the array of accumulated numbers obtained in the step 4103, respectively (steps 4905 and 4906). Even in the other processing modules PMMs, the steps 4901 to 4905 are processed in FIGS. 50 and 51.

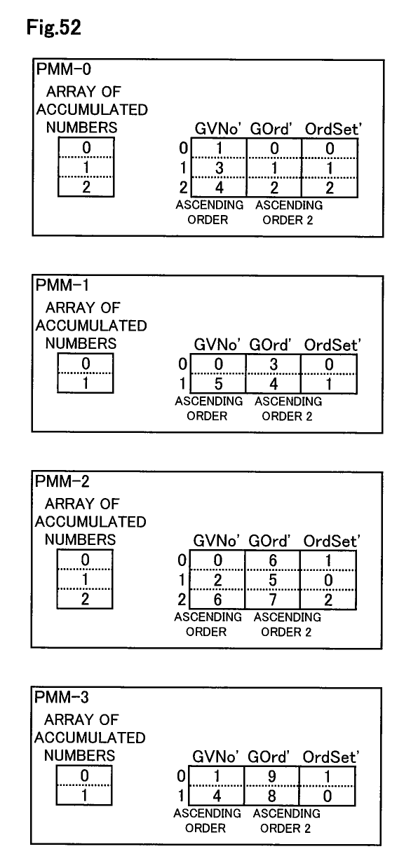

By the local sorting process (in each of the processing modules PMM), it is possible to obtain the array shown in FIG. 52. In FIGS. 50 to 52, “ascending 2” in the drawing means that the global record numbers GOrd′ are arranged in ascending order in a range that the global field value numbers GVNo′ are identical.

The local sorting process described therein has an excellent property that the comparison is not performed.

In general, when the number of the data is n, the sort which performs the comparison generates the processing amount 0(n*log(n)), but the sort which does not perform the comparison generates the processing amount 0(n). The counting sort which does not perform the comparison includes three steps: enumeration, accumulation and transmission. The processing steps become 3n when all data are different from one another. Accordingly, when n pieces of data without repetition and m computers exist, n pieces of data are divided into m, the divided data is locally sorted, and, in a model for integrating the locally sorted data by the global sort, the step of the global sort becomes (m−1)*(2*n/m). A first term (m−1) denotes the number of the data which is received from the other computers and processed by each computer, and a second term (2*n/m) denotes the number of the comparisons which is averagely generated when two ascending lists having n/m data are compared with each other. When m is large, the above-described equation becomes 2*n and the number of the steps of the global sort becomes 0 (n). That is, this sort is more efficiently performed than the sort for performing the comparison 0(n*log(n)). This is because efficiency can be accomplished by comparison of the ascending list. On the other hand, disappearance of m means that the processing amount of the global sort per one computer is not changed although the number of the computers increases.

[Other embodiments of the local sorting process] The above-described local sorting process is excellent in that each of the processing modules can operate in parallel. However, the local sorting process can be realized by the other method. For example, when the number m of the computers is similar to the number n of the data, the local sorting process may be realized using the policy of the above-described rank assigning process.

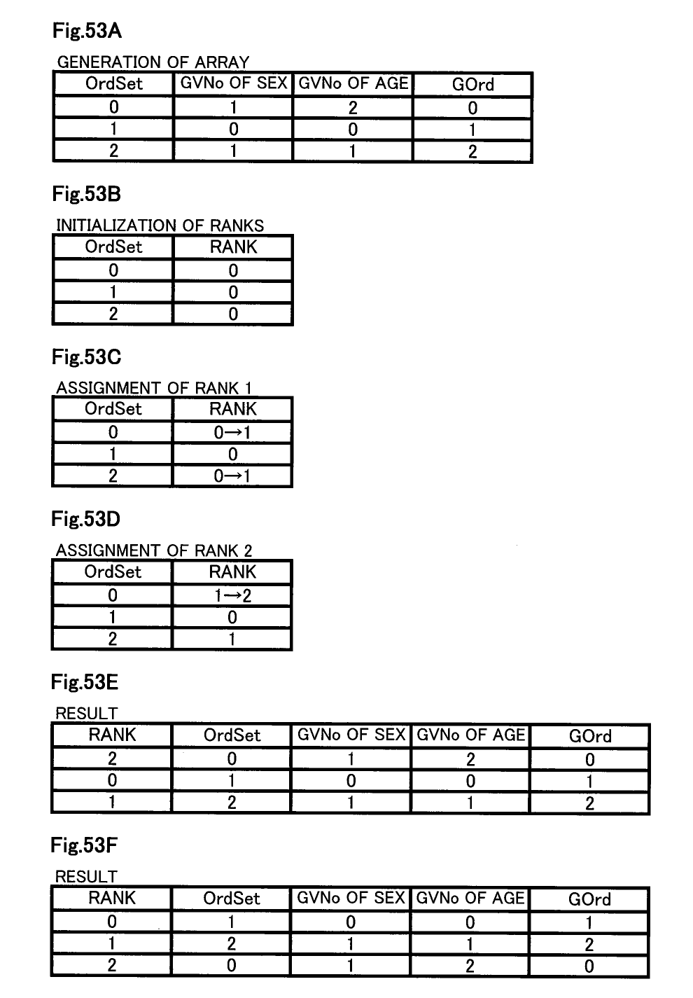

For example, the other local sorting process will be described with respect to the example of the sort by “age” and “sex” described with reference to FIG. 9. In the example of the sort by age and sex, when each of the processing modules PMM generates a three-dimensional array of GVNo of sex, GVNo of age and GOrd for each record and assigns ranks to the three-dimensional array, the same result as the above-described local sorting process is obtained. FIGS. 53A to 53F are explanatory diagrams of the local sorting process using the rank assigning process.

First, as shown in FIG. 53A, with respect to each element of the array Ordset, the three-dimensional array of GVNo of sex, GVNo of age and GOrd is generated. In the following description, the three-dimensional array of OrdSet=i is expressed by A[i]=(a, b, c). In the present example,

A[0]=(1, 2, 0)

A[1]=(0, 0, 1)

A[2]=(1, 1, 2).

Next, the ranks are initialized as shown in FIG. 53B. Next, as shown in FIG. 53C, the ranks are assigned. In the present example, A[0] is sent to OrdSet1, A[1] is sent to OrdSet2, A[2] is sent to OrdSet0, and its own three-dimensional array is compared with the received array, there by assigning the ranks.

As shown in FIG. 53D, A[0] is sent to OrdSet2, A[1] is sent to OrdSet0, A[2] is sent to OrdSet1, and its own three-dimensional array is compared with the received array, thereby assigning the ranks.

As the result of the rank assigning process, the result shown in FIG. 53E is obtained. In FIG. 53F, the result of sequentially rearranging the data is shown. The result shown in FIG. 53F is identical to the local sorting result shown in FIG. 9.

[SIMD type parallel process] When a parallelizing algorithm is poor, it is difficult to develop a program for obtaining a desired result using SIMD. Although the program can be developed, the freedom degree of the program is low. Accordingly, in order to use the SIMD, there is a need for developing an excellent algorithm suitable for the SIMD. The algorithm according to the present embodiment is excellent in view of the data structure and the algorithm in that
(1) there is no a conditional branch upon performing the process (in a case of the searching process, the conditional branch may be performed, but this conditional branch is simple),

(2) a ratio occupied by the processes which can be performed by a single command (the number of the steps and the number of the clocks), such as the comparison of the ascending list, is high, and

(3) all the processing modules have the identical function. When the processing modules perform different functions, the process cannot be realized by the single command. Accordingly, in the present embodiment, when the SIMD is used, the program is simplified and thus the easiness in the development of the program or the high freedom degree of the program can be ensured.

[System construction] An information processing system according to the invention is, for example, connected to a front-end terminal device through a ring-shaped channel such that each PMM receives a command from the terminal device and thus can perform the compiling, sorting and tabulating processes. Since each of the processing modules PMM transmits a packet using any one of buses, the synchronization between the processing modules PMMs need not be externally controlled.

A control device may include a general CPU in addition to an accelerator chip including a hardware structure for repeated operations such as compiling and sorting. The general CPU may analyze the command transmitted from the terminal device through the channel and assign an instruction necessary for the accelerator chip.

In the control device, and more particularly, the accelerator chip, a register group for receiving various arrays necessary for operations, such as an array of order sets and an array of global order sets is preferably provided. By this construction, when the value necessary for the process is loaded from a memory to the register, the control device may read or write a value from or to the register without accessing to the memory, in the calculating processes used for compiling, sorting and tabulating. To this end, it is possible to significantly reduce the number of the accesses to the memory (the load before the calculating process and the write of the processed result) and to significantly shorten the processing time.

The invention is not limited to the above-described embodiments, and various changes may be made therein without departing from scope of the invention as defined by the appended claims and will be construed as being included in the invention.

In the above-described embodiments, the PMMs are connected to one another in the ring through the first bus (first transmitting path) for transmitting the packet in the clockwise direction and the second bus (second transmitting path) for transmitting the packet in the counterclockwise direction. By this construction, it is possible to equalize the packet transmission delay time. However, the invention is not limited thereto and the other transmitting path such as a bus type may be used.

Although, in the present embodiments, the PMM having the memory, the interface and the control circuit is used, the invention is not limited thereto and a personal computer or a server may be used as an information processing unit for separately controlling the local table-format data, instead of the processing module PMM. Alternatively, a single personal computer or server may use a construction having a plurality of information processing units. In these cases, the information processing unit receives the value representing the order of the record and specifies the record with reference to the array of global order sets GOrd. Alternatively, it is possible to specify a field value with reference to the array of global value numbers.

In addition, the transmitting path among the information processing units may be the so-called network type or bus type.

By using the plurality of information processing units in the single personal computer, the invention can be used as follows. For example, three pieces of table-format data of Sapporo branch, Tokyo branch and Fukuoka branch are generated and the searching, tabulating and sorting processes are performed in the unit of the respective branches. In consideration of global table-format data including the data of the three branches, the table-format data of the respective branches is treated as a partial table of the entire table and the searching, sorting and tabulating processes on the global table-format data can be realized.

Even when the plurality of personal computers is connected to a network, it is possible to perform a process on local table-format data which is separately managed by the personal computers and a process on global table-format data.

### INDUSTRIAL AVAILABILITY

The invention is particularly applicable to systems which handle large amounts of data, for example, databases and data warehouses. More specifically, the invention is applicable to large-scale scientific and technical calculation, the management of mission-critical task such as ordering management or securities trading and management of affairs.

### DESCRIPTION OF THE REFERENCE NUMERALS AND SIGNS

32: PMM
34: first bus
36: second bus
40: control circuit
42: bus I/F
44: memory
46: bank

1. An information processing method of transmitting/receiving and processing data among a plurality of processing modules in an information processing system in which the plurality of processing modules, each having a memory for storing a list composed of values, is logically connected to one another in a loop, the method comprising the steps of:
allowing each of the processing modules to transmit a first list composed of values stored in the memory of each of the processing modules to the other processing modules in the information processing system;
allowing each of the processing modules to receive at lease one second list composed of values transmitted to each of the processing modules, from the other processing modules;
allowing each of the processing modules to compare values of the second list with values of the first list; and
allowing each of the processing modules to increase a counter corresponding to a value of the first list by one when a value of the second list is identical to the value of the first list.

2. An information processing method of transmitting/receiving and processing data among a plurality of processing modules in an information processing system in which the plurality of processing modules, each having a memory for storing a list composed of values, is logically connected to one another in a loop, the method comprising the steps of:
allowing each of the processing modules to transmit a first list composed of pairs of a value and a number of value stored in the memory of each of the processing modules, to the other processing modules in the information processing system;
allowing each of the processing modules to receive at least one second list composed of the pairs of value and the number of value transmitted to each of the processing modules, from the other processing modules;
allowing each of the processing modules to compare values of the second list with values of the first list; and
allowing each of the processing modules to increase a counter corresponding to a value of the first list by the number of the values corresponding to a value of the second list, when the value of the second list is identical to the value of the first list.

3. An information processing method of transmitting/receiving and processing data among a plurality of processing modules in an information processing system in which the plurality of processing modules, each having a memory for storing a list composed of values, is logically connected to one another in a loop, the method comprising the steps of:
allowing each of the processing modules to transmit a first list composed of values stored in the memory of each of the processing modules to the other processing modules in the information processing system;
allowing each of the processing modules to receive at least one second list composed of values transmitted to each of the processing modules, from the other processing modules;
allowing each of the processing modules to compare values of the second list with values of the first list; and
allowing each of the processing modules to increase the count of a value of the first list that ranks immediately next to a value of the second list, by one, when the value of the first list ranks lower than the value of the second list.

4. An information processing method of transmitting/receiving and processing data among a plurality of processing modules in an information processing system in which the plurality of processing modules, each having a memory for storing a list composed of values, is logically connected to one another in a loop, the method comprising the steps of:
allowing each of the processing modules to transmit a first list, composed of pairs of a value and a number of value stored in the memory of each of the processing modules, to the other processing modules in the information processing system;
allowing each of the processing modules to receive at least one second list which is composed of the pairs of a value and the number of value transmitted to each of the processing modules from the other processing module;
allowing each of the processing modules to compare values of the second list with values of the first list; and
allowing each of the processing modules to increase a counter corresponding to a value of the first list ranked immediately next to a value in the second list by the number of the values corresponding to the value of the second list, when the value of the first list ranks lower than the value of the second list.

5. An information processing method of transmitting/receiving and processing data among a plurality of processing modules in an information processing system in which the plurality of processing modules, each having a memory for storing a list composed of values, is logically connected to one another in a loop, the method comprising the steps of:
allowing each of the processing modules to transmit a first list composed of values stored in the memory of each of the processing modules to the other processing modules in the information processing system;
allowing each of the processing modules to receive at least one second list composed of values transmitted to each of the processing modules, from the other processing modules;
allowing each of the processing modules to cancel a value of the second list when the value of the second list exists in the first list, and, when identical values exist in two or more second lists, allowing each of the processing modules to cancel the value of one or more second lists that, appear later among the two or more second lists; and
allowing each of the processing modules to increase a counter corresponding to a value of the first list that, ranks immediately next to the value of the second list, by one, when the value of the first list ranks lower than the value of the second list.

6. The information processing method according to claim 1, wherein each of the processing modules stores table-format data represented by an array of records including field values contained in an information field in the memory in a form of a value list in which the field values are stored in order of field value numbers corresponding to the field values and an array of pointers in which information for specifying the field value numbers is stored in order of records, and
wherein said list composed of the values is said value list that constructs the table-format data.

7. An information processing system that includes a plurality of processing modules, each having a memory for storing a list composed of values, and a transmitting path for logically connecting the plurality of processing modules to one another in a loops and transmits/receives and processes data among the plurality of processing modules, each of the processing modules comprising:
a means for transmitting a first list composed of values stored in the memory of each of the processing modules to the other processing modules in the information processing system;
a means receiving at least one second list composed of values transmitted to each of the processing modules from the other processing modules;
a means for comparing values of the second list with values of the first list; and
a means that, when a value of the second list is identical to a value of the first list, increases a counter corresponding to the identical value of the first list by one.

8. An information processing system that includes a plurality of processing modules, each having a memory for storing a list composed of values, and a transmitting path for logically connecting the plurality of processing modules to one another in a loop, and transmits/receives and processes data among the plurality of processing modules, each of the processing modules comprising:
a means for transmitting transmits a first list composed of pairs of a value and a number of value stored in the memory of each of the processing modules to the other processing modules in the information processing system;
a means receiving at least one second list composed of the pairs of values and the number of value transmitted to each of the processing modules, from the other processing modules;
a means for comparing values of the second list with values of the first list; and
a means which, when a value of the second list is identical to a value of the first list, increases a counter corresponding to the identical value of the first list by a number of the values corresponding to the identical value of the second list.

9. An information processing system that includes a plurality of processing modules, each having a memory for storing a list composed of values, and a transmitting path for logically connecting the plurality of processing modules to one another in a loops and transmits/receives and processes data among the plurality of processing modules, each of the processing modules comprising:
a means for transmitting a first list composed of values stored in the memory of each of the processing modules to the other processing modules in the information processing system;
a means for receiving at least one second list composed of values transmitted to each of the processing module, from the other processing modules;
a means for comparing values of the second list with values of the first list; and
a means that, when a value that ranks lower than a value of the second list exists in the first list, increases a counter corresponding to the value of the first list that, ranks immediately next to the value of the second list, by one.

10. An information processing system that includes a plurality of processing modules, each having a memory for storing a list composed of values, and a transmitting path for logically connecting the plurality of processing modules to one another in a loop, and transmits/receives and processes data among the plurality of processing modules, each of the processing modules comprising:
a means for transmitting a first list, composed of pairs of a value and a number of value stored in the memory of each of the processing modules, to the other processing modules in the information processing system;
a means receiving at least one second list composed of the pairs of value and the number of value transmitted to each of the processing modules module, from the other processing modules;
a means for comparing values of the second list with values of the first list; and
a means that, when a value that ranks lower than a value of the second list exists in the first list, increases a counter corresponding to the value of the first list by the number of the values corresponding to the value of the second list.

11. An information processing system that includes a plurality of processing modules, each having a memory for storing a list composed of values, and a transmitting path for logically connecting the plurality of processing modules to one another in a loop, and transmits/receives and processes data among the plurality of processing modules, each of the processing modules comprising:
a means for transmitting a first list composed of values stored in the memory of each of the processing modules to the other processing modules in the information processing system;
a means for receiving at least one second list composed of values transmitted to each of the processing modules, from the other processing modules;
a means that, when a value of the second list exists in the first list, cancels the value of the second list, and, when identical values exist in two or more second lists, cancels the value of one or more second lists that, appear later among the two or more second lists; and
a means that, when a value that ranks lower than a value of the second list exists in the first list, increases a counter corresponding to the value of the first list that ranks immediately next to the value of the second list, by one.

12. The information processing system according to claim 7, wherein each of the processing modules comprises the memory that stores table-format data represented by an array of records including field values contained in an information field in a form of a value list in which the field values are stored in order of field value numbers corresponding to the field values and an array of pointers in which information for specifying the field value numbers is stored in order of records, and
wherein said list composed of the values is the value list that, constructs the table-format data.

13. A program for embodying the following functions in an information processing system that includes a plurality of processing modules, each having a memory for storing a list composed of values, and a transmitting path for logically connecting the plurality of processing modules to one another in a loops and transmits/receives and processes data among the plurality of processing modules, the functions being executed by a computer of each of the processing modules, and the program comprise:
a function that transmits a first list composed of values stored in the memory of each of the processing modules to the other processing modules in the information processing system;
a function that receives at least one second list composed of values transmitted to each of the processing modules from the other processing modules;
a function that compares values of the second list with values of the first list; and
a function that, when a value of a second list is identical to a value of the first list, increases a counter corresponding to the identical value of the first list by one.

14. A program for embodying the following functions in an information processing system that includes a plurality of processing modules, each having a memory for storing a list composed of values, and a transmitting path for logically connecting the plurality of processing modules to one another in a loops and transmits/receives and processes data among the plurality of processing modules, the functions being executed by a computer of each of the processing modules, and the program comprises:
a function that transmits a first list composed of pairs of a value and a number of value stored in the memory of each of the processing modules to the other processing modules in the information processing system;
a function that receives at least one second list composed of the pairs of value and the number of value transmitted to each of the processing modules from the other processing modules;
a function that compares values of the second list with values of the first list; and
a function that, when a value of the second list is identical to a value of the first list, increases a counter corresponding to the identical value of the first list by the number of the values corresponding to the value of the second list.

15. A program for embodying the following functions in an information processing system that includes a plurality of processing modules, each having a memory for storing a list composed of values, and a transmitting path for logically connecting the plurality of processing modules to one another in a loops and transmits/receives and processes data among the plurality of processing modules, the functions being executed by a computer of each of the processing modules, and the program comprises:
a function that transmits a first list composed of values stored in the memory of each of the processing modules to the other processing modules in the information processing system;
a function that receives at least one second list composed of values transmitted to each of the processing modules from the other processing modules,
a function that compares values of the second list with values of the first list; and
a function which, when a value that ranks lower than a value of the second list exists in the first list, increases a counter corresponding to the value of the first list that ranks immediately next to the value of the second list, by one.

16. A program for embodying the following functions in an information processing system that includes a plurality of processing modules, each having a memory for storing a list composed of values, and a transmitting path for logically connecting the plurality of processing modules to one another in a loop, and transmits/receives and processes data among the plurality of processing modules, the functions being executed by a computer of each of the processing modules, and the program comprises:
a function that transmits a first list composed of pairs of a value and a number of value stored in the memory of each of the processing modules to the other processing modules in the information processing system;
a function that receives at least one second list composed of the pairs of value and the number of value transmitted to each of the processing modules from the other processing modules;
a function that compares values of the second list with values of the first list; and
a function that, when a value that ranks lower than a value of the second list exists in the first list, increases a counter corresponding to the value of the first list ranked immediately next to the value in the second list by the number of the values corresponding to the value of the second list.

17. A program for embodying the following functions in an information processing system that includes a plurality of processing modules, each having a memory for storing a list composed of values, and a transmitting path for logically connecting the plurality of processing modules to one another in a loop, and transmits/receives and processes data among the plurality of processing modules, the functions being executed by a computer of each of the processing modules, and the program comprises:
a function that transmits a first list composed of values stored in the memory of each of the processing modules to the other processing modules in the information processing system;
a function that receives at least one second list composed of values transmitted to each of the processing modules from other processing modules;
a function that, when a value of the second list exists in the first list, cancels the value of the second list, and, when identical values exist in two or more second lists, cancels the identical value of one or more second lists that appears, later among the two or more second lists; and
a function that, when a value that ranks lower than a value of the second list exists in the first list, increases a counter corresponding to the value of the first list that ranks immediately next to the value of the second list, by one.

18. The program according to claim 13, wherein each of the processing modules comprises a memory that stores table-format data represented by an array of records including field values contained in an information field in a form of a value list in which the field values are stored in order of field value numbers corresponding to the field values and an array of pointers in which information for specifying the field value numbers is stored in order of records, and
wherein said list composed of the values is said value list that constructs the table-format data.

19. A computer-readable recoding medium having the program according to claim 13 recorded thereon.
